(19) United States
(12) Patent Application Publication
(10) Pub. No.: US 2024/0418681 A1
(43) Pub. Date: Dec. 19, 2024

(54) METHOD AND APPARATUS FOR SAFETY MONITORING OF CRACK IN BLADE GROOVE OF IN-SERVICE NUCLEAR TURBINE ROTOR

(71) Applicant: Shanghai Power Equipment Research Institute Co., Ltd, Shanghai (CN)

(72) Inventors: Jinyuan Shi, Shanghai (CN); Yuesheng Xie, Shanghai (CN); Luyi Jiang, Shanghai (CN); Xuefei Fan, Shanghai (CN); Lin Zhang, Shanghai (CN); Wangren Xu, Shanghai (CN); Yuxuan Wang, Shanghai (CN); Dexuan Wang, Shanghai (CN)

(73) Assignee: Shanghai Power Equipment Research Institute Co., Ltd, Shanghai (CN)

(21) Appl. No.: 18/458,178

(22) Filed: Aug. 30, 2023

(30) Foreign Application Priority Data
Jun. 15, 2023 (CN) 202310715750.6
Jun. 15, 2023 (CN) 202310715787.9
Jun. 15, 2023 (CN) 202310716773.9
Jun. 15, 2023 (CN) 202310716803.6
Jun. 15, 2023 (CN) 202310716848.3

(51) Int. Cl. G01N 29/26; F01D 21/00; G01M 15/14; G01N 29/04

(52) U.S. Cl. CPC G01N 29/262; F01D 21/003; G01M 15/14; G01N 29/04; F05D 2220/31; F05D 2260/80; F05D 2260/83; G01N 2291/0289; G01N 2291/106

(57) ABSTRACT

A method for safety monitoring of a crack in a blade groove of an in-service nuclear turbine rotor includes: acquiring a phased array detection crack depth of the blade groove of the in-service nuclear turbine rotor; acquiring a stress corrosion crack propagation life, a low cycle fatigue crack propagation life and a high cycle fatigue crack propagation life based on the phased array detection crack depth; acquiring a crack propagation calendar life of the blade groove of the rotor based on the stress corrosion crack propagation life, the low cycle fatigue crack propagation life and the high cycle fatigue crack propagation life; and performing safety monitoring on the crack in the blade groove of the rotor based on the crack propagation calendar life.

### CROSS REFERENCE TO RELATED APPLICATION

This application is based on and claims priorities to Chinese patent application No. 202310716773.9, 202310715750.6, 202310716803.6, 202310716848.3, 202310715787.9, filed on Jun. 15, 2023, the entire contents of which are hereby introduced into this application as a reference.

### Technical Field

The present disclosure relates to a field of in-service nuclear turbine technologies, and particularly to a method for safety monitoring of a crack in a blade groove of an in-service nuclear turbine rotor, and an electronic device.

### BACKGROUND

As an energy shortage problem worsens, there is an urgent need to develop new energy to satisfy energy requirements of people. Nuclear power is clean energy with no carbon dioxide emission and a small environmental influence, efficient energy with a high energy density and a low resource consumption, stable energy with free of intermittent, a long utilization hour and a stable power supply capacity, and safe energy with a small accident occurrence possibility, which is an important option to enhance energy security. An in-service nuclear turbine is a key equipment in the nuclear power technology.

### SUMMARY

According to a first aspect of the present disclosure, a method for safety monitoring of a crack in a blade groove of an in-service nuclear turbine rotor is proposed, and includes: acquiring a phased array detection crack depth of the blade groove of the in-service nuclear turbine rotor; acquiring a stress corrosion crack propagation life, a low cycle fatigue crack propagation life and a high cycle fatigue crack propagation life of the blade groove of the rotor based on the phased array detection crack depth; acquiring a crack propagation calendar life of the blade groove of the rotor based on the stress corrosion crack propagation life, the low cycle fatigue crack propagation life and the high cycle fatigue crack propagation life; and performing safety monitoring on the crack in the blade groove of the rotor based on the crack propagation calendar life.

According to a second aspect of the present disclosure, an electronic device is proposed, and includes a memory, a processor and a computer program stored on the memory and executable by the processor. The processor is configured to implement: acquiring a phased array detection crack depth of the blade groove of the in-service nuclear turbine rotor; acquiring a stress corrosion crack propagation life, a low cycle fatigue crack propagation life and a high cycle fatigue crack propagation life of the blade groove of the rotor based on the phased array detection crack depth; acquiring a crack propagation calendar life of the blade groove of the rotor based on the stress corrosion crack propagation life, the low cycle fatigue crack propagation life and the high cycle fatigue crack propagation life; and performing safety monitoring on the crack in the blade groove of the rotor based on the crack propagation calendar life.

It should be noted that, the details above and in the following are exemplary and illustrative, and do not constitute the limitation on the present disclosure.

### BRIEF DESCRIPTION OF THE DRAWINGS

The above and/or additional aspects and advantages of the present disclosure will become obvious and easy to understand from the following description of the embodiments in conjunction with the accompanying drawings, in which:

FIG. 1 is a flowchart illustrating a method for safety monitoring of a crack in a blade groove of an in-service nuclear turbine rotor according to an embodiment of the present disclosure.

FIG. 2 is a flowchart illustrating a method for safety monitoring of a crack in a blade groove of an in-service nuclear turbine rotor according to another embodiment of the present disclosure.

FIG. 3 is a flowchart illustrating acquiring a stress corrosion crack propagation life in a method for safety monitoring of a crack in a blade groove of an in-service nuclear turbine rotor according to an embodiment of the present disclosure.

2.5 FIG. 4 is a flowchart illustrating acquiring a high cycle fatigue crack propagation life in a method for safety monitoring of a crack in a blade groove of an in-service nuclear turbine rotor according to an embodiment of the present disclosure.

FIG. 5 is a flowchart illustrating acquiring a low cycle fatigue crack propagation life in a method for safety monitoring of a crack in a blade groove of an in-service nuclear turbine rotor according to an embodiment of the present disclosure.

FIG. 6 is a flowchart illustrating acquiring a low cycle fatigue crack propagation life in a method for safety monitoring of a crack in a blade groove of an in-service nuclear turbine rotor according to another embodiment of the present disclosure.

FIG. 7 is a flowchart illustrating acquiring a low cycle fatigue crack propagation life in a method for safety monitoring of a crack in a blade groove of an in-service nuclear turbine rotor according to another embodiment of the present disclosure.

FIG. 8 is a flowchart illustrating a method for safety monitoring of a crack in a blade groove of an in-service nuclear turbine rotor according to another embodiment of the present disclosure.

FIG. 9 is a flowchart illustrating a method for safety monitoring of a crack in a blade groove of an in-service nuclear turbine rotor according to another embodiment of the present disclosure.

FIG. 10 is a block diagram illustrating an apparatus for safety monitoring of a crack in a blade groove of an in-service nuclear turbine rotor according to an embodiment of the present disclosure.

FIG. 11 is a block diagram illustrating an electronic device according to an embodiment of the present disclosure.

### DETAILED DESCRIPTION

Embodiments of the present disclosure are described in detail below, and examples of embodiments are illustrated in the accompanying drawings, in which the same or similar labels represent the same or similar elements or elements with the same or similar functions. The embodiments described below with reference to the drawings are exemplary, are intended to be configured to explain the present disclosure and are not to be construed as a limitation of the present disclosure.

A method and an apparatus for safety monitoring of a crack in a blade groove of an in-service nuclear turbine rotor, an electronic device, a storage medium and a platform in embodiments of the present disclosure are described in combination with the accompanying drawings.

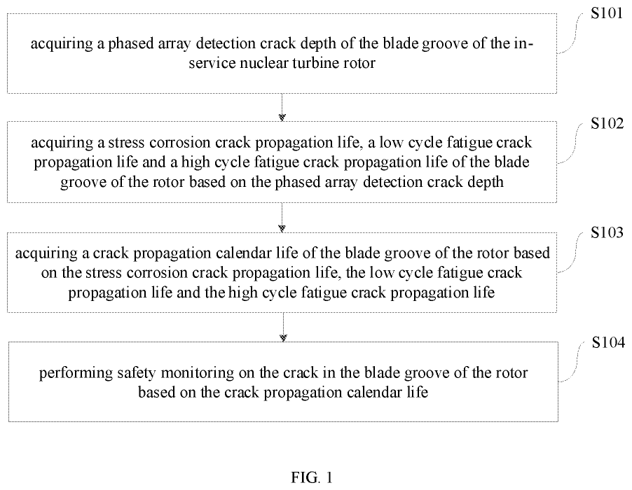

FIG. 1 is a flowchart illustrating a method for safety monitoring of a crack in a blade groove of an in-service nuclear turbine rotor according to an embodiment of the present disclosure.

As illustrated in FIG. 1, the method for safety monitoring of the crack in the blade groove of the in-service nuclear turbine rotor according to an embodiment of the present disclosure includes the following steps.

At S101, a phased array detection crack depth of the blade groove of the in-service nuclear turbine rotor is acquired.

It is noted that, the method in embodiments of the present disclosure may be executed by an apparatus for safety monitoring of a crack in a blade groove of an in-service nuclear turbine rotor in embodiments of the present disclosure, and the apparatus in embodiments of the present disclosure may be configured in any monitoring platform suitable for the in-service nuclear turbine, to perform the method in embodiments of the present disclosure.

The phased array detection crack depth may refer to a depth of the crack in the blade groove of the rotor obtained by performing phased array detection on the blade groove of the rotor. The phased array detection may be implemented by any phased array detection method in the related art.

In an implementation, acquiring the phased array detection crack depth of the blade groove of the in-service nuclear turbine rotor includes: acquiring the phased array detection crack depth during the phased array detection on the blade groove of the rotor by a phased array ultrasonic flaw detector and a phased array probe; and in response to no crack being found during the phased array detection on the blade groove of the rotor, setting the phased array detection crack depth as a preset value. It should be noted that, the preset value is not limited, and for example, may be 0.002 m.

For example, 1000 MW in-service nuclear turbines A, B and C of a certain model may operate for 20 years. In a planned overhaul, a phased array non-destructive detection and safety monitoring of the crack are performed on a fifth-stage inverted T-type blade groove of a No. 1 low-pressure rotor of an in-service nuclear turbine A, a fifth-stage inverted T-type blade groove of a No. 2 low-pressure rotor of an in-service nuclear turbine B, and a fifth-stage inverted T-type blade groove of a No. 3 low-pressure rotor of an in-service nuclear turbine C. The low-pressure rotor works near a saturated steam line (Wilson) in a transition region of superheated steam and wet steam, and is prone to stress corrosion cracking. A material mark of the low-pressure rotor may be 30Cr2Ni4MoV (3.5% NiCrMoV).

20) The phased array non-destructive detection may be performed on the fifth-stage blade groove of the No. 1 low-pressure rotor of the in-service nuclear turbine A, and no crack is found. In response to no crack being found during the phased nondestructive array detection, a depth of a crack in a load-bearing tooth surface of the fifth-stage inverted T-type blade groove of the No. 1 low-pressure rotor of the nuclear turbine A is set as aᵢ=2 mm=0.002 m.

The phased array non-destructive detection is performed on the fifth-stage inverted T-type blade groove of the No. 2 low-pressure rotor of the in-service nuclear turbine B, and a depth aᵢ=5 mm=0.005 m of a crack in a load-bearing tooth surface of the fifth-stage inverted T-type blade groove of the No. 2 low-pressure rotor of the in-service nuclear turbine B is acquired.

The non-destructive monitoring is performed on the fifth-stage inverted T-type blade groove of the No. 3 low-pressure rotor of the in-service nuclear turbine C, and a depth aᵢ=10 mm=0.010 m of a crack in a load-bearing tooth surface of the fifth-stage inverted T-type blade groove of the No. 3 low-pressure rotor of the nuclear turbine C is acquired.

At S102, a stress corrosion crack propagation life, a low cycle fatigue crack propagation life and a high cycle fatigue crack propagation life of the blade groove of the rotor are acquired based on the phased array detection crack depth.

It is noted that, the stress corrosion crack propagation life refers to a propagation life of the crack in the blade groove of the rotor when a failure category borne by the blade groove of the rotor includes stress corrosion. The low cycle fatigue crack propagation life refers to a propagation life of the crack in the blade groove of the rotor when a failure category borne by the blade groove of the rotor includes low cycle fatigue. The high cycle fatigue crack propagation life refers to a propagation life of the crack in the blade groove of the rotor when a failure category borne by the blade groove of the rotor includes high cycle fatigue.

In an implementation, acquiring the stress corrosion crack propagation life, the low cycle fatigue crack propagation life and the high cycle fatigue crack propagation life of the blade groove of the rotor based on the phased array detection crack depth includes inputting the phased array detection crack depth into a first preset model, and outputting the stress corrosion crack propagation life, the low cycle fatigue crack propagation life and the high cycle fatigue crack propagation life by the first preset model. It should be noted that, the first preset model is not limited, and for example, may include a deep learning model.

At S103, a crack propagation calendar life of the blade groove of the rotor is acquired based on the stress corrosion crack propagation life, the low cycle fatigue crack propagation life and the high cycle fatigue crack propagation life.

In an implementation, acquiring the crack propagation calendar life of the blade groove of the rotor based on the stress corrosion crack propagation life, the low cycle fatigue crack propagation life and the high cycle fatigue crack propagation life includes inputting the stress corrosion crack propagation life, the low cycle fatigue crack propagation life and the high cycle fatigue crack propagation life into a second preset model, and outputting the crack propagation calendar life by the second preset model. It should be noted that, the second preset model is not limited, and for example, may include a deep learning model.

In an implementation, acquiring the crack propagation calendar life of the blade groove of the rotor based on the stress corrosion crack propagation life, the low cycle fatigue crack propagation life and the high cycle fatigue crack propagation life includes obtaining a calendar life of the blade groove of the rotor in each phase based on the stress corrosion crack propagation life, the low cycle fatigue crack propagation life and the high cycle fatigue crack propagation life, and determining a sum value of calendar lives of the blade groove of the rotor in respective phases as the crack propagation calendar life of the blade groove of the rotor. It should be noted that the phase refers to a crack propagation phase of the blade groove of the rotor. There may be a plurality of phases, and different phased array detection crack depths and different crack propagation size sets of the blade groove of the rotor may correspond to different categories and different phases.

At S104, safety monitoring is performed on the crack in the blade groove of the rotor based on the crack propagation calendar life.

In an implementation, performing the safety monitoring on the crack in the blade groove of the rotor based on the crack propagation calendar life includes acquiring a monitoring criterion value of the blade groove of the rotor, and determining that no safety exception occurs in the blade groove of the rotor in response to the crack propagation calendar life being greater than or equal to the monitoring criterion value, and determining that the safety exception occurs in the blade groove of the rotor in response to the crack propagation calendar life being less than the monitoring criterion value.

In some examples, when determining that the safety exception occurs in the blade groove of the rotor, the method further includes generating indication information indicating that the safety exception occurs in the blade groove of the rotor, and informing a user in time that the safety exception occurs in the blade groove of the rotor.

In some examples, a mapping relationship between models of blade grooves of rotors and monitoring criterion values may be pre-established. Acquiring the monitoring criterion value of the blade groove of the rotor includes querying a monitoring criterion value in the above mapping relationship based on the model of the blade groove of the rotor, and determining the queried monitoring criterion value as the monitoring criterion value of the blade groove of the rotor.

In summary, in the method for safety monitoring of the crack in the blade groove of the in-service nuclear turbine rotor in embodiments of the present disclosure, the phased array detection crack depth of the blade groove of the in-service nuclear turbine rotor is acquired. The stress corrosion crack propagation life, the low cycle fatigue crack propagation life and the high cycle fatigue crack propagation life of the blade groove of the rotor are acquired based on the phased array detection crack depth. The crack propagation calendar life of the blade groove of the rotor is acquired based on the stress corrosion crack propagation life, the low cycle fatigue crack propagation life and the high cycle fatigue crack propagation life. The safety monitoring is performed on the crack in the blade groove of the rotor based on the crack propagation calendar life. Therefore, the safety monitoring may be performed on the crack in the blade groove of the rotor in consideration of influences of the stress corrosion, the low cycle fatigue and the high cycle fatigue on the life of the blade groove of the rotor, to ensure a long life safe operation of the rotor of the in-service nuclear turbine.

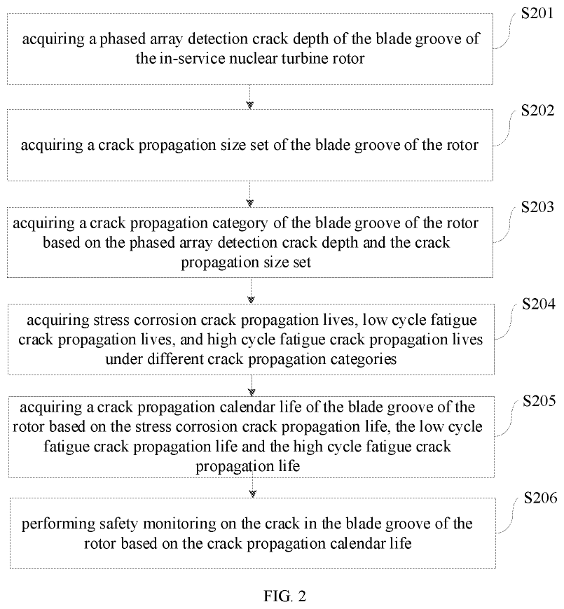

FIG. 2 is a flowchart illustrating a method for safety monitoring of a crack in a blade groove of an in-service nuclear turbine rotor according to another embodiment of the present disclosure.

As illustrated in FIG. 2, the method for safety monitoring of the crack in the blade groove of the in-service nuclear turbine rotor according to an embodiment of the present disclosure may include the following steps.

At S201, a phased array detection crack depth of the blade groove of the in-service nuclear turbine rotor is acquired.

Explanation of S201 may refer to the above embodiments, which will not be repeated herein.

At S202, a crack propagation size set of the blade groove of the rotor is acquired.

It needs to be noted that, the crack propagation size set is not limited, and for example, may include a stress corrosion crack propagation size threshold value a_{SCC}, a high cycle fatigue crack propagation size threshold value aₜₕ, a high cycle fatigue critical crack size a_{cH}, a low cycle fatigue critical crack size a_{cn} of the blade groove of the rotor under the normal shutdown transient condition of the in-service nuclear turbine, a low cycle fatigue critical crack size a_{c110%} of the blade groove of the rotor under a 110% overspeed test transient condition of the in-service nuclear turbine and a low cycle fatigue critical crack size a_{c120%} of the blade groove of the rotor under a 120% overspeed operation transient condition of the in-service nuclear turbine, etc.

In an implementation, acquiring the crack propagation size set of the blade groove of the rotor includes acquiring stress calculation basic data of the blade groove of the rotor, acquiring material test basic data of the in-service nuclear turbine rotor; and determining the crack propagation size set based on the stress calculation basic data and the material test basic data of the rotor. Therefore, in this method, the crack propagation size set may be determined in consideration of the stress calculation basic data and the material test basic data of the rotor.

It needs to be noted that, the stress calculation basic data and the material test basic data of the rotor are not limited.

For example, the stress calculation basic data includes a range Δσ_{H} of a high cycle fatigue stress at the crack location in the blade groove of the rotor and a maximum stress σ_{maxH} at the crack location in the blade groove of the rotor under the load operation steady-state condition of the in-service nuclear turbine, a maximum stress σₘₐₓₙ at the crack location in the blade groove of the rotor under the normal shutdown transient condition, a maximum stress σ_{max110%} at the crack location in the blade groove of the rotor under the 110% overspeed test transient condition, and a maximum stress σ_{max120%} at the crack location in the blade groove of the rotor under the 120% overspeed test transient condition, etc.

For example, the material test basic data of the rotor include a fracture toughness K_{IC} of a material of the rotor, a stress corrosion fracture toughness K_{ISCC} of the material of the rotor, a test value of an annual average stress corrosion crack propagation rate

$${( \frac{da}{dt} )}_{SCC} ,$$

a crack shape parameter Q, and a test value of a high cycle fatigue crack propagation threshold value Kₜₕ^{R} of the material of the rotor, etc.

In some examples, determining the crack propagation size set based on the stress calculation basic data and the material test basic data of the rotor includes the following possible implementations.

In a first implementation, the stress corrosion crack propagation size threshold value of the blade groove of the rotor is determined based on the crack shape parameter of the blade groove of the rotor, the stress corrosion fracture toughness of the material of the rotor and the maximum stress at the crack location in the blade groove of the rotor under the load operation steady-state condition of the in-service nuclear turbine.

In a second implementation, the high cycle fatigue crack propagation size threshold value of the blade groove of the rotor is determined based on the crack shape parameter of the blade groove of the rotor, the test value of the high cycle fatigue crack propagation threshold value of the material of the rotor and the range of the high cycle fatigue stress at the crack location in the blade groove of the rotor under the load operation steady-state condition of the in-service nuclear turbine.

In a third implementation, the high cycle fatigue critical crack size of the blade groove of the rotor is determined based on the crack shape parameter of the blade groove of the rotor, the fracture toughness of the material of the rotor, and the maximum stress at the crack location in the blade groove of the rotor under the load operation steady-state condition of in-service nuclear turbine.

In a fourth implementation, the low cycle fatigue critical crack size of the blade groove of the rotor under the normal shutdown transient condition of the in-service nuclear turbine is determined based on the crack shape parameter of the blade groove of the rotor, the fracture toughness of the material of the rotor, and the maximum stress at the crack location in the blade groove of the rotor under the normal shutdown transient condition of the in-service nuclear turbine.

In a fifth implementation, the low cycle fatigue critical crack size of the blade groove of the rotor under the 110% overspeed test transient condition of the in-service nuclear turbine is determined based on the crack shape parameter of the blade groove of the rotor, the fracture toughness of the material of the rotor, and the maximum stress at the crack location in the blade groove of the rotor under the 110% overspeed test transient condition of the in-service nuclear turbine.

In a sixth implementation, the low cycle fatigue critical crack size of the blade groove of the rotor under the 120% overspeed operation transient condition of the in-service nuclear turbine is determined based on the crack shape parameter of the blade groove of the rotor, the fracture toughness of the material of the rotor, and the maximum stress at the crack location in the blade groove of the rotor under the 120% overspeed operation transient condition of the in-service nuclear turbine.

For example, taking the fifth-stage inverted T-type blade groove of the No. 1 low-pressure rotor of the in-service nuclear turbine A, the fifth-stage inverted T-type blade groove of the No. 2 low-pressure rotor of the in-service nuclear turbine B, and the fifth-stage inverted T-type blade groove of the No. 3 low-pressure rotor of the in-service nuclear turbine C for example, stress calculation basic data and rotor material test basic data of the fifth-stage inverted T-type blade groove of the No. 1 low-pressure rotor of the in-service nuclear turbine A are respectively illustrated in Table 1 and Table 2, stress calculation basic data and rotor material test basic data of the fifth-stage inverted T-type blade groove of the No. 2 low-pressure rotor of the in-service nuclear turbine B are respectively illustrated in Table 1 and Table 2, and stress calculation basic data and rotor material test basic data of the fifth-stage inverted T-type blade groove of the No. 3 low-pressure rotor of the in-service nuclear turbine C are respectively illustrated in Table 1 and Table 2.

TABLE 1
stress calculation basic data of a fifth-stage inverted T-type blade
groove of a low-pressure rotor of an in-service nuclear turbine

| | | Data |
|---|---|---|
| No. | Item | Value |
| 1 | range ^{Δσ}_{H}/Mpa of a high cycle fatigue stress at a | 3.078 |
| | crack location in a blade groove of a rotor under | |
| | a load operation steady-state condition | |
| 2 | maximum stress σ_{maxH}/MPa at a crack location | 436.299 |
| | in a blade groove of a rotor under a load operation | |
| | steady-state condition | |
| 3 | maximum stress σₘₐₓₙ/MPa at a weld location | 457.918 |
| | on a surface of a rotor under a normal shutdown | |
| | transient condition | |
| 4 | maximum stress σ_{max110%}/MPa at a crack location | 481.019 |
| | in a blade groove of a rotor under a 110% | |
| | overspeed test transient condition | |
| 5 | maximum stress σ_{max120%}/MPa at a crack location | 577.005 |
| | in a blade groove of a rotor under a 120% | |
| | overspeed operation transient condition | |

TABLE 2
material test basic data of a low-pressure rotor of an in-service nuclear turbine

| No. | Item | Data Value |
|---|---|---|
| 1 | fracture toughness K_{IC}/MPa \sqrt{m} of a | 190 |
| | material of a rotor | |
| 2 | stress corrosion fracture toughness | 76 |
| | K_{ISCC}/MPa \sqrt{m} of a material of a rotor | |
| 3 | $test value {( \frac{da}{dt} )}_{SCC} / mm / a of an annual$ | 2 |
| | average stress corrosion crack propagation | |
| | rate | |
| 4 | crack shape parameter Q | steady-state condition: 0.99976 |
| | | normal shutdown: 0.98684 |
| | | 110% overspeed test: 0.97481 |
| | | 120% overspeed operation: 0.92580 |
| 5 | high cycle fatigue crack propagation | 0.9224 |
| | threshold value Kₜₕ^{R}/Mpa \sqrt{m} of a | |
| | material of a rotor | |

The maximum stress at the crack location of the blade groove of the rotor under the normal shutdown transient condition includes the maximum stress σₘₐₓₙ at the weld location on the surface of the rotor under the normal shutdown transient condition.

A calculation process of a crack propagation size set of the fifth-stage inverted T-type blade groove of the No. 1 low-pressure rotor of the in-service nuclear turbine A, the fifth-stage inverted T-type blade groove of the No. 2 low-pressure rotor of the in-service nuclear turbine B, and the fifth-stage inverted T-type blade groove of the No. 3 low-pressure rotor of the in-service nuclear turbine C is as follow:

$${a}_{SCC} = \frac{{Q ( {K}_{ISCC} )}^{2}}{1.21 {πσ}_{maxH}^{2}} = \frac{0.99976 \times {76}^{2}}{1.21 π \times {436.299}^{2}} = 0.00798 m = 7.98 mm \\ {a}_{th} = \frac{{Q ( Δ {K}_{th}^{R} )}^{2}}{1.21 {π ( {Δσ}_{H} )}^{2}} = \frac{0.99976 \times {0.9224}^{2}}{1.21 π \times {3.078}^{2}} = 0.023619 m \\ {a}_{cH} = \frac{{QK}_{IC}^{2}}{1.21 {πσ}_{maxH}^{2}} = \frac{0.99976 \times {190}^{2}}{1.21 π \times {436.299}^{2}} = 0.049877 m \\ {a}_{cn} = \frac{{QK}_{IC}^{2}}{1.21 {πσ}_{maxn}^{2}} = \frac{0.98684 \times {190}^{2}}{1.21 π \times {457.918}^{2}} = 0.044693 m = 44.693 mm \\ {a}_{c 100 \%} = \frac{{QK}_{IC}^{2}}{1.21 {πσ}_{max 110 \%}^{2}} = \frac{0.97481 \times {190}^{2}}{1.21 π \times {481.019}^{2}} = 0.04001 m \\ {a}_{c 120 \%} = \frac{{QK}_{IC}^{2}}{1.21 {πσ}_{max 120 \%}^{2}} = \frac{0.9358 \times {190}^{2}}{1.21 π \times {577.005}^{2}} = 0.02641 m$$

At S203, a crack propagation category of the blade groove of the rotor is acquired based on the phased array detection crack depth and the crack propagation size set.

In an implementation, acquiring the crack propagation category of the blade groove of the rotor based on the phased array detection crack depth and the crack propagation size set includes obtaining an operation result by performing an operation processing on the phased array detection crack depth and crack propagation sizes in the crack propagation size set, and obtaining the crack propagation category based on a correspondence between operation results and crack propagation categories. The operation processing may be achieved by adopting at least one operation processing method in the related art, which is not limited here, and for example, may include addition, subtraction, multiplication, division, etc.

In an implementation, acquiring the crack propagation category of the blade groove of the rotor based on the phased array detection crack depth and the crack propagation size set includes determining the crack propagation category based on a size relationship between the phased array detection crack depth and the crack propagation sizes in the crack propagation size set.

In some examples, acquiring the crack propagation category of the blade groove of the rotor based on the phased array detection crack depth and the crack propagation size set may include the following possible implementations.

In a first implementation, the crack propagation category is determined as a first crack propagation category in response to the phased array detection crack depth being less than the stress corrosion crack propagation size threshold value, and the stress corrosion crack propagation size threshold value being less than the high cycle fatigue crack propagation size threshold value.

In some examples, the crack propagation category is the first crack propagation category, and the first crack propagation category may include three phases. For this case, in a first phase, a crack size of the blade groove of the rotor is extended from a phased array detection crack depth aᵢ to a stress corrosion crack propagation size threshold value a_{SCC}. In a second phase, the crack size of the blade groove of the rotor is extended from the stress corrosion crack propagation size threshold value a_{SCC} to a high cycle fatigue crack propagation size threshold value aₜₕ. In a third phase, the crack size of the blade groove of the rotor is extended from the high cycle fatigue crack propagation size threshold value aₜₕ to a low cycle fatigue critical crack size a_{cj}. The low cycle fatigue critical crack size a_{cj} may be a_{cn} or a_{c110%} or a_{c120%}.

In a second implementation, the crack propagation category is determined as a second crack propagation category in response to the stress corrosion crack propagation size threshold value being less than the phased array detection crack depth, and the phased array detection crack depth being less than the high cycle fatigue crack propagation size threshold value.

In some examples, the crack propagation category is the second crack propagation category, and the second crack propagation category may include two phases. For this case, in a first phase, the crack size of the blade groove of the rotor is extended from the phased array detection crack depth aᵢ to the high cycle fatigue crack propagation size threshold value aₜₕ. In a second phase, the crack size of the blade groove of the rotor is extended from the high cycle fatigue crack propagation size threshold value aₜₕ to the low cycle fatigue critical crack size a_{cj}.

In a third implementation, the crack propagation category is determined as a third crack propagation category in response to the phased array detection crack depth being less than the high cycle fatigue crack propagation size threshold value, and the high cycle fatigue crack propagation size threshold value being less than the stress corrosion crack propagation size threshold value.

In some examples, the crack propagation category is the third crack propagation category, and the third crack propagation category may include three phases. For this case, in a first phase, the crack size of the blade groove of the rotor is extended from the phased array detection crack depth aᵢ to the high cycle fatigue crack propagation size threshold value aₜₕ. In a second phase, the crack size of the blade groove of the rotor is extended from the high cycle fatigue crack propagation size threshold value aₜₕ to the stress corrosion crack propagation size threshold value a_{SCC}. In a third phase, the crack size of the blade groove of the rotor is extended from the stress corrosion crack propagation size threshold value a_{SCC} to the low cycle fatigue critical crack size a_{cj}.

In a fourth implementation, the crack propagation category is determined as a fourth crack propagation category in response to the high cycle fatigue crack propagation size threshold value being less than the phased array detection crack depth, and the phased array detection crack depth being less than the stress corrosion crack propagation size threshold value.

In some examples, the crack propagation category is the fourth crack propagation category, and the fourth crack propagation category may include two phases. For this case, in a first phase, the crack size of the blade groove of the rotor is extended from the phased array detection crack depth aᵢ to the stress corrosion crack propagation size threshold value a_{SCC}. In a second phase, the crack size of the blade groove of the rotor is extended from the stress corrosion crack propagation size threshold value a_{SCC} to the low cycle fatigue critical crack size a_{cj}.

For example, taking the fifth-stage inverted T-type blade groove of the No. 1 low-pressure rotor of the in-service nuclear turbine A for example, the stress corrosion crack propagation size threshold value a_{SCC} is 0.007980 m, the high cycle fatigue crack propagation size threshold value aₜₕ is 0.023619 m, and a phased array non-destructive detection crack depth aᵢ is 0.002 m. Since a_{SCC}=0.007980 m<aₜₕ=0.023619 m and aᵢ=0.002 m<a_{SCC}=0.007980 m, a crack propagation category of the fifth-stage inverted T-type blade groove of the No. 1 low-pressure rotor of the in-service nuclear turbine A is the first crack propagation category.

For example, taking the fifth-stage inverted T-type blade groove of the No. 2 low-pressure rotor of the in-service nuclear turbine B for example, the stress corrosion crack propagation size threshold value a_{SCC} is 0.007980 m, the high cycle fatigue crack propagation size threshold value aₜₕ is 0.023619 m, and the phased array non-destructive detection crack depth aᵢ is 0.005 m. Since a_{SCC}=0.007980 m<aₜₕ=0.023619 m and aᵢ=0.005 m<a_{SCC}=0.007980 m, a crack propagation category of the fifth-stage inverted T-type blade groove of the No. 2 low-pressure rotor of the in-service nuclear turbine B is the first crack propagation category.

For example, taking the fifth-stage inverted T-type blade groove of the No. 3 low-pressure rotor of the in-service nuclear turbine C for example, the stress corrosion crack propagation size threshold value a_{SCC} is 0.007980 m, the high cycle fatigue crack propagation size threshold value aₜₕ is 0.023619 m, and the phased array non-destructive detection crack depth aᵢ is 0.010 m. Since a_{SCC}=0.007980 m<aₜₕ=0.023619 m and aᵢ=0.010 m>a_{SCC}=0.007980 m, a crack propagation category of the fifth-stage inverted T-type blade groove of the No. 3 low-pressure rotor of the in-service nuclear turbine C is the second crack propagation category.

At S204, a stress corrosion crack propagation life, a low cycle fatigue crack propagation lives, and a high cycle fatigue crack propagation lives under the crack propagation category of the blade groove of the rotor are acquired. Different crack propagation categories correspond to different stress corrosion crack propagation lives, different low cycle fatigue crack propagation lives, and different high cycle fatigue crack propagation lives.

In an implementation, acquiring the stress corrosion crack propagation life, the low cycle fatigue crack propagation life, and the high cycle fatigue crack propagation life under the crack propagation category includes determining life basic data matching a target crack propagation life and a crack propagation category, and obtaining a target crack propagation life under the crack propagation category based on the life basic data. The target crack propagation life is any one of the stress corrosion crack propagation life, the low cycle fatigue crack propagation life, and the high cycle fatigue crack propagation life.

It is noted that, the life basic data are not limited, and for example, may include the crack propagation size set, the stress calculation basic data of the blade groove of the rotor, material test basic data of the in-service nuclear turbine rotor, etc.

At S205, a crack propagation calendar life of the blade groove of the rotor is acquired based on the stress corrosion crack propagation life, the low cycle fatigue crack propagation life and the high cycle fatigue crack propagation life.

At S206, safety monitoring is performed on the crack in the blade groove of the rotor based on the crack propagation calendar life.

Explanation of S205-S206 may refer to the above embodiments, which will not be repeated here.

In summary, in the method for safety monitoring of the crack in the blade groove of the in-service nuclear turbine rotor in embodiments of the present disclosure, the crack propagation size set of the blade groove of the rotor is acquired. The crack propagation category of the blade groove of the rotor is acquired based on the phased array detection crack depth and the crack propagation size set. The stress corrosion crack propagation life, the low cycle fatigue crack propagation life, and the high cycle fatigue crack propagation life under the crack propagation category are acquired. In summary, the crack propagation category of the blade groove of the rotor may be acquired in consideration of the phased array detection crack depth of the blade groove of the rotor and the crack propagation size set, and the stress corrosion crack propagation lives, the low cycle fatigue crack propagation lives, and the high cycle fatigue crack propagation lives under different crack propagation categories may be acquired in consideration of the crack propagation size set of the blade groove of the rotor, to obtain the crack propagation calendar life of the blade groove of the rotor. Therefore, precision of the crack propagation calendar life of the blade groove of the rotor may be improved.

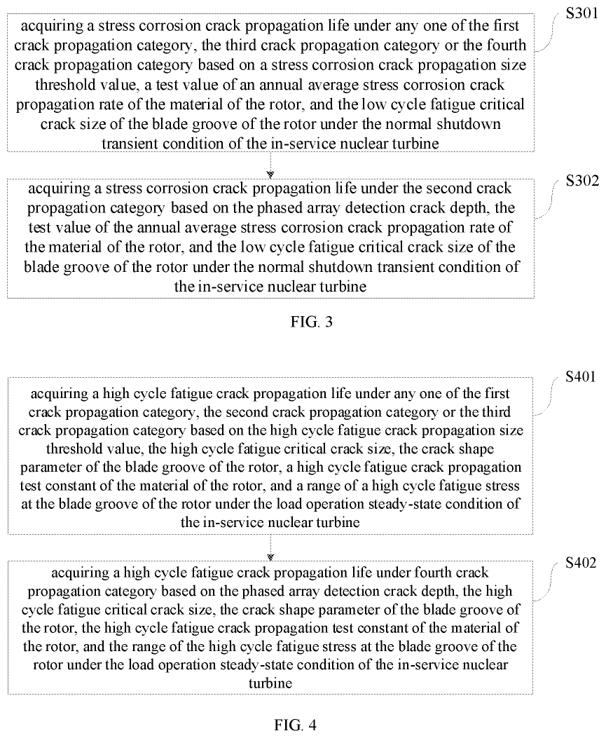

On the basis of the above any one embodiment, as illustrated in FIG. 3, acquiring the stress corrosion crack propagation life under the crack propagation category of the blade groove of the rotor may include the following steps.

At S301, a stress corrosion crack propagation life under any one of the first crack propagation category, the third crack propagation category or the fourth crack propagation category is acquired based on a stress corrosion crack propagation size threshold value, a test value of an annual average stress corrosion crack propagation rate of the material of the rotor, and the low cycle fatigue critical crack size of the blade groove of the rotor under the normal shutdown transient condition of the in-service nuclear turbine.

At S302, a stress corrosion crack propagation life under the second crack propagation category is acquired based on the phased array detection crack depth, the test value of the annual average stress corrosion crack propagation rate of the material of the rotor, and the low cycle fatigue critical crack size of the blade groove of the rotor under the normal shutdown transient condition of the in-service nuclear turbine.

In an implementation, a calculation process of the stress corrosion crack propagation life in any one of the first crack propagation category, the third crack propagation category or the fourth crack propagation category is as follow:

$${N}_{fSSC 1} = {N}_{fSCC 3} = {N}_{fSCC 4} = \frac{{a}_{cn} - {a}_{SCC}}{{( \frac{da}{dt} )}_{SCC}}$$

where, N_{fSCC1} is a stress corrosion crack propagation life under the first crack propagation category, N_{fSCC2} is a stress corrosion crack propagation life under the third crack propagation category, and N_{fSCC4} is a stress corrosion crack propagation life under the fourth crack propagation category.

In an implementation, a calculation process of the stress corrosion crack propagation life N_{fSCC2} under the second crack propagation category is as follow:

$${N}_{fSCC 2} = \frac{{a}_{cn} - {a}_{i}}{{( \frac{da}{dt} )}_{SCC}}$$

For example, taking the fifth-stage inverted T-type blade groove of the No. 1 low-pressure rotor of the in-service nuclear turbine A and the fifth-stage inverted T-type blade groove of the No. 2 low-pressure rotor of the in-service nuclear turbine B for example, the crack propagation category of the fifth-stage inverted T-type blade groove of the No. 1 low-pressure rotor of the in-service nuclear turbine A and the fifth-stage inverted T-type blade groove of the No. 2 low-pressure rotor of the in-service nuclear turbine B is the first crack propagation category, and the calculation process of the stress corrosion crack propagation life N_{fSCC} under the first crack propagation category of the fifth-stage inverted T-type blade groove of the No. 1 low-pressure rotor of the in-service nuclear turbine A and the fifth-stage inverted T-type blade groove of the No. 2 low-pressure rotor of the in-service nuclear turbine B is as follow:

$${N}_{fSCC 1} = \frac{{a}_{c n} - {a}_{SCC}}{{( \frac{da}{dt} )}_{SCC}} = \frac{44.693 - 7.980}{2} = 18.36 years$$

For example, taking the fifth-stage inverted T-type blade groove of the No. 3 low-pressure rotor of the in-service nuclear turbine C in the above embodiment for example, the crack propagation category of the fifth-stage inverted T-type blade groove of the No. 3 low-pressure rotor of the in-service nuclear turbine C is the second crack propagation category, and the calculation process of the stress corrosion crack propagation life N_{fSCC2} under the second crack propagation category of the fifth-stage inverted T-type blade groove of the No. 3 low-pressure rotor of the in-service nuclear turbine C is as follow:

$${N}_{fSCC 2} = \frac{{a}_{c n} - {a}_{i}}{{( \frac{da}{dt} )}_{SCC}} = \frac{44.693 - 10}{2} = 17.35 years$$

Thus, in this method, the stress corrosion crack propagation life under any one of the first crack propagation category, the third crack propagation category or the fourth crack propagation category may be acquired in consideration of the stress corrosion crack propagation size threshold value, the test value of the annual average stress corrosion crack propagation rate of the material of the rotor, and the low cycle fatigue critical crack size of the blade groove of the rotor under the normal shutdown transient condition of the in-service nuclear turbine, and the stress corrosion crack propagation life under the second crack propagation category may be acquired in consideration of the phased array detection crack depth, the test value of the annual average stress corrosion crack propagation rate of the material of the rotor, and the low cycle fatigue critical crack size of the blade groove of the rotor under the normal shutdown transient condition of the in-service nuclear turbine.

On the basis of the above any one embodiment, as illustrated in FIG. 4, acquiring the high cycle fatigue crack propagation life under the crack propagation category of the blade groove of the rotor includes the following steps.

At S401, a high cycle fatigue crack propagation life under any one of the first crack propagation category, the second crack propagation category or the third crack propagation category is acquired based on the high cycle fatigue crack propagation size threshold value, the high cycle fatigue critical crack size, the crack shape parameter of the blade groove of the rotor, a high cycle fatigue crack propagation test constant of the material of the rotor, and a range of a high cycle fatigue stress at the blade groove of the rotor under the load operation steady-state condition of the in-service nuclear turbine.

At S402, a high cycle fatigue crack propagation life under fourth crack propagation category is acquired based on the phased array detection crack depth, the high cycle fatigue critical crack size, the crack shape parameter of the blade groove of the rotor, the high cycle fatigue crack propagation test constant of the material of the rotor, and the range of the high cycle fatigue stress at the blade groove of the rotor under the load operation steady-state condition of the in-service nuclear turbine.

In an implementation, a calculation process of the stress corrosion crack propagation life in any one of the first crack propagation category, the second crack propagation category or the third crack propagation category is as follow:

$${N}_{fH 1} = {N}_{fH 2} = {N}_{fH 3} = \frac{2}{( {m}_{0 H} - 2 ) {{C}_{0 H} ( {Δσ}_{H} )}^{{m}_{0 H}} {( \frac{1.21 π}{Q} )}^{\frac{{m}_{0 H}}{2}}} [ \frac{1}{{a}_{th}^{\frac{{m}_{0 H} - 2}{2}}} - \frac{1}{{a}_{cH}^{\frac{{m}_{0 H} - 2}{2}}} ]$$

where, C_{0H} and m_{0H} are high cycle fatigue crack propagation test constants of the material of the rotor.
where, N_{fH1} is a high cycle fatigue crack propagation life under the first crack propagation category, N_{fH2} is a high cycle fatigue crack propagation life under the second crack propagation category, and N_{fH3} is a high cycle fatigue crack propagation life under the third crack propagation category.

In an implementation, a calculation process of the high cycle fatigue crack propagation life N_{fH4} under the fourth crack propagation category is as follow:

$${N}_{fH 4} = \frac{2}{( {m}_{0 H} - 2 ) {{C}_{0 H} ( {Δσ}_{H} )}^{{m}_{0 H}} {( \frac{1 \text{.21} π}{Q} )}^{\frac{{m}_{0 H}}{2}}} [ \frac{1}{{a}_{i}^{\frac{{m}_{0 H} - 2}{2}}} - \frac{1}{{a}_{cH}^{\frac{{m}_{0 H} - 2}{2}}} ]$$

For example, taking the fifth-stage inverted T-type blade groove of the No. 1 low-pressure rotor of the in-service nuclear turbine A and the fifth-stage inverted T-type blade groove of the No. 2 low-pressure rotor of the in-service nuclear turbine B for example, the crack propagation category of the fifth-stage inverted T-type blade groove of the No. 1 low-pressure rotor of the in-service nuclear turbine A and the fifth-stage inverted T-type blade groove of the No. 2 low-pressure rotor of the in-service nuclear turbine B is the first crack propagation category, and high cycle fatigue stresses and material test basic data of the No. 1 low-pressure rotor of the in-service nuclear turbine A and the No. 2 low-pressure rotor of the in-service nuclear turbine B are respectively illustrated in Table 3.

TABLE 3
high cycle fatigue stress and material test basic data of a
low-pressure rotor of an in-service nuclear turbine

| No. | Item | Data Value |
|---|---|---|
| 1 | range ^{Δσ}_{H}/Mpa of a high cycle fatigue stress | 3.078 |
| | at a crack location in a blade groove of a rotor | |
| 2 | high cycle fatigue crack propagation test | 2.889 |
| | constant m_{0H} of a material of a rotor | |
| 3 | high cycle fatigue crack propagation test | 6.859 × 10⁻¹² |
| | constant C_{0H} of a material of a rotor | |
| 4 | crack shape parameter Q | 0.99976 |

The calculation process of the high cycle fatigue crack propagation life N_{fH1} under the first crack propagation category for the fifth-stage inverted T-type blade groove of the No. 1 low-pressure rotor of the in-service nuclear turbine A and the fifth-stage inverted T-type blade groove of the No. 2 low-pressure rotor of the in-service nuclear turbine B is as follow:

$${N}_{fH 1} = \frac{2}{( {m}_{0 H} - 2 ) {{C}_{0 H} ( {Δσ}_{H} )}^{{m}_{0 H}} {( \frac{1.21 π}{Q} )}^{\frac{{m}_{0 H}}{2}}} [ \frac{1}{{a}_{th}^{\frac{{m}_{0 H} - 2}{2}}} - \frac{1}{{a}_{cH}^{\frac{{m}_{0 H} - 2}{2}}} ] = \frac{2}{( 2.889 - 2 ) \times 6.859 \times 1 {0}^{- 12} {( 3.078 )}^{2889} {( \frac{1 \text{.21} π}{0.99976} )}^{\frac{2.889}{2}}} [ \frac{1}{0.02361 {9}^{\frac{2.889 - 2}{2}}} - \frac{1}{0.04987 {7}^{\frac{2.889 - 2}{2}}} ] = 2.77 \times 1 {0}^{9}$$

For example, taking the fifth-stage inverted T-type blade groove of the No. 3 low-pressure rotor of the in-service nuclear turbine C in the above embodiment for example, the crack propagation category of the fifth-stage inverted T-type blade groove of the No. 3 low-pressure rotor of the in-service nuclear turbine C is the second crack propagation category, and high cycle fatigue stress and material test basic data of the No. 3 low-pressure rotor of the in-service nuclear turbine C are respectively illustrated in Table 3.

The calculation process of the high cycle fatigue crack propagation life N_{fH2} under the second crack propagation category for the fifth-stage inverted T-type blade groove of the No. 3 low-pressure rotor of the in-service nuclear turbine C is as follow:

$${N}_{fH 2} = \frac{2}{( {m}_{0 H} - 2 ) {{C}_{0 H} ( {Δσ}_{H} )}^{{m}_{0 H}} {( \frac{1 \text{.21} π}{Q} )}^{\frac{{m}_{0 H}}{2}}} [ \frac{1}{{a}_{th}^{\frac{{m}_{0 H} - 2}{2}}} - \frac{1}{{a}_{cH}^{\frac{{m}_{0 H} - 2}{2}}} ] = \frac{2}{( 2.889 - 2 ) \times 6.859 \times 1 {0}^{- 12} {( 3.078 )}^{2.889} {( \frac{1 \text{.21} π}{0.99976} )}^{\frac{2.889}{2}}} [ \frac{1}{0.02361 {9}^{\frac{2.889 - 2}{2}}} - \frac{1}{0.04987 {7}^{\frac{2.889 - 2}{2}}} ] = 2.77 \times 1 {0}^{9}$$

Thus, in this method, the high cycle fatigue crack propagation life under any one of the first crack propagation category, the second crack propagation category or the third crack propagation category may be acquired in consideration of the high cycle fatigue crack propagation size threshold value, the high cycle fatigue critical crack size, the crack shape parameter of the blade groove of the rotor, the high cycle fatigue crack propagation test constant of the material of the rotor, and the range of the high cycle fatigue stress at the blade groove of the rotor under the load operation steady-state condition of the in-service nuclear turbine. The high cycle fatigue crack propagation life under the fourth crack propagation category may be acquired in consideration of the phased array detection crack depth, the high cycle fatigue critical crack size, the crack shape parameter of the blade groove of the rotor, the high cycle fatigue crack propagation test constant of the material of the rotor, and the range of the high cycle fatigue stress at the blade groove of the rotor under the load operation steady-state condition of the in-service nuclear turbine.

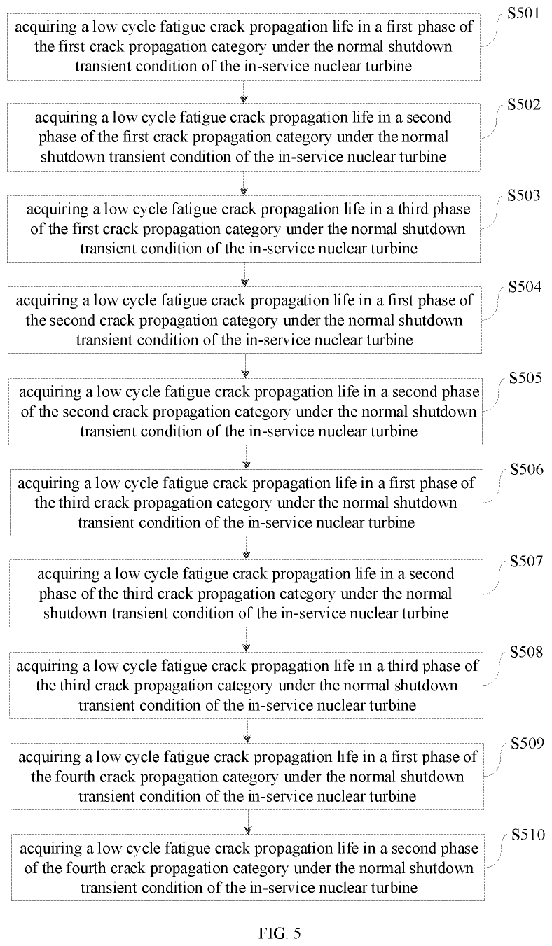

On the basis of the above any one embodiment, as illustrated in FIG. 5, acquiring the low cycle fatigue crack propagation life under the crack propagation category of the blade groove of the rotor under a normal shutdown transient condition of the in-service nuclear turbine may include the following steps.

At S501, a low cycle fatigue crack propagation life in a first phase of the first crack propagation category under the normal shutdown transient condition of the in-service nuclear turbine is acquired.

In an implementation, acquiring the low cycle fatigue crack propagation life in the first phase of the first crack propagation category under the normal shutdown transient condition of the in-service nuclear turbine includes acquiring the low cycle fatigue crack propagation life in the first phase of the first crack propagation category under the normal shutdown transient condition of the in-service nuclear turbine based on the phased array detection crack depth, the stress corrosion crack propagation size threshold value, the crack shape parameter of the blade groove of the rotor, the low cycle fatigue crack propagation test constant of the material of the rotor, and the maximum stress at the crack location in the blade groove of the rotor under the normal shutdown transient condition of the in-service nuclear turbine.

In some examples, a calculation process of the low cycle fatigue crack propagation life N_{fn1, 1} in the first phase of the first crack propagation category under the normal shutdown transient condition of the in-service nuclear turbine is as follow:

$${N}_{fn 1 , 1} = \frac{2 \times 0.5}{( {m}_{0} - 2 ) {{C}_{0} ( {σ}_{maxn} )}^{{m}_{0}} {( \frac{1 \text{.21} π}{Q} )}^{\frac{{m}_{0}}{2}}} [ \frac{1}{{a}_{i}^{\frac{{m}_{0} - 2}{2}}} - \frac{1}{{a}_{SCC}^{\frac{{m}_{0} - 2}{2}}} ]$$

where, C₀, m₀ are low fatigue crack propagation test constants of a material of the rotor.

At S502, a low cycle fatigue crack propagation life in a second phase of the first crack propagation category under the normal shutdown transient condition of the in-service nuclear turbine is acquired.

In an implementation, acquiring the low cycle fatigue crack propagation life in the second phase of the first crack propagation category under the normal shutdown transient condition of the in-service nuclear turbine includes acquiring the low cycle fatigue crack propagation life in the second phase of the first crack propagation category under the normal shutdown transient condition of the in-service nuclear turbine based on the stress corrosion crack propagation size threshold value, the high cycle fatigue crack propagation size threshold value, the crack shape parameter of the blade groove of the rotor, the low cycle fatigue crack propagation test constant of the material of the rotor, and the maximum stress at the crack location in the blade groove of the rotor under the normal shutdown transient condition of the in-service nuclear turbine.

In some examples, a calculation process of the low cycle fatigue crack propagation life N_{fn1, 2} in the second phase of the first crack propagation category under the normal shutdown transient condition of the in-service nuclear turbine is as follow:

$${N}_{fn 1 , 2} = \frac{2 \times 0.5}{( {m}_{0} - 2 ) {{C}_{0} ( {σ}_{maxn} )}^{{m}_{0}} {( \frac{1 \text{.21} π}{Q} )}^{\frac{{m}_{0}}{2}}} [ \frac{1}{{a}_{SCC}^{\frac{{m}_{0} - 2}{2}}} - \frac{1}{{a}_{th}^{\frac{{m}_{0} - 2}{2}}} ]$$

At S503, a low cycle fatigue crack propagation life in a third phase of the first crack propagation category under the normal shutdown transient condition of the in-service nuclear turbine is acquired.

In an implementation, acquiring the low cycle fatigue crack propagation life in the third phase of the first crack propagation category under the normal shutdown transient condition of the in-service nuclear turbine includes acquiring the low cycle fatigue crack propagation life in the third phase of the first crack propagation category under the normal shutdown transient condition of the in-service nuclear turbine based on the high cycle fatigue crack propagation size threshold value, the low cycle fatigue critical crack size of the blade groove of the rotor under the normal shutdown transient condition of the in-service nuclear turbine, the crack shape parameter of the blade groove of the rotor, the low cycle fatigue crack propagation test constant of the material of the rotor, and the maximum stress at the crack location in the blade groove of the rotor under the normal shutdown transient condition of the in-service nuclear turbine.

In some examples, a calculation process of the low cycle fatigue crack propagation life N_{fn1, 3} in the third phase of the first crack propagation category under the normal shutdown transient condition of the in-service nuclear turbine is as follow:

$${N}_{fn 1 , 3} = \frac{2 \times 0.5}{( {m}_{0} - 2 ) {{C}_{0} ( {σ}_{maxn} )}^{{m}_{0}} {( \frac{1 \text{.21} π}{Q} )}^{\frac{{m}_{0}}{2}}} [ \frac{1}{{a}_{th}^{\frac{{m}_{0} - 2}{2}}} - \frac{1}{{a}_{cn}^{\frac{{m}_{0} - 2}{2}}} ]$$

At S504, a low cycle fatigue crack propagation life in a first phase of the second crack propagation category under the normal shutdown transient condition of the in-service nuclear turbine is acquired.

In an implementation, acquiring the low cycle fatigue crack propagation life in the first phase of the second crack propagation category under the normal shutdown transient condition of the in-service nuclear turbine includes acquiring the low cycle fatigue crack propagation life in the first phase of the second crack propagation category under the normal shutdown transient condition of the in-service nuclear turbine based on the phased array detection crack depth, the high cycle fatigue crack propagation size threshold value, the crack shape parameter of the blade groove of the rotor, the low cycle fatigue crack propagation test constant of the material of the rotor, and the maximum stress at the crack location in the blade groove of the rotor under the normal shutdown transient condition of the in-service nuclear turbine.

In some examples, a calculation process of the low cycle fatigue crack propagation life N_{fn2, 1} in the first phase of the second crack propagation category under the normal shutdown transient condition of the in-service nuclear turbine is as follow:

$${N}_{fn 2 , 1} = \frac{2 \times 0.5}{( {m}_{0} - 2 ) {{C}_{0} ( {σ}_{maxn} )}^{{m}_{0}} {( \frac{1 \text{.21} π}{Q} )}^{\frac{{m}_{0}}{2}}} [ \frac{1}{{a}_{i}^{\frac{{m}_{0} - 2}{2}}} - \frac{1}{{a}_{th}^{\frac{{m}_{0} - 2}{2}}} ]$$

At S505, a low cycle fatigue crack propagation life in a second phase of the second crack propagation category under the normal shutdown transient condition of the in-service nuclear turbine is acquired.

In an implementation, acquiring the low cycle fatigue crack propagation life in the second phase of the phase crack propagation category under the normal shutdown transient condition of the in-service nuclear turbine includes acquiring the low cycle fatigue crack propagation life in the second phase of the second crack propagation category under the normal shutdown transient condition of the in-service nuclear turbine based on the high cycle fatigue crack propagation size threshold value, the low cycle fatigue critical crack size of the blade groove of the rotor under the normal shutdown transient condition of the in-service nuclear turbine, the crack shape parameter of the blade groove of the rotor, the low cycle fatigue crack propagation test constant of the material of the rotor, and the maximum stress at the crack location in the blade groove of the rotor under the normal shutdown transient condition of the in-service nuclear turbine.

In some examples, a calculation process of the low cycle fatigue crack propagation life N_{fn2, 2} in the second phase of the second crack propagation category under the normal shutdown transient condition of the in-service nuclear turbine is as follow:

$${N}_{fn 2 , 2} = \frac{2 \times 0.5}{( {m}_{0} - 2 ) {{C}_{0} ( {σ}_{maxn} )}^{{m}_{0}} {( \frac{1 \text{.21} π}{Q} )}^{\frac{{m}_{0}}{2}}} [ \frac{1}{{a}_{th}^{\frac{{m}_{0} - 2}{2}}} - \frac{1}{{a}_{cn}^{\frac{{m}_{0} - 2}{2}}} ]$$

At S506, a low cycle fatigue crack propagation life in a first phase of the third crack propagation category under the normal shutdown transient condition of the in-service nuclear turbine is acquired.

In an implementation, acquiring the low cycle fatigue crack propagation life in the first phase of the third crack propagation category under the normal shutdown transient condition of the in-service nuclear turbine includes acquiring the low cycle fatigue crack propagation life in the first phase of the third crack propagation category under the normal shutdown transient condition of the in-service nuclear turbine based on the phased array detection crack depth, the high cycle fatigue crack propagation size threshold value, the crack shape parameter of the blade groove of the rotor, the low cycle fatigue crack propagation test constant of the material of the rotor, and the maximum stress at the crack location in the blade groove of the rotor under the normal shutdown transient condition of the in-service nuclear turbine.

In some examples, a calculation process of the low cycle fatigue crack propagation life N_{fn3, 1} in the first phase of the third crack propagation category under the normal shutdown transient condition of the in-service nuclear turbine is as follow:

$${N}_{fn 3 , 1} = \frac{2 \times 0.5}{( {m}_{0} - 2 ) {{C}_{0} ( {σ}_{maxn} )}^{{m}_{0}} {( \frac{1 \text{.21} π}{Q} )}^{\frac{{m}_{0}}{2}}} [ \frac{1}{{a}_{i}^{\frac{{m}_{0} - 2}{2}}} - \frac{1}{{a}_{th}^{\frac{{m}_{0} - 2}{2}}} ]$$

At S507, a low cycle fatigue crack propagation life in a second phase of the third crack propagation category under the normal shutdown transient condition of the in-service nuclear turbine is acquired.

In an implementation, acquiring the low cycle fatigue crack propagation life in the second phase of the third crack propagation category under the normal shutdown transient condition of the in-service nuclear turbine includes acquiring the low cycle fatigue crack propagation life in the second phase of the third crack propagation category under the normal shutdown transient condition of the in-service nuclear turbine based on the high cycle fatigue crack propagation size threshold value, the stress corrosion crack propagation size threshold value, the crack shape parameter of the blade groove of the rotor, the low cycle fatigue crack propagation test constant of the material of the rotor, and the maximum stress at the crack location in the blade groove of the rotor under the normal shutdown transient condition of the in-service nuclear turbine.

In some examples, a calculation process of the low cycle fatigue crack propagation life N_{fn3, 2} in the second phase of the third crack propagation category under the normal shutdown transient condition of the in-service nuclear turbine is as follow:

$${N}_{fn 3 , 2} = \frac{2 \times 0.5}{( {m}_{0} - 2 ) {{C}_{0} ( {σ}_{maxn} )}^{{m}_{0}} {( \frac{1 \text{.21} π}{Q} )}^{\frac{{m}_{0}}{2}}} [ \frac{1}{{a}_{th}^{\frac{{m}_{0} - 2}{2}}} - \frac{1}{{a}_{SCC}^{\frac{{m}_{0} - 2}{2}}} ]$$

At S508, a low cycle fatigue crack propagation life in a third phase of the third crack propagation category under the normal shutdown transient condition of the in-service nuclear turbine is acquired.

In an implementation, acquiring the low cycle fatigue crack propagation life in the third phase of the third crack propagation category under the normal shutdown transient condition of the in-service nuclear turbine includes acquiring the low cycle fatigue crack propagation life in the third phase of the third crack propagation category under the normal shutdown transient condition of the in-service nuclear turbine based on the stress corrosion crack propagation size threshold value, the low cycle fatigue critical crack size of the blade groove of the rotor under the normal shutdown transient condition of the in-service nuclear turbine, the crack shape parameter of the blade groove of the rotor, the low cycle fatigue crack propagation test constant of the material of the rotor, and the maximum stress at the crack location in the blade groove of the rotor under the normal shutdown transient condition of the in-service nuclear turbine.

In some examples, a calculation process of the low cycle fatigue crack propagation life N_{fn3,3} in the third phase of the third crack propagation category under the normal shutdown transient condition of the in-service nuclear turbine is as follow:

$${N}_{fn 3 , 3} = \frac{2 \times 0.5}{( {m}_{0} - 2 ) {{C}_{0} ( {σ}_{maxn} )}^{{m}_{0}} {( \frac{1 \text{.21} π}{Q} )}^{\frac{{m}_{0}}{2}}} [ \frac{1}{{a}_{SCC}^{\frac{{m}_{0} - 2}{2}}} - \frac{1}{{a}_{cn}^{\frac{{m}_{0} - 2}{2}}} ]$$

At S509, a low cycle fatigue crack propagation life in a first phase of the fourth crack propagation category under the normal shutdown transient condition of the in-service nuclear turbine is acquired.

In an implementation, acquiring the low cycle fatigue crack propagation life in the first phase of the fourth crack propagation category under the normal shutdown transient condition of the in-service nuclear turbine includes acquiring the low cycle fatigue crack propagation life in the first phase of the fourth crack propagation category under the normal shutdown transient condition of the in-service nuclear turbine based on the phased array detection crack depth, the stress corrosion crack propagation size threshold value, the crack shape parameter of the blade groove of the rotor, the low cycle fatigue crack propagation test constant of the material of the rotor, and the maximum stress at the crack location in the blade groove of the rotor under the normal shutdown transient condition of the in-service nuclear turbine.

In some examples, a calculation process of the low cycle fatigue crack propagation life N_{fn4,1} in the first phase of the fourth crack propagation category under the normal shutdown transient condition of the in-service nuclear turbine is as follow:

$${N}_{fn 4 , 1} = \frac{2 \times 0.5}{( {m}_{0} - 2 ) {{C}_{0} ( {σ}_{maxn} )}^{{m}_{0}} {( \frac{1.21 π}{Q} )}^{\frac{{m}_{0}}{2}}} [ \frac{1}{{a}_{i}^{\frac{{m}_{0} - 2}{2}}} - \frac{1}{{a}_{SCC}^{\frac{{m}_{0} - 2}{2}}} ]$$

At S510, a low cycle fatigue crack propagation life in a second phase of the fourth crack propagation category under the normal shutdown transient condition of the in-service nuclear turbine is acquired.

In an implementation, acquiring the low cycle fatigue crack propagation life in the second phase of the fourth crack propagation category under the normal shutdown transient condition of the in-service nuclear turbine includes acquiring the low cycle fatigue crack propagation life in the second phase of the fourth crack propagation category under the normal shutdown transient condition of the in-service nuclear turbine based on the stress corrosion crack propagation size threshold value, the low cycle fatigue critical crack size of the blade groove of the rotor under the normal shutdown transient condition of the in-service nuclear turbine, the crack shape parameter of the blade groove of the rotor, the low cycle fatigue crack propagation test constant of the material of the rotor, and the maximum stress at the crack location in the blade groove of the rotor under the normal shutdown transient condition of the in-service nuclear turbine.

In some examples, a calculation process of the low cycle fatigue crack propagation life N_{fn4,2} in the second phase of the fourth crack propagation category under the normal shutdown transient condition of the in-service nuclear turbine is as follow:

$${N}_{fn 4 , 2} = \frac{2 \times 0.5}{( {m}_{0} - 2 ) {{C}_{0} ( {σ}_{maxn} )}^{{m}_{0}} {( \frac{1.21 π}{Q} )}^{\frac{{m}_{0}}{2}}} [ \frac{1}{{a}_{SCC}^{\frac{{m}_{0} - 2}{2}}} - \frac{1}{{a}_{cn}^{\frac{{m}_{0} - 2}{2}}} ]$$

For example, taking the fifth-stage inverted T-type blade groove of the No. 1 low-pressure rotor of the in-service nuclear turbine A in the above embodiment for example, the crack propagation category of the fifth-stage inverted T-type blade groove of the No. 1 low-pressure rotor of the in-service nuclear turbine A is the first crack propagation category, and a low cycle fatigue stress and material test basic data of the No. 1 low-pressure rotor under the normal shutdown condition of the in-service nuclear turbine A are as illustrated in Table 4.

TABLE 4
low cycle fatigue stress and material test basic data of a low-pressure
rotor under a normal shutdown condition of an in-service nuclear turbine

| No. | Item | Data Value |
|---|---|---|
| 1 | maximum stress σₘₐₓₙ/MPa at a crack | 457.918 |
| | location in a blade groove of a rotor | |
| | under a normal shutdown transient condition | |
| 2 | low cycle fatigue crack propagation test | 2.556 |
| | constant m ₀ of a material of a rotor | |
| 3 | low cycle fatigue crack propagation test | 1.593 × 10⁻¹¹ |
| | constant C ₀ of a material | |
| 4 | crack shape parameter Q | 0.98684 |

A calculation process of the low cycle fatigue crack propagation lives under the first crack propagation category of the fifth-stage inverted T-type blade groove of the No. 1 low-pressure rotor under the normal shutdown transient condition of the in-service nuclear turbine A is as follow:

$${N}_{fn 1 , 1} = \frac{2 \times 0.5}{( {m}_{0} - 2 ) {{C}_{0} ( {σ}_{maxn} )}^{{m}_{0}} {( \frac{1.21 π}{Q} )}^{\frac{{m}_{0}}{2}}} [ \frac{1}{{a}_{i}^{\frac{{m}_{0} - 2}{2}}} - \frac{1}{{a}_{SCC}^{\frac{{m}_{0} - 2}{2}}} ] = \frac{2 \times 0.5}{( 2.556 - 2 ) \times 1.593 \times 1 {0}^{- 11} {( 457.918 )}^{2.556} {( \frac{1.21 π}{0.98684} )}^{\frac{2.556}{2}}} [ \text{} \frac{1}{0.0 {02}^{\frac{2.556 - 2}{2}}} - \frac{1}{0.00 {798}^{\frac{2.556 - 2}{2}}} ] = 5725$$

$${N}_{fn 1 , 2} = \frac{2 \times 0.5}{( {m}_{0} - 2 ) {{C}_{0} ( {σ}_{maxn} )}^{{m}_{0}} {( \frac{1.21 π}{Q} )}^{\frac{{m}_{0}}{2}}} [ \frac{1}{{a}_{SCC}^{\frac{{m}_{0} - 2}{2}}} - \frac{1}{{a}_{th}^{\frac{{m}_{0} - 2}{2}}} ] = \frac{2 \times 0.5}{( 2.556 - 2 ) \times 1.593 \times 1 {0}^{- 11} {( 457.918 )}^{2.556} {( \frac{1.21 π}{0.98684} )}^{\frac{2.556}{2}}} [ \text{} \frac{1}{{0.00798}^{\frac{2.556 - 2}{2}}} - \frac{1}{{0.023619}^{\frac{2.556 - 2}{2}}} ] = 3177$$

$${N}_{fn 1 , 3} = \frac{2 \times 0.5}{( {m}_{0} - 2 ) {{C}_{0} ( {σ}_{maxn} )}^{{m}_{0}} {( \frac{1.21 π}{Q} )}^{\frac{{m}_{0}}{2}}} [ \frac{1}{{a}_{th}^{\frac{{m}_{0} - 2}{2}}} - \frac{1}{{a}_{cn}^{\frac{{m}_{0} - 2}{2}}} ] = \frac{2 \times 0.5}{\begin{matrix}( 2.5 56 - 2 ) \times 1.5 \; 93 \times \\ {10}^{- 11} {( 457.918 )}^{2.556} {( \frac{1.21 π}{0.98684} )}^{\frac{2.556}{2}}\end{matrix}} [ \text{} \frac{1}{{0.023619}^{\frac{2.556 - 2}{2}}} - \frac{1}{{0.044693}^{\frac{2.556 - 2}{2}}} ] = 1466$$

For example, taking the fifth-stage inverted T-type blade groove of the No. 2 low-pressure rotor of the in-service nuclear turbine B in the above embodiment for example, the crack propagation category of the fifth-stage inverted T-type blade groove of the No. 2 low-pressure rotor of the in-service nuclear turbine B is the first crack propagation category, and a low cycle fatigue stress and material test basic data of the No. 2 low-pressure rotor under the normal shutdown condition of the in-service nuclear turbine B are as illustrated in Table 4.

A calculation process of the low cycle fatigue crack propagation lives under the first crack propagation category of the fifth-stage inverted T-type blade groove of the No. 2 low-pressure rotor under the normal shutdown condition of the in-service nuclear turbine B is as follow:

$${N}_{fn 1 , 1} = \frac{2 \times 0.5}{( {m}_{0} - 2 ) {{C}_{0} ( {σ}_{maxn} )}^{{m}_{0}} {( \frac{1.21 π}{Q} )}^{\frac{{m}_{0}}{2}}} [ \frac{1}{{a}_{i}^{\frac{{m}_{0} - 2}{2}}} - \frac{1}{{a}_{SCC}^{\frac{{m}_{0} - 2}{2}}} ] = \frac{2 \times 0.5}{( 2.556 - 2 ) \times 1.593 \times 1 {0}^{- 11} {( 457.918 )}^{2.556} {( \frac{1.21 π}{0.98684} )}^{\frac{2.556}{2}}} [ \text{} \frac{1}{{0.005}^{\frac{2.556 - 2}{2}}} - \frac{1}{0.00 {798}^{\frac{2.556 - 2}{2}}} ] = 1693$$

$${N}_{fn 1 , 2} = \frac{2 \times 0.5}{( {m}_{0} - 2 ) {{C}_{0} ( {σ}_{maxn} )}^{{m}_{0}} {( \frac{1.21 π}{Q} )}^{\frac{{m}_{0}}{2}}} [ \frac{1}{{a}_{SCC}^{\frac{{m}_{0} - 2}{2}}} - \frac{1}{{a}_{th}^{\frac{{m}_{0} - 2}{2}}} ] \frac{2 \times 0.5}{( 2.556 - 2 ) \times 1.593 \times 1 {0}^{- 11} {( 457.918 )}^{2.556} {( \frac{1.21 π}{0.98684} )}^{\frac{2.556}{2}}} [ \text{} \frac{1}{{0.00798}^{\frac{2.556 - 2}{2}}} - \frac{1}{{0.023619}^{\frac{2.556 - 2}{2}}} ] = 3177$$

$${N}_{fn 1 , 3} = \frac{2 \times 0.5}{( {m}_{0} - 2 ) {{C}_{0} ( {σ}_{maxn} )}^{{m}_{0}} {( \frac{1.21 π}{Q} )}^{\frac{{m}_{0}}{2}}} [ \frac{1}{{a}_{th}^{\frac{{m}_{0} - 2}{2}}} - \frac{1}{{a}_{cn}^{\frac{{m}_{0} - 2}{2}}} ] \frac{2 \times 0.5}{\begin{matrix}( 2.5 56 - 2 ) \times 1.5 \; 93 \times \\ {10}^{- 11} {( 457.918 )}^{2.556} {( \frac{1.21 π}{0.98684} )}^{\frac{2.556}{2}}\end{matrix}} [ \text{} \frac{1}{{0.023619}^{\frac{2.556 - 2}{2}}} \text{} - \frac{1}{{0.044693}^{\frac{2.556 - 2}{2}}} ] = 1466$$

For example, taking the fifth-stage inverted T-type blade groove of the No. 3 low-pressure rotor of the in-service nuclear turbine C in the above embodiment for example, the crack propagation category of the fifth-stage inverted T-type blade groove of the No. 3 low-pressure rotor of the in-service nuclear turbine C is the second crack propagation category, and a low cycle fatigue stress and material test basic data of the No. 3 low-pressure rotor under the normal shutdown condition of the in-service nuclear turbine C are as illustrated in Table 4.

A calculation process of the low cycle fatigue crack propagation lives under the second crack propagation category of the fifth-stage inverted T-type blade groove of the No. 3 low-pressure rotor under the normal shutdown transient condition of the in-service nuclear turbine C is as follow:

$${N}_{fn 2 , 1} = \frac{2 \times 0.5}{( {m}_{0} - 2 ) {{C}_{0} ( {σ}_{maxn} )}^{{m}_{0}} {( \frac{1.21 π}{Q} )}^{\frac{{m}_{0}}{2}}} [ \frac{1}{{a}_{i}^{\frac{{m}_{0} - 2}{2}}} - \frac{1}{{a}_{th}^{\frac{{m}_{0} - 2}{2}}} ] \frac{2 \times 0.5}{( 2.556 - 2 ) \times 1.593 \times 1 {0}^{- 11} {( 457.918 )}^{2.556} {( \frac{1.21 π}{0.98684} )}^{\frac{2.556}{2}}} [ \text{} \frac{1}{{0.01}^{\frac{2.556 - 2}{2}}} - \frac{1}{{0.023619}^{\frac{2.556 - 2}{2}}} ] = 2435$$

$${N}_{fn 2 , 2} = \frac{2 \times 0.5}{( {m}_{0} - 2 ) {{C}_{0} ( {σ}_{maxn} )}^{{m}_{0}} {( \frac{1.21 π}{Q} )}^{\frac{{m}_{0}}{2}}} [ \frac{1}{{a}_{th}^{\frac{{m}_{0} - 2}{2}}} - \frac{1}{{a}_{cn}^{\frac{{m}_{0} - 2}{2}}} ] \frac{2 \times 0.5}{\begin{matrix}( 2.5 56 - 2 ) \times 1.5 \; 93 \times \\ {10}^{- 11} {( 457.918 )}^{2.556} {( \frac{1.21 π}{0.98684} )}^{\frac{2.556}{2}}\end{matrix}} [ \text{} \frac{1}{{0.023619}^{\frac{2.556 - 2}{2}}} - \frac{1}{{0.044693}^{\frac{2.556 - 2}{2}}} ] = 1466$$

Thus, in the method, the low cycle fatigue crack propagation lives under the crack propagation category of the blade groove of the rotor under the normal shutdown transient condition of the in-service nuclear turbine may be acquired in consideration of the crack shape parameter of the blade groove of the rotor, the low cycle fatigue crack propagation test constant of the material of the rotor, the maximum stress at the crack location in the blade groove of the rotor under the normal shutdown transient condition of the in-service nuclear turbine and the crack propagation size set of the blade groove of the rotor.

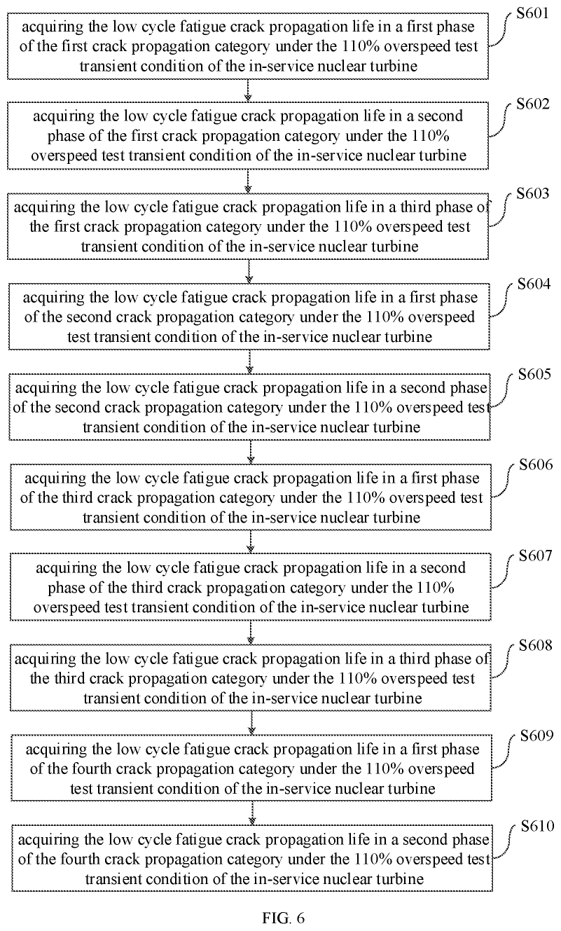

On the basis of the above any one embodiment, as illustrated in FIG. 6, acquiring the low cycle fatigue crack propagation lives under the crack propagation category under a 100% overspeed test transient condition of the in-service nuclear turbine includes the following steps.

At S601, a low cycle fatigue crack propagation life in a first phase of the first crack propagation category under the 110% overspeed test transient condition of the in-service nuclear turbine is acquired.

In an implementation, acquiring the low cycle fatigue crack propagation life in the first phase of the first crack propagation category under the 110% overspeed test transient condition of the in-service nuclear turbine includes acquiring the low cycle fatigue crack propagation life in the first phase of the first crack propagation category under the 110% overspeed test transient condition of the in-service nuclear turbine based on the phased array detection crack depth, the stress corrosion crack propagation size threshold value, the crack shape parameter of the blade groove of the rotor, the low cycle fatigue crack propagation test constant of the material of the rotor, and the maximum stress at the crack location in the blade groove of the rotor under the 110% overspeed test transient condition of the in-service nuclear turbine.

In some examples, a calculation process of the low cycle fatigue crack propagation life N_{f110% 1.1} in the first phase of the first crack propagation category under the 110% overspeed test transient condition of the in-service nuclear turbine is as follow:

$${N}_{fl 10 \%1 , 1} = \frac{2 \times 0.5}{( {m}_{0} - 2 ) {{C}_{0} ( {σ}_{max 110 \%} )}^{{m}_{0}} {( \frac{1.21 π}{Q} )}^{\frac{{m}_{0}}{2}}} [ \frac{1}{{a}_{i}^{\frac{{m}_{0} - 2}{2}}} - \frac{1}{{a}_{SCC}^{\frac{{m}_{0} - 2}{2}}} ]$$

At S602, a low cycle fatigue crack propagation life in a second phase of the first crack propagation category under the 110% overspeed test transient condition of the in-service nuclear turbine is acquired.

In an implementation, acquiring the low cycle fatigue crack propagation life in the second phase of the first crack propagation category under the 110% overspeed test transient condition of the in-service nuclear turbine includes acquiring the low cycle fatigue crack propagation life in the second phase of the first crack propagation category under the 110% overspeed test transient condition of the in-service nuclear turbine based on the stress corrosion crack propagation size threshold value, the high cycle fatigue crack propagation size threshold value, the crack shape parameter of the blade groove of the rotor, the low cycle fatigue crack propagation test constant of the material of the rotor, and the maximum stress at the crack location in the blade groove of the rotor under the 110% overspeed test transient condition of the in-service nuclear turbine.

In some examples, a calculation process of the low cycle fatigue crack propagation life N_{f110% 1.2} in the second phase of the first crack propagation category under the 110% overspeed test transient condition of the in-service nuclear turbine is as follow:

$${N}_{fl 10 \%1 , 2} = \frac{2 \times 0.5}{( {m}_{0} - 2 ) {{C}_{0} ( {σ}_{max 110 \%} )}^{{m}_{0}} {( \frac{1.21 π}{Q} )}^{\frac{{m}_{0}}{2}}} [ \frac{1}{{a}_{SCC}^{\frac{{m}_{0} - 2}{2}}} - \frac{1}{{a}_{th}^{\frac{{m}_{0} - 2}{2}}} ]$$

At S603, a low cycle fatigue crack propagation life in a third phase of the first crack propagation category under the 110% overspeed test transient condition of the in-service nuclear turbine is acquired.

In an implementation, acquiring the low cycle fatigue crack propagation life in the third phase of the first crack propagation category under the 110% overspeed test transient condition of the in-service nuclear turbine includes acquiring the low cycle fatigue crack propagation life in the third phase of the first crack propagation category under the 110% overspeed test transient condition of the in-service nuclear turbine based on the high cycle fatigue crack propagation size threshold value, the low cycle fatigue critical crack size of the blade groove of the rotor under the 110% overspeed test transient condition of the in-service nuclear turbine, the crack shape parameter of the blade groove of the rotor, the low cycle fatigue crack propagation test constant of the material of the rotor, and the maximum stress at the crack location in the blade groove of the rotor under the 110% overspeed test transient condition of the in-service nuclear turbine.

In some examples, a calculation process of the low cycle fatigue crack propagation life N_{f110% 1.3} in the third phase of the first crack propagation category under the 110% overspeed test transient condition of the in-service nuclear turbine is as follow:

$${N}_{fl 10 \%1 , 3} = \frac{2 \times 0.5}{( {m}_{0} - 2 ) {{C}_{0} ( {σ}_{max 110 \%} )}^{{m}_{0}} {( \frac{1.21 π}{Q} )}^{\frac{{m}_{0}}{2}}} [ \frac{1}{{a}_{th}^{\frac{{m}_{0} - 2}{2}}} - \frac{1}{{a}_{c 110 \%}^{\frac{{m}_{0} - 2}{2}}} ]$$

At S604, a low cycle fatigue crack propagation life in a first phase of the second crack propagation category under the 110% overspeed test transient condition of the in-service nuclear turbine is acquired.

In an implementation, acquiring the low cycle fatigue crack propagation life in the first phase of the second crack propagation category under the 110% overspeed test transient condition of the in-service nuclear turbine includes acquiring the low cycle fatigue crack propagation life in the first phase of the second crack propagation category under the 110% overspeed test transient condition of the in-service nuclear turbine based on the phased array detection crack depth, the high cycle fatigue crack propagation size threshold value, the crack shape parameter of the blade groove of the rotor, the low cycle fatigue crack propagation test constant of the material of the rotor, and the maximum stress at the crack location in the blade groove of the rotor under the 110% overspeed test transient condition of the in-service nuclear turbine.

In some examples, a calculation process of the low cycle fatigue crack propagation life N_{f110% 2.1} in the first phase of the second crack propagation category under the 110% overspeed test transient condition of the in-service nuclear turbine is as follow:

$${N}_{fl 10 \%1 , 1} = \frac{2 \times 0.5}{( {m}_{0} - 2 ) {{C}_{0} ( {σ}_{max 110 \%} )}^{{m}_{0}} {( \frac{1.21 π}{Q} )}^{\frac{{m}_{0}}{2}}} [ \frac{1}{{a}_{i}^{\frac{{m}_{0} - 2}{2}}} - \frac{1}{{a}_{th}^{\frac{{m}_{0} - 2}{2}}} ]$$

At S605, a low cycle fatigue crack propagation life in a second phase of the second crack propagation category under the 110% overspeed test transient condition of the in-service nuclear turbine is acquired.

In an implementation, acquiring the low cycle fatigue crack propagation life in the second phase of the second crack propagation category under the 110% overspeed test transient condition of the in-service nuclear turbine includes acquiring the low cycle fatigue crack propagation life in the second phase of the second crack propagation category under the 110% overspeed test transient condition of the in-service nuclear turbine based on the high cycle fatigue crack propagation size threshold value, the low cycle fatigue critical crack size of the blade groove of the rotor under the 110% overspeed test transient condition of the in-service nuclear turbine, the crack shape parameter of the blade groove of the rotor, the low cycle fatigue crack propagation test constant of the material of the rotor, and the maximum stress at the crack location in the blade groove of the rotor under the 110% overspeed test transient condition of the in-service nuclear turbine.

In some examples, a calculation process of the low cycle fatigue crack propagation life N_{f110% 2.2} in the second phase of the second crack propagation category under the 110% overspeed test transient condition of the in-service nuclear turbine is as follow:

$${N}_{fl 10 \%2 , 2} = \frac{2 \times 0.5}{( {m}_{0} - 2 ) {{C}_{0} ( {σ}_{max 110 \%} )}^{{m}_{0}} {( \frac{1.21 π}{Q} )}^{\frac{{m}_{0}}{2}}} [ \frac{1}{{a}_{th}^{\frac{{m}_{0} - 2}{2}}} - \frac{1}{{a}_{c 110 \%}^{\frac{{m}_{0} - 2}{2}}} ]$$

At S606, a low cycle fatigue crack propagation life in a first phase of the third crack propagation category under the 110% overspeed test transient condition of the in-service nuclear turbine is acquired.

In an implementation, acquiring the low cycle fatigue crack propagation life in the first phase of the third crack propagation category under the 110% overspeed test transient condition of the in-service nuclear turbine includes acquiring the low cycle fatigue crack propagation life in the first phase of the third crack propagation category under the 110% overspeed test transient condition of the in-service nuclear turbine based on the phased array detection crack depth, the high cycle fatigue crack propagation size threshold value, the crack shape parameter of the blade groove of the rotor, the low cycle fatigue crack propagation test constant of the material of the rotor, and the maximum stress at the crack location in the blade groove of the rotor under the 110% overspeed test transient condition of the in-service nuclear turbine.

In some examples, a calculation process of the low cycle fatigue crack propagation life N_{f110% 3.1} in the first phase of the third crack propagation category under the 110% overspeed test transient condition of the in-service nuclear turbine is as follow:

$${N}_{fl 10 \%3 , 1} = \frac{2 \times 0.5}{( {m}_{0} - 2 ) {{C}_{0} ( {σ}_{max 110 \%} )}^{{m}_{0}} {( \frac{1.21 π}{Q} )}^{\frac{{m}_{0}}{2}}} [ \frac{1}{{a}_{i}^{\frac{{m}_{0} - 2}{2}}} - \frac{1}{{a}_{th}^{\frac{{m}_{0} - 2}{2}}} ]$$

At S607, a low cycle fatigue crack propagation life in a second phase of the third crack propagation category under the 110% overspeed test transient condition of the in-service nuclear turbine is acquired.

In an implementation, acquiring the low cycle fatigue crack propagation life in the second phase of the third crack propagation category under the 110% overspeed test transient condition of the in-service nuclear turbine includes acquiring the low cycle fatigue crack propagation life in the second phase of the third crack propagation category under the 110% overspeed test transient condition of the in-service nuclear turbine based on the high cycle fatigue crack propagation size threshold value, the stress corrosion crack propagation size threshold value, the crack shape parameter of the blade groove of the rotor, the low cycle fatigue crack propagation test constant of the material of the rotor, and the maximum stress at the crack location in the blade groove of the rotor under the 110% overspeed test transient condition of the in-service nuclear turbine.

In some examples, a calculation process of the low cycle fatigue crack propagation life N_{f110% 3.2} in the second phase of the third crack propagation category under the 110% overspeed test transient condition of the in-service nuclear turbine is as follow:

$${N}_{fl 10 \%3 , 2} = \frac{2 \times 0.5}{( {m}_{0} - 2 ) {{C}_{0} ( {σ}_{max 110 \%} )}^{{m}_{0}} {( \frac{1.21 π}{Q} )}^{\frac{{m}_{0}}{2}}} [ \frac{1}{{a}_{th}^{\frac{{m}_{0} - 2}{2}}} - \frac{1}{{a}_{SCC}^{\frac{{m}_{0} - 2}{2}}} ]$$

At S608, a low cycle fatigue crack propagation life in a third phase of the third crack propagation category under the 110% overspeed test transient condition of the in-service nuclear turbine is acquired.

In an implementation, acquiring the low cycle fatigue crack propagation life in the third phase of the third crack propagation category under the 110% overspeed test transient condition of the in-service nuclear turbine includes acquiring the low cycle fatigue crack propagation life in the third phase of the third crack propagation category under the 110% overspeed test transient condition of the in-service nuclear turbine based on the stress corrosion crack propagation size threshold value, the low cycle fatigue critical crack size of the blade groove of the rotor under the 110% overspeed test transient condition of the in-service nuclear turbine, the crack shape parameter of the blade groove of the rotor, the low cycle fatigue crack propagation test constant of the material of the rotor, and the maximum stress at the crack location in the blade groove of the rotor under the 110% overspeed test transient condition of the in-service nuclear turbine.

In some examples, a calculation process of the low cycle fatigue crack propagation life N_{f110% 3.3} in the third phase of the third crack propagation category under the 110% overspeed test transient condition of the in-service nuclear turbine is as follow:

$${N}_{fl 10 \%3 , 3} = \frac{2 \times 0.5}{( {m}_{0} - 2 ) {{C}_{0} ( {σ}_{max 110 \%} )}^{{m}_{0}} {( \frac{1.21 π}{Q} )}^{\frac{{m}_{0}}{2}}} [ \frac{1}{{a}_{SCC}^{\frac{{m}_{0} - 2}{2}}} - \frac{1}{{a}_{c 110 \%}^{\frac{{m}_{0} - 2}{2}}} ]$$

At S609, a low cycle fatigue crack propagation life in a first phase of the fourth crack propagation category under the 110% overspeed test transient condition of the in-service nuclear turbine is acquired.

In an implementation, acquiring the low cycle fatigue crack propagation life in the first phase of the fourth crack propagation category under the 110% overspeed test transient condition of the in-service nuclear turbine includes acquiring the low cycle fatigue crack propagation life in the first phase of the fourth crack propagation category under the 110% overspeed test transient condition of the in-service nuclear turbine based on the phased array detection crack depth, the stress corrosion crack propagation size threshold value, the crack shape parameter of the blade groove of the rotor, the low cycle fatigue crack propagation test constant of the material of the rotor, and the maximum stress at the crack location in the blade groove of the rotor under the 110% overspeed test transient condition of the in-service nuclear turbine.

In some examples, a calculation process of the low cycle fatigue crack propagation life N_{f110% 4.1} in the first phase of the fourth crack propagation category under the 110% overspeed test transient condition of the in-service nuclear turbine is as follow:

$${N}_{fl 10 \%4 , 1} = \frac{2 \times 0.5}{( {m}_{0} - 2 ) {{C}_{0} ( {σ}_{max 110 \%} )}^{{m}_{0}} {( \frac{1.21 π}{Q} )}^{\frac{{m}_{0}}{2}}} [ \frac{1}{{a}_{i}^{\frac{{m}_{0} - 2}{2}}} - \frac{1}{{a}_{SCC}^{\frac{{m}_{0} - 2}{2}}} ]$$

At S610, a low cycle fatigue crack propagation life in a second phase of the fourth crack propagation category under the 110% overspeed test transient condition of the in-service nuclear turbine is acquired.

In an implementation, acquiring the low cycle fatigue crack propagation life in the second phase of the fourth crack propagation category under the 110% overspeed test transient condition of the in-service nuclear turbine includes acquiring the low cycle fatigue crack propagation life in the second phase of the fourth crack propagation category under the 110% overspeed test transient condition of the in-service nuclear turbine based on the stress corrosion crack propagation size threshold value, the low cycle fatigue critical crack size of the blade groove of the rotor under the 110% overspeed test transient condition of the in-service nuclear turbine, the crack shape parameter of the blade groove of the rotor, the low cycle fatigue crack propagation test constant of the material of the rotor, and the maximum stress at the crack location in the blade groove of the rotor under the 110% overspeed test transient condition of the in-service nuclear turbine.

In some examples, a calculation process of the low cycle fatigue crack propagation life N_{f110% 4.2} in the second phase of the fourth crack propagation category under the 110% overspeed test transient condition of the in-service nuclear turbine is as follow:

$${N}_{fl 10 \%4 , 2} = \frac{2 \times 0.5}{( {m}_{0} - 2 ) {{C}_{0} ( {σ}_{max 110 \%} )}^{{m}_{0}} {( \frac{1.21 π}{Q} )}^{\frac{{m}_{0}}{2}}} [ \frac{1}{{a}_{SCC}^{\frac{{m}_{0} - 2}{2}}} - \frac{1}{{a}_{c 110 \%}^{\frac{{m}_{0} - 2}{2}}} ]$$

For example, taking the fifth-stage inverted T-type blade groove of the No. 1 low-pressure rotor of the in-service nuclear turbine A in the above embodiment for example, the crack propagation category of the fifth-stage inverted T-type blade groove of the No. 1 low-pressure rotor of the in-service nuclear turbine A is the first crack propagation category, and a low cycle fatigue stress and material test basic data of the No. 1 low-pressure rotor under the 100% overspeed test condition of the in-service nuclear turbine A are as illustrated in Table 5.

TABLE 5
low cycle fatigue stress and material test basic
data of a low-pressure rotor under a 110%
overspeed test condition of an in-service nuclear turbine

| No. | Item | Data Value |
|---|---|---|
| 1 | maximum stress σ_{max110%}/MPa at a crack | 481.019 |
| | location in a blade groove of a rotor under | |
| | a 110% overspeed test transient condition | |
| 2 | low cycle fatigue crack propagation test | 2.556 |
| | constant m ₀ of a material of a rotor | |
| 3 | low cycle fatigue crack propagation test | 1.593 × 10⁻¹¹ |
| | constant C₀ of a material | |
| 4 | crack shape parameter Q | 0.97481 |

A calculation process of the low cycle fatigue crack propagation lives under the first crack propagation category for the fifth-stage inverted T-type blade groove of the No. 1 low-pressure rotor under the 110% overspeed test transient condition of the in-service nuclear turbine A is as follow:

$${N}_{fl 10 \%1 , 1} = \frac{2 \times 0.5}{( {m}_{0} - 2 ) {{C}_{0} ( {σ}_{max 110 \%} )}^{{m}_{0}} {( \frac{1.21 π}{Q} )}^{\frac{{m}_{0}}{2}}} [ \frac{1}{{a}_{i}^{\frac{{m}_{0} - 2}{2}}} - \frac{1}{{a}_{SCC}^{\frac{{m}_{0} - 2}{2}}} ] = \frac{2 \times 0.5}{( 2.556 - 2 ) \times 1.593 \times {10}^{- 11} {( 481.019 )}^{2.556} {( \frac{1.21 π}{0.97481} )}^{\frac{2.556}{2}}} [ \frac{1}{{0.002}^{\frac{2.556 - 2}{2}}} - \frac{1}{{0.00798}^{\frac{2.556 - 2}{2}}} ] = 4970$$

$${N}_{fl 10 \%1 , 2} = \frac{2 \times 0.5}{( {m}_{0} - 2 ) {{C}_{0} ( {σ}_{max 110 \%} )}^{{m}_{0}} {( \frac{1.21 π}{Q} )}^{\frac{{m}_{0}}{2}}} [ \frac{1}{{a}_{SCC}^{\frac{{m}_{0} - 2}{2}}} - \frac{1}{{a}_{th}^{\frac{{m}_{0} - 2}{2}}} ] = \frac{2 \times 0.5}{( 2.556 - 2 ) \times 1.593 \times {10}^{- 11} {( 481.019 )}^{2.556} {( \frac{1.21 π}{0.97481} )}^{\frac{2.556}{2}}} [ \frac{1}{{0.00798}^{\frac{2.556 - 2}{2}}} - \frac{1}{{0.023619}^{\frac{2.556 - 2}{2}}} ] = 2758$$

$${N}_{fl 10 \%1 , 3} = \frac{2 \times 0.5}{( {m}_{0} - 2 ) {{C}_{0} ( {σ}_{max 110 \%} )}^{{m}_{0}} {( \frac{1.21 π}{Q} )}^{\frac{{m}_{0}}{2}}} [ \frac{1}{{a}_{th}^{\frac{{m}_{0} - 2}{2}}} - \frac{1}{{a}_{c 110 \%}^{\frac{{m}_{0} - 2}{2}}} ] = \frac{2 \times 0.5}{( 2.556 - 2 ) \times 1.593 \times {10}^{- 11} {( 481.019 )}^{2.556} {( \frac{1.21 π}{0.97481} )}^{\frac{2.556}{2}}} [ \frac{1}{{0.023619}^{\frac{2.556 - 2}{2}}} - \frac{1}{{0.04001}^{\frac{2.556 - 2}{2}}} ] = 1067$$

For example, taking the fifth-stage inverted T-type blade groove of the No. 2 low-pressure rotor of the in-service nuclear turbine B in the above embodiment for example, the crack propagation category of the fifth-stage inverted T-type blade groove of the No. 2 low-pressure rotor of the in-service nuclear turbine B is the first crack propagation category, and a low cycle fatigue stress and material test basic data of the No. 3 low-pressure rotor under the 110% overspeed test condition of the in-service nuclear turbine C are as illustrated in Table 5.

A calculation process of the low cycle fatigue crack propagation lives under the first crack propagation category for the fifth-stage inverted T-type blade groove of the No. 2 low-pressure rotor under the 110% overspeed test transient condition of the in-service nuclear turbine is as follow:

$${N}_{fl 10 \%1 , 1} = \frac{2 \times 0.5}{( {m}_{0} - 2 ) {{C}_{0} ( {σ}_{max 110 \%} )}^{{m}_{0}} {( \frac{1.21 π}{Q} )}^{\frac{{m}_{0}}{2}}} [ \frac{1}{{a}_{i}^{\frac{{m}_{0} - 2}{2}}} - \frac{1}{{a}_{SCC}^{\frac{{m}_{0} - 2}{2}}} ] = \frac{2 \times 0.5}{( 2.556 - 2 ) \times 1.593 \times {10}^{- 11} {( 481.019 )}^{2.556} {( \frac{1.21 π}{0.97481} )}^{\frac{2.556}{2}}} [ \frac{1}{{0.005}^{\frac{2.556 - 2}{2}}} - \frac{1}{{0.00798}^{\frac{2.556 - 2}{2}}} ] = 1470$$

$${N}_{fl 10 \%1 , 2} = \frac{2 \times 0.5}{( {m}_{0} - 2 ) {{C}_{0} ( {σ}_{max 110 \%} )}^{{m}_{0}} {( \frac{1.21 π}{Q} )}^{\frac{{m}_{0}}{2}}} [ \frac{1}{{a}_{SCC}^{\frac{{m}_{0} - 2}{2}}} - \frac{1}{{a}_{th}^{\frac{{m}_{0} - 2}{2}}} ] = \frac{2 \times 0.5}{( 2.556 - 2 ) \times 1.593 \times {10}^{- 11} {( 481.019 )}^{2.556} {( \frac{1.21 π}{0.97481} )}^{\frac{2.556}{2}}} [ \frac{1}{{0.00798}^{\frac{2.556 - 2}{2}}} - \frac{1}{{0.023619}^{\frac{2.556 - 2}{2}}} ] = 2758$$

$${N}_{fl 10 \%1 , 3} = \frac{2 \times 0.5}{( {m}_{0} - 2 ) {{C}_{0} ( {σ}_{max 110 \%} )}^{{m}_{0}} {( \frac{1.21 π}{Q} )}^{\frac{{m}_{0}}{2}}} [ \frac{1}{{a}_{th}^{\frac{{m}_{0} - 2}{2}}} - \frac{1}{{a}_{c 110 \%}^{\frac{{m}_{0} - 2}{2}}} ] = \frac{2 \times 0.5}{( 2.556 - 2 ) \times 1.593 \times {10}^{- 11} {( 481.019 )}^{2.556} {( \frac{1.21 π}{0.97481} )}^{\frac{2.556}{2}}} [ \frac{1}{{0.023619}^{\frac{2.556 - 2}{2}}} - \frac{1}{{0.04001}^{\frac{2.556 - 2}{2}}} ] = 1067$$

For example, taking the fifth-stage inverted T-type blade groove of the No. 3 low-pressure rotor of the in-service nuclear turbine C in the above embodiment for example, the crack propagation category of the fifth-stage inverted T-type blade groove of the No. 3 low-pressure rotor of the in-service nuclear turbine C is the second crack propagation category, and a low cycle fatigue stress and material test basic data of the No. 3 low-pressure rotor under the 110% overspeed test condition of the in-service nuclear turbine C are as illustrated in Table 5.

A calculation process of the low cycle fatigue crack propagation lives under the second crack propagation category for the fifth-stage inverted T-type blade groove of the No. 3 low-pressure rotor under the 110% overspeed test transient condition of the in-service nuclear turbine C is as follow:

$${N}_{fl 10 \%2 , 1} = \frac{2 \times 0.5}{( {m}_{0} - 2 ) {{C}_{0} ( {σ}_{max 110 \%} )}^{{m}_{0}} {( \frac{1.21 π}{Q} )}^{\frac{{m}_{0}}{2}}} [ \frac{1}{{a}_{i}^{\frac{{m}_{0} - 2}{2}}} - \frac{1}{{a}_{th}^{\frac{{m}_{0} - 2}{2}}} ] = \frac{2 \times 0.5}{( 2.556 - 2 ) \times 1.593 \times {10}^{- 11} {( 481.019 )}^{2.556} {( \frac{1.21 π}{0.97481} )}^{\frac{2.556}{2}}} [ \frac{1}{{0.01}^{\frac{2.556 - 2}{2}}} - \frac{1}{{0.023619}^{\frac{2.556 - 2}{2}}} ] = 2114$$

$${N}_{fl 10 \%2 , 2} = \frac{2 \times 0.5}{( {m}_{0} - 2 ) {{C}_{0} ( {σ}_{max 110 \%} )}^{{m}_{0}} {( \frac{1.21 π}{Q} )}^{\frac{{m}_{0}}{2}}} [ \frac{1}{{a}_{th}^{\frac{{m}_{0} - 2}{2}}} - \frac{1}{{a}_{c 110 \%}^{\frac{{m}_{0} - 2}{2}}} ] = \frac{2 \times 0.5}{( 2.556 - 2 ) \times 1.593 \times {10}^{- 11} {( 481.019 )}^{2.556} {( \frac{1.21 π}{0.97481} )}^{\frac{2.556}{2}}} [ \frac{1}{{0.02316}^{\frac{2.556 - 2}{2}}} - \frac{1}{{0.04001}^{\frac{2.556 - 2}{2}}} ] = 1067$$

Thus, in the method, the low cycle fatigue crack propagation lives under the crack propagation category of the blade groove of the rotor under the 110% overspeed test transient condition of the in-service nuclear turbine may be acquired in consideration of the crack shape parameter of the blade groove of the rotor, the low cycle fatigue crack propagation test constant of the material of the rotor, the maximum stress at the crack location in the blade groove of the rotor under the 110% overspeed test transient condition of the in-service nuclear turbine and the crack propagation size set of the blade groove of the rotor.

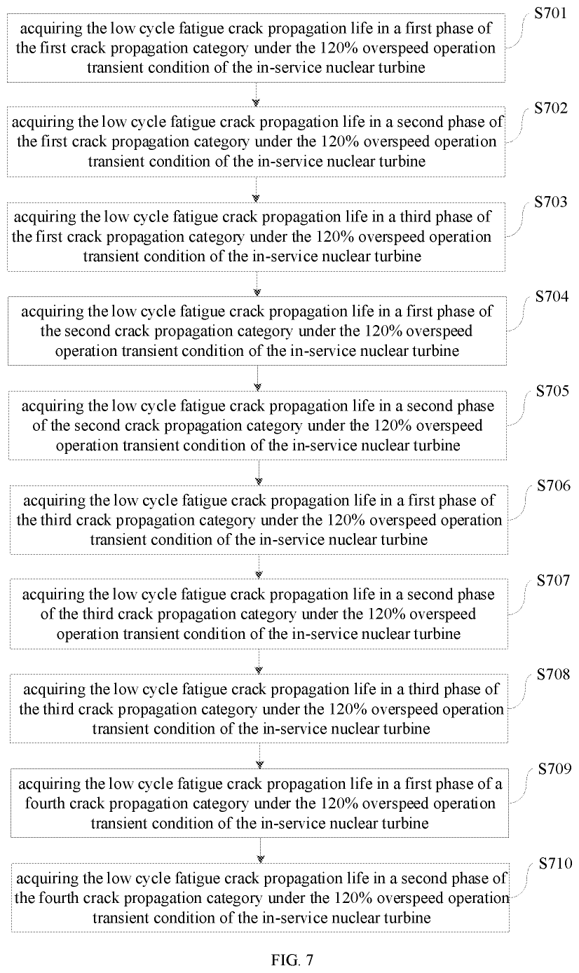

On the basis of the above any one embodiment, as illustrated in FIG. 7, acquiring the low cycle fatigue crack propagation lives under the crack propagation category of the blade groove of the rotor under a 120% overspeed operation transient condition of the in-service nuclear turbine includes the following steps.

At S701, a low cycle fatigue crack propagation life in a first phase of the first crack propagation category under the 120% overspeed operation transient condition of the in-service nuclear turbine is acquired.

In an implementation, acquiring the low cycle fatigue crack propagation life in the first phase of the first crack propagation category under the 120% overspeed operation transient condition of the in-service nuclear turbine includes acquiring the low cycle fatigue crack propagation life in the first phase of the first crack propagation category under the 120% overspeed operation transient condition of the in-service nuclear turbine based on the phased array detection crack depth, the stress corrosion crack propagation size threshold value, the crack shape parameter of the blade groove of the rotor, the low cycle fatigue crack propagation test constant of the material of the rotor, and the maximum stress at the crack location in the blade groove of the rotor under the 120% overspeed operation transient condition of the in-service nuclear turbine.

In some examples, a calculation process of the low cycle fatigue crack propagation life N_{f120% 1.1} in the first phase of the first crack propagation category under the 120% overspeed operation transient condition of the in-service nuclear turbine is as follow:

$${N}_{fl 20 \%1 , 1} = \frac{2 \times 0.5}{( {m}_{0} - 2 ) {{C}_{0} ( {σ}_{max 120 \%} )}^{{m}_{0}} {( \frac{1.21 π}{Q} )}^{\frac{{m}_{0}}{2}}} [ \frac{1}{{a}_{i}^{\frac{{m}_{0} - 2}{2}}} - \frac{1}{{a}_{SCC}^{\frac{{m}_{0} - 2}{2}}} ]$$

At S702, a low cycle fatigue crack propagation life in a second phase of the first crack propagation category under the 120% overspeed operation transient condition of the in-service nuclear turbine is acquired.

In an implementation, acquiring the low cycle fatigue crack propagation life in the second phase of the first crack propagation category under the 120% overspeed operation transient condition of the in-service nuclear turbine includes acquiring the low cycle fatigue crack propagation life in the second phase of the first crack propagation category under the 120% overspeed operation transient condition of the in-service nuclear turbine based on the stress corrosion crack propagation size threshold value, the high cycle fatigue crack propagation size threshold value, the crack shape parameter of the blade groove of the rotor, the low cycle fatigue crack propagation test constant of the material of the rotor, and the maximum stress at the crack location in the blade groove of the rotor under the 120% overspeed operation transient condition of the in-service nuclear turbine.

In some examples, a calculation process of the low cycle fatigue crack propagation life N_{f120% 1.2} in the second phase of the first crack propagation category under the 120% overspeed operation transient condition of the in-service nuclear turbine is as follow:

$${N}_{fl 20 \%1 , 2} = \frac{2 \times 0.5}{( {m}_{0} - 2 ) {{C}_{0} ( {σ}_{max 120 \%} )}^{{m}_{0}} {( \frac{1.21 π}{Q} )}^{\frac{{m}_{0}}{2}}} [ \frac{1}{{a}_{SCC}^{\frac{{m}_{0} - 2}{2}}} - \frac{1}{{a}_{th}^{\frac{{m}_{0} - 2}{2}}} ]$$

At S703, a low cycle fatigue crack propagation life in a third phase of the first crack propagation category under the 120% overspeed operation transient condition of the in-service nuclear turbine is acquired.

In an implementation, acquiring the low cycle fatigue crack propagation life in the third phase of the first crack propagation category under the 120% overspeed operation transient condition of the in-service nuclear turbine includes acquiring the low cycle fatigue crack propagation life in the third phase of the first crack propagation category under the 120% overspeed operation transient condition of the in-service nuclear turbine based on the high cycle fatigue crack propagation size threshold value, the low cycle fatigue critical crack size of the blade groove of the rotor under the 120% overspeed test transient condition of the in-service nuclear turbine, the crack shape parameter of the blade groove of the rotor, the low cycle fatigue crack propagation test constant of the material of the rotor, and the maximum stress at the crack location in the blade groove of the rotor under the 120% overspeed operation transient condition of the in-service nuclear turbine.

In some examples, a calculation process of the low cycle fatigue crack propagation life N_{f120% 1.3} in the third phase of the first crack propagation category under the 120% overspeed operation transient condition of the in-service nuclear turbine is as follow:

$${N}_{fl 20 \%1 , 3} = \frac{2 \times 0.5}{( {m}_{0} - 2 ) {{C}_{0} ( {σ}_{max 120 \%} )}^{{m}_{0}} {( \frac{1.21 π}{Q} )}^{\frac{{m}_{0}}{2}}} [ \frac{1}{{a}_{th}^{\frac{{m}_{0} - 2}{2}}} - \frac{1}{{a}_{c 120 \%}^{\frac{{m}_{0} - 2}{2}}} ]$$

At S704, a low cycle fatigue crack propagation life in a first phase of the second crack propagation category under the 120% overspeed operation transient condition of the in-service nuclear turbine is acquired.

In an implementation, acquiring the low cycle fatigue crack propagation life in the first phase of the second crack propagation category under the 120% overspeed operation transient condition of the in-service nuclear turbine includes acquiring the low cycle fatigue crack propagation life in the first phase of the second crack propagation category under the 120% overspeed operation transient condition of the in-service nuclear turbine based on the phased array detection crack depth, the high cycle fatigue crack propagation size threshold value, the crack shape parameter of the blade groove of the rotor, the low cycle fatigue crack propagation test constant of the material of the rotor, and the maximum stress at the crack location in the blade groove of the rotor under the 120% overspeed operation transient condition of the in-service nuclear turbine.

In some examples, a calculation process of the low cycle fatigue crack propagation life N_{f120% 2.1} in the first phase of the second crack propagation category under the 120% overspeed operation transient condition of the in-service nuclear turbine is as follow:

$${N}_{fl 20 \%2 , 1} = \frac{2 \times 0.5}{( {m}_{0} - 2 ) {{C}_{0} ( {σ}_{max 120 \%} )}^{{m}_{0}} {( \frac{1.21 π}{Q} )}^{\frac{{m}_{0}}{2}}} [ \frac{1}{{a}_{i}^{\frac{{m}_{0} - 2}{2}}} - \frac{1}{{a}_{th}^{\frac{{m}_{0} - 2}{2}}} ]$$

At S705, a low cycle fatigue crack propagation life in a second phase of the second crack propagation category under the 120% overspeed operation transient condition of the in-service nuclear turbine is acquired.

In an implementation, acquiring the low cycle fatigue crack propagation life in the second phase of the second crack propagation category under the 120% overspeed operation transient condition of the in-service nuclear turbine includes acquiring the low cycle fatigue crack propagation life in the second phase of the second crack propagation category under the 120% overspeed operation transient condition of the in-service nuclear turbine based on the high cycle fatigue crack propagation size threshold value, the low cycle fatigue critical crack size of the blade groove of the rotor under the 120% overspeed operation transient condition of the in-service nuclear turbine, the crack shape parameter of the blade groove of the rotor, the low cycle fatigue crack propagation test constant of the material of the rotor, and the maximum stress at the crack location in the blade groove of the rotor under the 120% overspeed operation transient condition of the in-service nuclear turbine.

In some examples, a calculation process of the low cycle fatigue crack propagation life N_{f120% 2.2} in the second phase of the second crack propagation category under the 120% overspeed operation transient condition of the in-service nuclear turbine is as follow:

$${N}_{fl 20 \%2 , 2} = \frac{2 \times 0.5}{( {m}_{0} - 2 ) {{C}_{0} ( {σ}_{max 120 \%} )}^{{m}_{0}} {( \frac{1.21 π}{Q} )}^{\frac{{m}_{0}}{2}}} [ \frac{1}{{a}_{th}^{\frac{{m}_{0} - 2}{2}}} - \frac{1}{{a}_{c 120 \%}^{\frac{{m}_{0} - 2}{2}}} ]$$

At S706, a low cycle fatigue crack propagation life in a first phase of the third crack propagation category under the 120% overspeed operation transient condition of the in-service nuclear turbine is acquired.

In an implementation, acquiring the low cycle fatigue crack propagation life in the first phase of the third crack propagation category under the 120% overspeed operation transient condition of the in-service nuclear turbine includes acquiring the low cycle fatigue crack propagation life in the first phase of the third crack propagation category under the 120% overspeed operation transient condition of the in-service nuclear turbine based on the phased array detection crack depth, the high cycle fatigue crack propagation size threshold value, the crack shape parameter of the blade groove of the rotor, the low cycle fatigue crack propagation test constant of the material of the rotor, and the maximum stress at the crack location in the blade groove of the rotor under the 120% overspeed operation transient condition of the in-service nuclear turbine.

In some examples, a calculation process of the low cycle fatigue crack propagation life N_{f120% 3.1} in the first phase of the third crack propagation category under the 120% overspeed operation transient condition of the in-service nuclear turbine is as follow:

At S707, a low cycle fatigue crack propagation life in a second phase of the third crack propagation category under the 120% overspeed operation transient condition of the in-service nuclear turbine is acquired.

In an implementation, acquiring the low cycle fatigue crack propagation life in the second phase of the third crack propagation category under the 120% overspeed operation transient condition of the in-service nuclear turbine includes acquiring the low cycle fatigue crack propagation life in the second phase of the third crack propagation category under the 120% overspeed operation transient condition of the in-service nuclear turbine based on the high cycle fatigue crack propagation size threshold value, the stress corrosion crack propagation size threshold value, the crack shape parameter of the blade groove of the rotor, the low cycle fatigue crack propagation test constant of the material of the rotor, and the maximum stress at the crack location in the blade groove of the rotor under the 120% overspeed operation transient condition of the in-service nuclear turbine.

In some examples, a calculation process of the low cycle fatigue crack propagation life N_{f120% 3.2} in the second phase of the third crack propagation category under the 120% overspeed operation transient condition of the in-service nuclear turbine is as follow:

$${N}_{fl 20 \%3 , 2} = \frac{2 \times 0.5}{( {m}_{0} - 2 ) {{C}_{0} ( {σ}_{max 120 \%} )}^{{m}_{0}} {( \frac{1.21 π}{Q} )}^{\frac{{m}_{0}}{2}}} [ \frac{1}{{a}_{th}^{\frac{{m}_{0} - 2}{2}}} - \frac{1}{{a}_{SCC}^{\frac{{m}_{0} - 2}{2}}} ]$$

At S708, a low cycle fatigue crack propagation life in a third phase of the third crack propagation category under the 120% overspeed operation transient condition of the in-service nuclear turbine is acquired.

In an implementation, acquiring the low cycle fatigue crack propagation life in the third phase of the third crack propagation category under the 120% overspeed operation transient condition of the in-service nuclear turbine includes acquiring the low cycle fatigue crack propagation life in the third phase of the third crack propagation category under the 120% overspeed operation transient condition of the in-service nuclear turbine based on the stress corrosion crack propagation size threshold value, the low cycle fatigue critical crack size of the blade groove of the rotor under the 120% overspeed test transient condition of the in-service nuclear turbine, the crack shape parameter of the blade groove of the rotor, the low cycle fatigue crack propagation test constant of the material of the rotor, and the maximum stress at the crack location in the blade groove of the rotor under the 120% overspeed operation transient condition of the in-service nuclear turbine.

In some examples, a calculation process of the low cycle fatigue crack propagation life N_{f120% 3.3} in the third phase of the third crack propagation category under the 120% overspeed operation transient condition of the in-service nuclear turbine is as follow:

$${N}_{fl 20 \%3 , 3} = \frac{2 \times 0.5}{( {m}_{0} - 2 ) {{C}_{0} ( {σ}_{max 120 \%} )}^{{m}_{0}} {( \frac{1.21 π}{Q} )}^{\frac{{m}_{0}}{2}}} [ \frac{1}{{a}_{SCC}^{\frac{{m}_{0} - 2}{2}}} - \frac{1}{{a}_{c 120 \%}^{\frac{{m}_{0} - 2}{2}}} ]$$

At S709, a low cycle fatigue crack propagation life in a first phase of a fourth crack propagation category under the 120% overspeed operation transient condition of the in-service nuclear turbine is acquired.

In an implementation, acquiring the low cycle fatigue crack propagation life in the first phase of the fourth crack propagation category under the 120% overspeed operation transient condition of the in-service nuclear turbine includes acquiring the low cycle fatigue crack propagation life in the first phase of the fourth crack propagation category under the 120% overspeed operation transient condition of the in-service nuclear turbine based on the phased array detection crack depth, the stress corrosion crack propagation size threshold value, the crack shape parameter of the blade groove of the rotor, the low cycle fatigue crack propagation test constant of the material of the rotor, and the maximum stress at the crack location in the blade groove of the rotor under the 120% overspeed operation transient condition of the in-service nuclear turbine.

In some examples, a calculation process of the low cycle fatigue crack propagation life N_{f120% 4.1} in the first phase of the fourth crack propagation category under the 120% overspeed operation transient condition of the in-service nuclear turbine is as follow:

$${N}_{fl 20 \%4 , 1} = \frac{2 \times 0.5}{( {m}_{0} - 2 ) {{C}_{0} ( {σ}_{max 120 \%} )}^{{m}_{0}} {( \frac{1.21 π}{Q} )}^{\frac{{m}_{0}}{2}}} [ \frac{1}{{a}_{i}^{\frac{{m}_{0} - 2}{2}}} - \frac{1}{{a}_{SCC}^{\frac{{m}_{0} - 2}{2}}} ]$$

At S710, a low cycle fatigue crack propagation life in a second phase of the fourth crack propagation category under the 120% overspeed operation transient condition of the in-service nuclear turbine is acquired.

In an implementation, acquiring the low cycle fatigue crack propagation life in the second phase of the fourth crack propagation category under the 120% overspeed operation transient condition of the in-service nuclear turbine includes acquiring the low cycle fatigue crack propagation life in the second phase of the fourth crack propagation category under the 120% overspeed operation transient condition of the in-service nuclear turbine based on the stress corrosion crack propagation size threshold value, the low cycle fatigue critical crack size of the blade groove of the rotor under the 120% overspeed test transient condition of the in-service nuclear turbine, the crack shape parameter of the blade groove of the rotor, the low cycle fatigue crack propagation test constant of the material of the rotor, and the maximum stress at the crack location in the blade groove of the rotor under the 120% overspeed operation transient condition of the in-service nuclear turbine.

In some examples, a calculation process of the low cycle fatigue crack propagation life N_{f120% 4.2} in the second phase of the fourth crack propagation category under the 120% overspeed operation transient condition of the in-service nuclear turbine is as follow:

$${N}_{fl 20 \%4 , 2} = \frac{2 \times 0.5}{( {m}_{0} - 2 ) {{C}_{0} ( {σ}_{max 120 \%} )}^{{m}_{0}} {( \frac{1.21 π}{Q} )}^{\frac{{m}_{0}}{2}}} [ \frac{1}{{a}_{SCC}^{\frac{{m}_{0} - 2}{2}}} - \frac{1}{{a}_{c 120 \%}^{\frac{{m}_{0} - 2}{2}}} ]$$

For example, taking the fifth-stage inverted T-type blade groove of the No. 1 low-pressure rotor of the in-service nuclear turbine A in the above embodiment for example, the crack propagation category of the fifth-stage inverted T-type blade groove of the No. 1 low-pressure rotor of the in-service nuclear turbine A is the first crack propagation category, and a low cycle fatigue stress and material test basic data of the No. 1 low-pressure rotor under the 120% overspeed operation condition of the in-service nuclear turbine A are as illustrated in Table 6.

TABLE 6
low cycle fatigue stress and material test basic
data of a low-pressure rotor under a 120% overspeed
operation condition of an in-service nuclear turbine

| No. | Item | Data Value |
|---|---|---|
| 1 | maximum stress σ_{max120%}/MPa at a crack location | 577.005 |
| | in a blade groove of a rotor under a 120% | |
| | overspeed operation transient condition | |
| 2 | low cycle fatigue crack propagation test | 2.556 |
| | constant m₀ of a material of a rotor | |
| 3 | low cycle fatigue crack propagation test | 1.593 × 10⁻¹¹ |
| | constant C₀ of a material | |
| 4 | crack shape parameter Q | 0.92580 |

A calculation process of the low cycle fatigue crack propagation lives under the first crack propagation category for the fifth-stage inverted T-type blade groove of the No. 1 low-pressure rotor under the 120% overspeed operation transient condition of the in-service nuclear turbine A is as follow:

$${N}_{fl 20 \%1 , 1} = \frac{2 \times 0.5}{( {m}_{0} - 2 ) {{C}_{0} ( {σ}_{max 120 \%} )}^{{m}_{0}} {( \frac{1.21 π}{Q} )}^{\frac{{m}_{0}}{2}}} [ \frac{1}{{a}_{i}^{\frac{{m}_{0} - 2}{2}}} - \frac{1}{{a}_{SCC}^{\frac{{m}_{0} - 2}{2}}} ] = \frac{2 \times 0.5}{( 2.556 - 2 ) \times 1.593 \times {10}^{- 11} {( 577.005 )}^{2.556} {( \frac{1.21 π}{0.9258} )}^{\frac{2.556}{2}}} [ \frac{1}{{0.002}^{\frac{2.556 - 2}{2}}} - \frac{1}{{0.00798}^{\frac{2.556 - 2}{2}}} ] = 2922$$

$${N}_{fl 20 \%1 , 2} = \frac{2 \times 0.5}{( {m}_{0} - 2 ) {{C}_{0} ( {σ}_{max 120 \%} )}^{{m}_{0}} {( \frac{1.21 π}{Q} )}^{\frac{{m}_{0}}{2}}} [ \frac{1}{{a}_{SCC}^{\frac{{m}_{0} - 2}{2}}} - \frac{1}{{a}_{th}^{\frac{{m}_{0} - 2}{2}}} ] = \frac{2 \times 0.5}{( 2.556 - 2 ) \times 1.593 \times {10}^{- 11} {( 577.005 )}^{2.556} {( \frac{1.21 π}{0.9258} )}^{\frac{2.556}{2}}} [ \frac{1}{{0.00798}^{\frac{2.556 - 2}{2}}} - \frac{1}{{0.023619}^{\frac{2.556 - 2}{2}}} ] = 1622$$

$${N}_{fl 20 \%1 , 3} = \frac{2 \times 0.5}{( {m}_{0} - 2 ) {{C}_{0} ( {σ}_{max 120 \%} )}^{{m}_{0}} {( \frac{1.21 π}{Q} )}^{\frac{{m}_{0}}{2}}} [ \frac{1}{{a}_{th}^{\frac{{m}_{0} - 2}{2}}} - \frac{1}{{a}_{c 120 \%}^{\frac{{m}_{0} - 2}{2}}} ] = \frac{2 \times 0.5}{( 2.556 - 2 ) \times 1.593 \times {10}^{- 11} {( 577.005 )}^{2.556} {( \frac{1.21 π}{0.9258} )}^{\frac{2.556}{2}}} [ \frac{1}{{0.023619}^{\frac{2.556 - 2}{2}}} - \frac{1}{{0.02641}^{\frac{2.556 - 2}{2}}} ] = 140$$

For example, taking the fifth-stage inverted T-type blade groove of the No. 2 low-pressure rotor of the in-service nuclear turbine B in the above embodiment for example, the crack propagation category of the fifth-stage inverted T-type blade groove of the No. 2 low-pressure rotor of the in-service nuclear turbine B is the first crack propagation category, and a low cycle fatigue stress and material test basic data of the No. 2 low-pressure rotor under the 120% overspeed operation condition of the in-service nuclear turbine B are as illustrated in Table 6.

A calculation process of the low cycle fatigue crack propagation lives under the first crack propagation category for the fifth-stage inverted T-type blade groove of the No. 2 low-pressure rotor under the 120% overspeed operation transient condition of the in-service nuclear turbine is as follow:

$${N}_{fl 20 \%1 , 1} = \frac{2 \times 0.5}{( {m}_{0} - 2 ) {{C}_{0} ( {σ}_{max 120 \%} )}^{{m}_{0}} {( \frac{1.21 π}{Q} )}^{\frac{{m}_{0}}{2}}} [ \frac{1}{{a}_{i}^{\frac{{m}_{0} - 2}{2}}} - \frac{1}{{a}_{SCC}^{\frac{{m}_{0} - 2}{2}}} ] = \frac{2 \times 0.5}{( 2.556 - 2 ) \times 1.593 \times {10}^{- 11} {( 577.005 )}^{2.556} {( \frac{1.21 π}{0.9258} )}^{\frac{2.556}{2}}} [ \frac{1}{{0.005}^{\frac{2.556 - 2}{2}}} - \frac{1}{{0.00798}^{\frac{2.556 - 2}{2}}} ] = 864$$

$${N}_{fl 20 \%1 , 2} = \frac{2 \times 0.5}{( {m}_{0} - 2 ) {{C}_{0} ( {σ}_{max 120 \%} )}^{{m}_{0}} {( \frac{1.21 π}{Q} )}^{\frac{{m}_{0}}{2}}} [ \frac{1}{{a}_{SCC}^{\frac{{m}_{0} - 2}{2}}} - \frac{1}{{a}_{th}^{\frac{{m}_{0} - 2}{2}}} ] = \frac{2 \times 0.5}{( 2.556 - 2 ) \times 1.593 \times {10}^{- 11} {( 577.005 )}^{2.556} {( \frac{1.21 π}{0.9258} )}^{\frac{2.556}{2}}} [ \frac{1}{{0.00798}^{\frac{2.556 - 2}{2}}} - \frac{1}{{0.023619}^{\frac{2.556 - 2}{2}}} ] = 1622$$

$${N}_{fl 20 \%1 , 3} = \frac{2 \times 0.5}{( {m}_{0} - 2 ) {{C}_{0} ( {σ}_{max 120 \%} )}^{{m}_{0}} {( \frac{1.21 π}{Q} )}^{\frac{{m}_{0}}{2}}} [ \frac{1}{{a}_{th}^{\frac{{m}_{0} - 2}{2}}} - \frac{1}{{a}_{c 120 \%}^{\frac{{m}_{0} - 2}{2}}} ] = \frac{2 \times 0.5}{( 2.556 - 2 ) \times 1.593 \times {10}^{- 11} {( 577.005 )}^{2.556} {( \frac{1.21 π}{0.9258} )}^{\frac{2.556}{2}}} [ \frac{1}{{0.023619}^{\frac{2.556 - 2}{2}}} - \frac{1}{{0.02641}^{\frac{2.556 - 2}{2}}} ] = 140$$

For example, taking the fifth-stage inverted T-type blade groove of the No. 3 low-pressure rotor of the in-service nuclear turbine C in the above embodiment for example, the crack propagation category of the fifth-stage inverted T-type blade groove of the No. 3 low-pressure rotor of the in-service nuclear turbine C is the second crack propagation category, and a low cycle fatigue stress and material test basic data of the No. 3 low-pressure rotor under the 120% overspeed operation condition of the in-service nuclear turbine C are as illustrated in Table 6.

A calculation process of the low cycle fatigue crack propagation life under the second crack propagation category for the fifth-stage inverted T-type blade groove of the No. 3 low-pressure rotor under the 120% overspeed operation transient condition of the in-service nuclear turbine C is as follow:

$${N}_{fl 20 \%2 , 1} = \frac{2 \times 0.5}{( {m}_{0} - 2 ) {{C}_{0} ( {σ}_{max 120 \%} )}^{{m}_{0}} {( \frac{1.21 π}{Q} )}^{\frac{{m}_{0}}{2}}} [ \frac{1}{{a}_{i}^{\frac{{m}_{0} - 2}{2}}} - \frac{1}{{a}_{th}^{\frac{{m}_{0} - 2}{2}}} ] = \frac{2 \times 0.5}{( 2.556 - 2 ) \times 1.593 \times {10}^{- 11} {( 577.005 )}^{2.556} {( \frac{1.21 π}{0.9258} )}^{\frac{2.556}{2}}} [ \frac{1}{{0.01}^{\frac{2.556 - 2}{2}}} - \frac{1}{{0.023619}^{\frac{2.556 - 2}{2}}} ] = 1243$$

$${N}_{fl 20 \%2 , 2} = \frac{2 \times 0.5}{( {m}_{0} - 2 ) {{C}_{0} ( {σ}_{max 120 \%} )}^{{m}_{0}} {( \frac{1.21 π}{Q} )}^{\frac{{m}_{0}}{2}}} [ \frac{1}{{a}_{th}^{\frac{{m}_{0} - 2}{2}}} - \frac{1}{{a}_{c 120 \%}^{\frac{{m}_{0} - 2}{2}}} ] = \frac{2 \times 0.5}{( 2.556 - 2 ) \times 1.593 \times {10}^{- 11} {( 577.005 )}^{2.556} {( \frac{1.21 π}{0.9258} )}^{\frac{2.556}{2}}} [ \frac{1}{{0.023619}^{\frac{2.556 - 2}{2}}} - \frac{1}{{0.02641}^{\frac{2.556 - 2}{2}}} ] = 140$$

Thus, in the method, the low cycle fatigue crack propagation lives under the crack propagation category of the blade groove of the rotor under the 120% overspeed operation transient condition of the in-service nuclear turbine may be acquired in consideration of the crack shape parameter of the blade groove of the rotor, the low cycle fatigue crack propagation test constant of the material of the rotor, the maximum stress at the crack location in the blade groove of the rotor under the 120% overspeed operation transient condition of the in-service nuclear turbine and the crack propagation size set of the blade groove of the rotor.

On the basis of the above any embodiment, acquiring the crack propagation calendar life of the blade groove of the rotor based on the stress corrosion crack propagation life, the low cycle fatigue crack propagation life and the high cycle fatigue crack propagation life at step S102 includes acquiring the crack propagation calendar life under the crack propagation category based on a stress corrosion crack propagation life, low cycle fatigue crack propagation lives in a plurality of phases and a high cycle fatigue crack propagation life under the crack propagation category. Thus, the crack propagation calendar life under the crack propagation category may be acquired in consideration of the stress corrosion crack propagation life, the low cycle fatigue crack propagation lives in the plurality of phases and the high cycle fatigue crack propagation life under a certain crack propagation category.

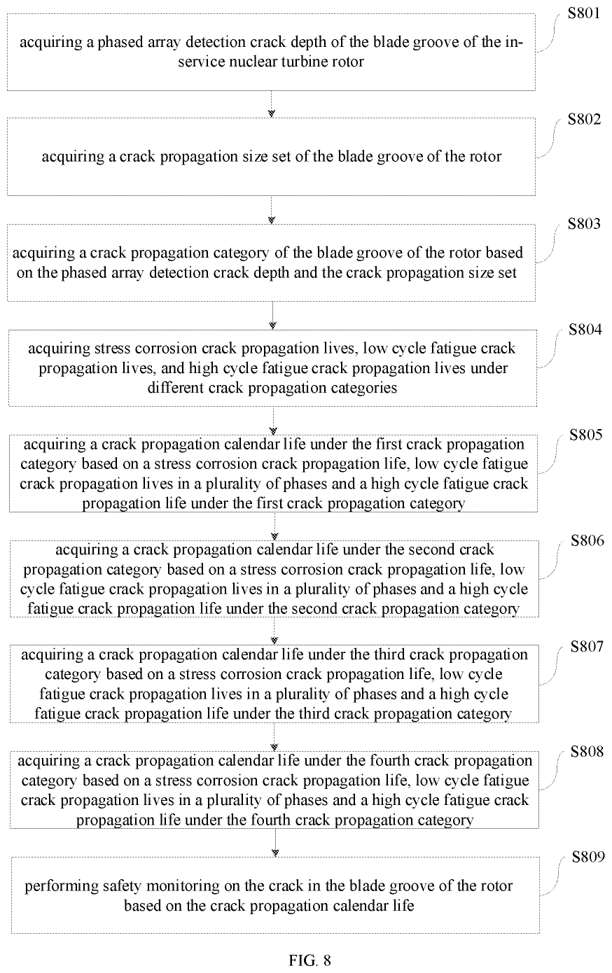

FIG. 8 is a flowchart illustrating a method for safety monitoring of a crack in a blade groove of an in-service nuclear turbine rotor according to another embodiment of the present disclosure.

As illustrated in FIG. 8, the method for safety monitoring of the crack in the blade groove of the in-service nuclear turbine rotor according to an embodiment of the present disclosure may include the following steps.

At S801, a phased array detection crack depth of the blade groove of the in-service nuclear turbine rotor is acquired.

At S802, a crack propagation size set of the blade groove of the rotor is acquired.

At S803, a crack propagation category of the blade groove of the rotor is acquired based on the phased array detection crack depth and the crack propagation size set.

At S804, a stress corrosion crack propagation life, a low cycle fatigue crack propagation life, and a high cycle fatigue crack propagation life under the crack propagation category of the blade groove of the rotor are acquired. Different crack propagation categories correspond to different stress corrosion crack propagation lives, different low cycle fatigue crack propagation lives, and different high cycle fatigue crack propagation lives.

Explanation of S801-S804 may refer to the above embodiments, which will not be repeated here.

At S805, a crack propagation calendar life under the first crack propagation category is acquired based on a stress corrosion crack propagation life, low cycle fatigue crack propagation lives in a plurality of phases and a high cycle fatigue crack propagation life under the first crack propagation category.

In an implementation, acquiring the crack propagation calendar life under the first crack propagation category based on the stress corrosion crack propagation life, the low cycle fatigue crack propagation lives in the plurality of phases and the high cycle fatigue crack propagation life under the first crack propagation category includes acquiring a calendar life in each phase of the first crack propagation category based on the stress corrosion crack propagation life, the low cycle fatigue crack propagation lives in the plurality of phases and the high cycle fatigue crack propagation life under the first crack propagation category, and acquiring the crack propagation calendar life under the first crack propagation category based on the calendar life in each phase of the first crack propagation category.

In some examples, a calendar life in a first phase of the first crack propagation category is acquired based on a low cycle fatigue crack propagation life in the first phase of the first crack propagation category under the normal shutdown transient condition of the in-service nuclear turbine, a low cycle fatigue crack propagation life in the first phase of the first crack propagation category under the 110% overspeed test transient condition of the in-service nuclear turbine, a low cycle fatigue crack propagation life in the first phase of the first crack propagation category under the 120% overspeed operation transient condition of the in-service nuclear turbine, an annual average number of normal shutdowns, an annual average number of 110% overspeed tests and an annual average number of 120% overspeed operations of the in-service nuclear turbine.

In some examples, a calendar life in a second phase of the first crack propagation category is acquired based on a stress corrosion crack propagation life under the first crack propagation category, a low cycle fatigue crack propagation life in the second phase of the first crack propagation category under the normal shutdown transient condition of the in-service nuclear turbine, a low cycle fatigue crack propagation life in the second phase of the first crack propagation category under the 120% overspeed test transient condition of the in-service nuclear turbine, a low cycle fatigue crack propagation life in the second phase of the first crack propagation category under the 120% overspeed test transient condition of the in-service nuclear turbine, the annual average number of the normal shutdowns, the annual average number of the 110% overspeed tests and the annual average number of the 120% overspeed operations of the in-service nuclear turbine.

In some examples, a calendar life in a third phase of the first crack propagation category is acquired based on the stress corrosion crack propagation life under the first crack propagation category, a high cycle fatigue crack propagation life under the first crack propagation category, a low cycle fatigue crack propagation life in the third phase of the first crack propagation category under the normal shutdown transient condition of the in-service nuclear turbine, a low cycle fatigue crack propagation life in the third phase of the first crack propagation category under the 110% overspeed test transient condition of the in-service nuclear turbine, a low cycle fatigue crack propagation life in the third phase of the first crack propagation category under the 120% overspeed operation transient condition of the in-service nuclear turbine, the annual average number of the normal shutdowns, the annual average number of the 110% overspeed tests and the annual average number of the 120% overspeed operations of the in-service nuclear turbine and an annual average number of high cycle fatigues of the blade groove of the rotor.

A crack propagation calendar life under the first crack propagation category is acquired based on the calendar life in the first phase of the first crack propagation category, the calendar life in the second phase of the first crack propagation category and the calendar life in the third phase of the first crack propagation category.

In some examples, a calculation process of a crack propagation calendar life icL under the first crack propagation category is as follow:

$${τ}_{CL 1 , 1} = \frac{1}{\frac{{y}_{n}}{{N}_{fn 1 , 1}} + \frac{{y}_{110 \%}}{{N}_{f 110 \%1 , 1}} + \frac{{y}_{120 \%}}{{N}_{f 120 \%1 , 1}}} \\ {τ}_{CL 1 , 2} = \frac{1}{\frac{1}{{N}_{fSCC 1}} + \frac{{y}_{n}}{{N}_{fn 1 , 2}} + \frac{{y}_{110 \%}}{{N}_{f 110 \%1 , 2}} + \frac{{y}_{120 \%}}{{N}_{f 120 \%1 , 2}}} \\ {τ}_{CL 1 , 3} = \frac{1}{\frac{1}{{N}_{fSCC 1}} + \frac{{y}_{H}}{{N}_{fH 1}} + \frac{{y}_{n}}{{N}_{fn 1 , 3}} + \frac{{y}_{110 \%}}{{N}_{f 110 \%1 , 3}} + \frac{{y}_{120 \%}}{{N}_{f 120 \%1 , 3}}} \\ {τ}_{CL 1} = {τ}_{CL 1 , 1} + {τ}_{CL 1 , 2} + {τ}_{CL 1 , 3}$$

where, τ_{CL1,1} is a calendar life in a first phase of the first crack propagation category, τ_{CL1,2} is a calendar life in a second phase of the first crack propagation category, τ_{CL1,3} is a calendar life in a third phase of the first crack propagation category, yₙ is an annual average number of normal shutdowns of the in-service nuclear turbine, y_{110%} is an annual average number of 110% overspeed tests of the in-service nuclear turbine, y_{120%} is an annual average number of 120% overspeed operations of the in-service nuclear turbine, and y_{H} is an annual average number of high cycle fatigues of the blade groove of the rotor.

In some examples, the annual average number y_{H} of high cycle fatigues of the blade groove of the rotor may be acquired based on an annual average number ty of operation hours of the in-service nuclear turbine and a working speed no of the in-service nuclear turbine. For example, it may be implemented based on the following equation:

$${y}_{H} = \frac{3600 {t}_{y} {n}_{0}}{60}$$

For example, taking the fifth-stage inverted T-type blade groove of the No. 1 low-pressure rotor of the in-service nuclear turbine A in the above embodiment for example, the crack propagation category of the fifth-stage inverted T-type blade groove of the No. 1 low-pressure rotor of the in-service nuclear turbine A is the first crack propagation category, and calendar design monitoring basic data of the fifth-stage inverted T-type blade groove of the No. 1 low-pressure rotor of the in-service nuclear turbine A are as illustrated in Table 7.

TABLE 7
calendar design monitoring basic data of a blade
groove of an in-service nuclear turbine rotor

| | | Data |
|---|---|---|
| No. | Item | Value |
| 1 | annual average number yₙ/times of normal | 99 |
| | shutdowns | |
| 2 | annual average number y_{110%}/times of | 1 |
| | 110% overspeed tests | |
| 3 | annual average number y_{120%}/times of | 0.2 |
| | 120% overspeed operations | |
| 4 | annual average number of operation hours | 7000 |
| | t_{y}/h | |
| 5 | working speed n₀/r/min | 1500 |
| 6 | safety monitoring criterion value τ₀/year of | 60 |
| | a crack propagation life | |
| 7 | planned overhaul interval τₘ/year of an | 10 |
| | in-service nuclear turbine | |

A calculation process of the annual average number of high cycle fatigues of the fifth-stage inverted T-type blade groove of the No. 1 low-pressure rotor of the in-service nuclear turbine A is as follow:

$${y}_{H} = \frac{3600 {t}_{y} {n}_{0}}{60} = \frac{3600 \times 7000 \times 1500}{60} = 6.3 \times {10}^{8}$$

A calculation process of the crack propagation calendar life τ_{CL1} under the first crack propagation category of the fifth-stage inverted T-type blade groove of the No. 1 low-pressure rotor of the in-service nuclear turbine A is as follow:

$${τ}_{CL 1} = \frac{1}{\frac{{y}_{n}}{{N}_{fn 1 , 1}} + \frac{{y}_{110 \%}}{{N}_{f 110 \%1 , 1}} + \frac{{y}_{120 \%}}{{N}_{f 120 \%1 , 1}}} + \frac{1}{\frac{1}{{N}_{fSCC 1}} + \frac{{y}_{n}}{{N}_{fn 1 , 2}} + \frac{{y}_{110 \%}}{{N}_{f 110 \%1 , 2}} + \frac{{y}_{120 \%}}{{N}_{f 120 \%1 , 2}}} + \frac{1}{\frac{1}{{N}_{fSCC 1}} + \frac{{y}_{H}}{{N}_{fH 1}} + \frac{{y}_{n}}{{N}_{fn 1 , 3}} + \frac{{y}_{110 \%}}{{N}_{f 110 \%1 , 3}} + \frac{{y}_{120 \%}}{{N}_{f 120 \%1 , 3}}} = \frac{1}{\frac{99}{5725} + \frac{1}{4970} + \frac{0.2}{2922}} + \frac{1}{\frac{1}{18.36} + \frac{99}{3177} + \frac{1}{2758} + \frac{0.2}{1622}} + \frac{1}{\frac{1}{18.36} + \frac{6.3 \times {10}^{8}}{2.77 \times {10}^{9}} + \frac{99}{1466} + \frac{1}{1067} + \frac{0.2}{140}} = 56.94 + 11.61 + 2.84 = 71.39 years$$

For example, taking the fifth-stage inverted T-type blade groove of the No. 2 low-pressure rotor of the in-service nuclear turbine B in the above embodiment for example, the crack propagation category of the fifth-stage inverted T-type blade groove of the No. 2 low-pressure rotor of the in-service nuclear turbine B is the first crack propagation category, and calendar design monitoring basic data of the fifth-stage inverted T-type blade groove of the No. 2 low-pressure rotor of the in-service nuclear turbine B are as illustrated in Table 7.

A calculation process of the annual average number of high cycle fatigues of the fifth-stage inverted T-type blade groove of the No. 2 low-pressure rotor of the in-service nuclear turbine B is as follow:

$${y}_{H} = \frac{3600 {t}_{y} {n}_{0}}{60} = \frac{3600 \times 7000 \times 1500}{60} = 6.3 \times {10}^{8}$$

A calculation process of the crack propagation calendar life τ_{CL1} under the first crack propagation category of the fifth-stage inverted T-type blade groove of the No. 2 low-pressure rotor of the in-service nuclear turbine B is as follow:

$${τ}_{CL 1} = \frac{1}{\frac{{y}_{n}}{{N}_{fn 1 , 1}} + \frac{{y}_{110 \%}}{{N}_{f 110 \%1 , 1}} + \frac{{y}_{120 \%}}{{N}_{f 120 \%1 , 1}}} + \frac{1}{\frac{1}{{N}_{fSCC 1}} + \frac{{y}_{n}}{{N}_{fn 1 , 2}} + \frac{{y}_{110 \%}}{{N}_{f 110 \%1 , 2}} + \frac{{y}_{120 \%}}{{N}_{f 120 \%1 , 2}}} + \frac{1}{\frac{1}{{N}_{fSCC 1}} + \frac{{y}_{H}}{{N}_{fH 1}} + \frac{{y}_{n}}{{N}_{fn 1 , 3}} + \frac{{y}_{110 \%}}{{N}_{f 110 \%1 , 3}} + \frac{{y}_{120 \%}}{{N}_{f 120 \%1 , 3}}} = \frac{1}{\frac{99}{1693} + \frac{1}{1470} + \frac{0.2}{864}} + \frac{1}{\frac{1}{36.71} + \frac{99}{3177} + \frac{1}{2758} + \frac{0.2}{1622}} + \frac{1}{\frac{1}{36.71} + \frac{6.3 \times {10}^{8}}{2.77 \times {10}^{9}} + \frac{99}{1466} + \frac{1}{1067} + \frac{0.2}{140}} = 16.84 + 11.61 + 2.84 = 31.29 years$$

At S806, a crack propagation calendar life under the second crack propagation category is acquired based on a stress corrosion crack propagation life, low cycle fatigue crack propagation lives in a plurality of phases and a high cycle fatigue crack propagation life under the second crack propagation category.

In an implementation, acquiring the crack propagation calendar life under the second crack propagation category based on the stress corrosion crack propagation life, the low cycle fatigue crack propagation lives in the plurality of phases and the high cycle fatigue crack propagation life under the second crack propagation category includes acquiring a calendar life in each phase of the second crack propagation category based on the stress corrosion crack propagation life, the low cycle fatigue crack propagation lives in the plurality of phases and the high cycle fatigue crack propagation life under the second crack propagation category, and acquiring the crack propagation calendar life under the second crack propagation category based on the calendar life in each phase of the second crack propagation category.

In some examples, a calendar life in a first phase of the second crack propagation category is acquired based on a stress corrosion crack propagation life under the second crack propagation category, a low cycle fatigue crack propagation life in the first phase of the second crack propagation category under the normal shutdown transient condition of the in-service nuclear turbine, a low cycle fatigue crack propagation life in the first phase of the second crack propagation category under the 110% overspeed test transient condition of the in-service nuclear turbine, a low cycle fatigue crack propagation life in the first phase of the second crack propagation category under the 120% overspeed test transient condition of the in-service nuclear turbine, the annual average number of the normal shutdowns, the annual average number of the 110% overspeed tests and the annual average number of the 120% overspeed operations of the in-service nuclear turbine.

In some examples, a calendar life in a second phase of the second crack propagation category is acquired based on the stress corrosion crack propagation life under the second crack propagation category, a high cycle fatigue crack propagation life under the second crack propagation category, a low cycle fatigue crack propagation life in the second phase of the second crack propagation category under the normal shutdown transient condition of the in-service nuclear turbine, a low cycle fatigue crack propagation life in the second phase of the second crack propagation category under the 110% overspeed test transient condition of the in-service nuclear turbine, a low cycle fatigue crack propagation life in the second phase of the second crack propagation category under the 120% overspeed test transient condition of the in-service nuclear turbine, the annual average number of the normal shutdowns, the annual average number y_{110%} of the 110% overspeed tests and the annual average number of the 120% overspeed operations of the in-service nuclear turbine and an annual average number of high cycle fatigues of the blade groove of the rotor.

In some examples, a crack propagation calendar life under the second crack propagation category is acquired based on the calendar life in the first phase of the second crack propagation category, and the calendar life in the second phase of the second crack propagation category.

In some examples, a calculation process of a crack propagation calendar life τ_{CL2} under the second crack propagation category is as follow:

$${τ}_{CL 2 , 1} = \frac{1}{\frac{1}{{N}_{fSCC 2}} + \frac{{y}_{n}}{{N}_{fn 2 , 1}} + \frac{{y}_{110 \%}}{{N}_{f 110 \%2 , 1}} + \frac{{y}_{120 \%}}{{N}_{f 120 \%2 , 1}}} \\ {τ}_{CL 2 , 2} = \frac{1}{\frac{1}{{N}_{fSCC 2}} + \frac{{y}_{H}}{{N}_{fH 2}} + \frac{{y}_{n}}{{N}_{fn 2 , 2}} + \frac{{y}_{110 \%}}{{N}_{f 110 \%2 , 2}} + \frac{{y}_{120 \%}}{{N}_{f 120 \%2 , 2}}} \\ {τ}_{CL , 2} = {τ}_{CL 2 , 1} + {τ}_{CL 2 , 2}$$

where, τ_{CL2,1} is a calendar life in the first phase of the second crack propagation category, and τ_{CL2,2} is a calendar life in the second phase of the second crack propagation category.

For example, taking the fifth-stage inverted T-type blade groove of the No. 3 low-pressure rotor of the in-service nuclear turbine C in the above embodiment for example, the crack propagation category of the fifth-stage inverted T-type blade groove of the No. 3 low-pressure rotor of the in-service nuclear turbine C is the second crack propagation category, and calendar design monitoring basic data of the fifth-stage inverted T-type blade groove of the No. 3 low-pressure rotor of the in-service nuclear turbine C are as illustrated in Table 7.

A calculation process of the annual average number of high cycle fatigues of the fifth-stage inverted T-type blade groove of the No. 3 low-pressure rotor of the in-service nuclear turbine C is as follow.

$${y}_{H} = \frac{3600 {t}_{y} {n}_{0}}{60} = \frac{3600 \times 7000 \times 1500}{60} = 6.3 \times {10}^{8}$$

A calculation process of the crack propagation calendar life τ_{CL2} under the second crack propagation category for the fifth-stage inverted T-type blade groove of the No. 3 low-pressure rotor of the in-service nuclear turbine C is as follow:

$$\begin{matrix}{τ}_{CL 2} = \frac{1}{\frac{1}{{N}_{fSCC 2}} + \frac{{y}_{n}}{{N}_{fn 2 , 1}} + \frac{{y}_{110 \%}}{{N}_{f 110 \%2 , 1}} + \frac{{y}_{120 \%}}{{N}_{f 120 \%2 , 1}}} + \\ \frac{1}{\frac{1}{{N}_{fSCC 2}} + \frac{{y}_{H}}{{N}_{fH 2}} + \frac{{y}_{n}}{{N}_{fn 2 , 2}} + \frac{{y}_{110 \%}}{{N}_{f 110 \%2 , 2}} + \frac{{y}_{120 \%}}{{N}_{f 120 \%2 , 2}}} \\ = \frac{1}{\frac{1}{17.35} + \frac{99}{2435} + \frac{1}{2114} + \frac{0.2}{1243}} + \\ \frac{1}{\frac{1}{17.35} + \frac{6.3 \times {10}^{8}}{2.77 \times {10}^{9}} + \frac{99}{1466} + \frac{1}{1067} + \frac{0.2}{140}} \\ = 10.11 + 2.82 = 12.93 years\end{matrix}$$

At S807, a crack propagation calendar life under the third crack propagation category is acquired based on a stress corrosion crack propagation life, low cycle fatigue crack propagation lives in a plurality of phases and a high cycle fatigue crack propagation life under the third crack propagation category.

In an implementation, acquiring the crack propagation calendar life under the third crack propagation category based on the stress corrosion crack propagation life, the low cycle fatigue crack propagation lives in the plurality of phases and the high cycle fatigue crack propagation life under the third crack propagation category includes acquiring a calendar life in each phase of the third crack propagation category based on the stress corrosion crack propagation life, the low cycle fatigue crack propagation lives in the plurality of phases and the high cycle fatigue crack propagation life under the third crack propagation category, and acquiring the crack propagation calendar life under the third crack propagation category based on the calendar life in each phase of the third crack propagation category.

In some examples, a calendar life in a first phase of the third crack propagation category is acquired based on a low cycle fatigue crack propagation life in the first phase of the third crack propagation category under the normal shutdown transient condition of the in-service nuclear turbine, a low cycle fatigue crack propagation life in the first phase of the third crack propagation category under the 110% overspeed test transient condition of the in-service nuclear turbine, a low cycle fatigue crack propagation life in the first phase of the third crack propagation category under the 120% overspeed test transient condition of the in-service nuclear turbine, an annual average number of normal shutdowns, an annual average number of 110% overspeed tests and an annual average number of 120% overspeed operations of the in-service nuclear turbine.

In some examples, a calendar life in a second phase of the third crack propagation category is acquired based on a high cycle fatigue crack propagation life under the third second crack propagation category, a low cycle fatigue crack propagation life in the second phase of the third propagation category under the normal shutdown transient condition of the in-service nuclear turbine, a low cycle fatigue crack propagation life in the second phase of the third propagation category under the 110% overspeed test transient condition of the in-service nuclear turbine, a low cycle fatigue crack propagation life in the second phase of the third propagation category under the 120% overspeed test transient condition of the in-service nuclear turbine, the annual average number of the normal shutdowns, the annual average number of the 110% overspeed tests and the annual average number of the 120% overspeed operations of the in-service nuclear turbine and an annual average number of high cycle fatigues of the blade groove of the rotor.

In some examples, a calendar life in a third phase of the third crack propagation category is acquired based on the stress corrosion crack propagation life under the third crack propagation category, a high cycle fatigue crack propagation life under the third crack propagation category, a low cycle fatigue crack propagation life in the third phase of the third crack propagation category under the normal shutdown transient condition of the in-service nuclear turbine, the low cycle fatigue crack propagation life in the third phase of the third crack propagation category under the 110% overspeed test transient condition of the in-service nuclear turbine, the low cycle fatigue crack propagation life in the third phase of the third crack propagation category under the 120% overspeed test transient condition of the in-service nuclear turbine, the annual average number of the normal shutdowns, the annual average number of the 110% overspeed tests and the annual average number of the 120% overspeed operations of the in-service nuclear turbine and the annual average number of high cycle fatigues of the blade groove of the rotor.

In some examples, a crack propagation calendar life under the third crack propagation category is acquired based on the calendar life in the first phase of the third crack propagation category, the calendar life in the second phase of the third crack propagation category and the calendar life in the third phase of the third crack propagation category.

In some examples, a calculation process of a crack propagation calendar life τ_{CL3} under the third crack propagation category is as follow:

$${τ}_{CL 3 , 1} = \frac{1}{\frac{{y}_{n}}{{N}_{fn 3 , 1}} + \frac{{y}_{110 \%}}{{N}_{f 110 \%3 , 1}} + \frac{{y}_{120 \%}}{{N}_{f 120 \%3 , 1}}} \\ {τ}_{CL 3 , 2} = \frac{1}{\frac{{y}_{H}}{{N}_{fH 3}} + \frac{{y}_{n}}{{N}_{fn 3 , 2}} + \frac{{y}_{110 \%}}{{N}_{f 110 \%3 , 2}} + \frac{{y}_{120 \%}}{{N}_{f 120 \%3 , 2}}} \\ {τ}_{CL 3 , 3} = \frac{1}{\frac{1}{{N}_{fSCC 3}} + \frac{{y}_{H}}{{N}_{fH 3}} + \frac{{y}_{n}}{{N}_{fn 3 , 3}} + \frac{{y}_{110 \%}}{{N}_{f 110 \%3 , 3}} + \frac{{y}_{120 \%}}{{N}_{f 120 \%3 , 3}}} \\ {τ}_{CL 3} = {τ}_{CL 3 , 1} + {τ}_{CL 3 , 2} + {τ}_{CL 3 , 3}$$

where, τ_{CL3,1} is a calendar life in the first phase of the third crack propagation category, τ_{CL3,2} is a calendar life in the second phase of the third crack propagation category, and τ_{CL3,3} is a calendar life in the third phase of the third crack propagation category.

At S808, a crack propagation calendar life under the fourth crack propagation category is acquired based on a stress corrosion crack propagation life, low cycle fatigue crack propagation lives in a plurality of phases and a high cycle fatigue crack propagation life under the fourth crack propagation category.

In an implementation, acquiring the crack propagation calendar life under the fourth crack propagation category based on the stress corrosion crack propagation life, the low cycle fatigue crack propagation lives in the plurality of phases and the high cycle fatigue crack propagation life under the fourth crack propagation category includes acquiring a calendar life in each phase of the fourth crack propagation category based on the stress corrosion crack propagation life, the low cycle fatigue crack propagation lives in the plurality of phases and the high cycle fatigue crack propagation life under the fourth crack propagation category, and acquiring the crack propagation calendar life under the fourth crack propagation category based on the calendar life in each phase of the fourth crack propagation category.

In some examples, a calendar life in a first phase of the fourth crack propagation category is acquired based on a high cycle fatigue crack propagation life under the fourth crack propagation category, a low cycle fatigue crack propagation life in the first phase of the fourth propagation category under the normal shutdown transient condition of the in-service nuclear turbine, a low cycle fatigue crack propagation life in the first phase of the fourth propagation category under the 110% overspeed test transient condition of the in-service nuclear turbine, a low cycle fatigue crack propagation life in the first phase of the fourth propagation category under the 120% overspeed test transient condition of the in-service nuclear turbine, the annual average number of the normal shutdowns, the annual average number of the 110% overspeed tests and the annual average number of the 120% overspeed operations of the in-service nuclear turbine and an annual average number of high cycle fatigues of the blade groove of the rotor.

In some examples, a calendar life in a second phase of the fourth crack propagation category is acquired based on the stress corrosion crack propagation life under the fourth crack propagation category, a high cycle fatigue crack propagation life under the fourth crack propagation category, a low cycle fatigue crack propagation life in the second phase of the fourth crack propagation category under the normal shutdown transient condition of the in-service nuclear turbine, a low cycle fatigue crack propagation life in the second phase of the fourth crack propagation category under the 110% overspeed test transient condition of the in-service nuclear turbine, a low cycle fatigue crack propagation life in the second phase of the fourth crack propagation category under the 120% overspeed test transient condition of the in-service nuclear turbine, the annual average number of the normal shutdowns, the annual average number of the 110% overspeed tests and the annual average number of the 120% overspeed operations of the in-service nuclear turbine and an annual average number of high cycle fatigues of the blade groove of the rotor.

In some examples, a crack propagation calendar life under the fourth crack propagation category is acquired based on the calendar life in the first phase of the fourth crack propagation category, and the calendar life in the second phase of the fourth crack propagation category.

In some examples, a calculation process of a crack propagation calendar life τ_{CL4} under the fourth crack propagation category is as follow:

$${τ}_{CL 4 , 1} = \frac{1}{\frac{{y}_{H}}{{N}_{fH 4}} + \frac{{y}_{n}}{{N}_{fn 4 , 1}} + \frac{{y}_{110 \%}}{{N}_{f 110 \%4 , 1}} + \frac{{y}_{120 \%}}{{N}_{f 120 \%4 , 1}}} \\ {τ}_{CL 4 , 2} = \frac{1}{\frac{1}{{N}_{fSCC 4}} + \frac{{y}_{H}}{{N}_{fH 4}} + \frac{{y}_{n}}{{N}_{fn 4 , 2}} + \frac{{y}_{110 \%}}{{N}_{f 110 \%4 , 2}} + \frac{{y}_{120 \%}}{{N}_{f 120 \%4 , 2}}} \\ {τ}_{CL 4} = {τ}_{CL 4 , 1} + {τ}_{CL 4 , 2}$$

where, τ_{CL4,1} is a calendar life in the first phase of the fourth crack propagation category, and τ_{CL4,2} is a calendar life in the second phase of the fourth crack propagation category.

At S809, safety monitoring is performed on the crack in the blade groove of the rotor based on the crack propagation calendar life.

Explanation of S809 may refer to the above embodiments, which will not be repeated here.

In summary, in the method for safety monitoring of the crack in the blade groove of the in-service nuclear turbine rotor in embodiments of the present disclosure, the crack propagation calendar life under the crack propagation category may be acquired in consideration of the annual average number of the normal shutdowns, the annual average number of the 110% overspeed tests and the annual average number of the 120% overspeed operations of the in-service nuclear turbine, and the annual average number of high cycle fatigues of the blade groove of the rotor, the stress corrosion crack propagation life, the low cycle fatigue crack propagation lives in the plurality of phases and the high cycle fatigue crack propagation life under a certain crack propagation category.

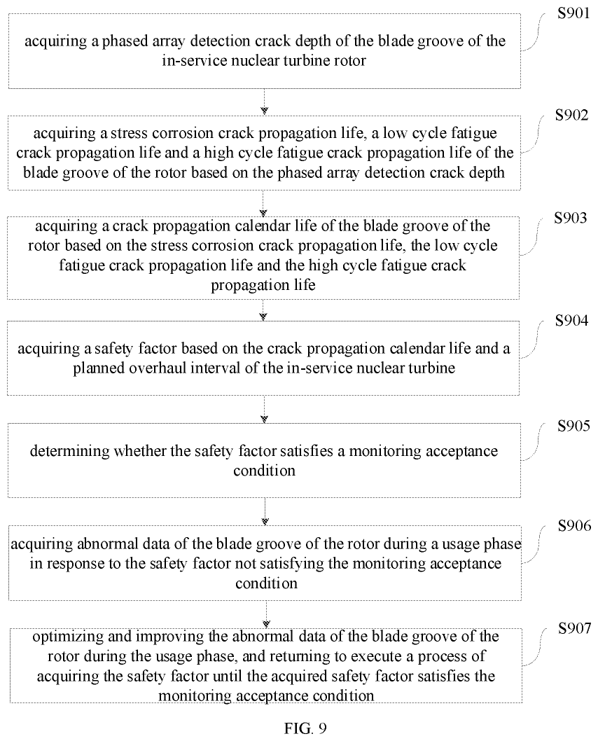

FIG. 9 is a flowchart illustrating a method for safety monitoring of a crack in a blade groove of an in-service nuclear turbine rotor according to another embodiment of the present disclosure.

As illustrated in FIG. 9, the method for safety monitoring of the crack in the blade groove of the in-service nuclear turbine rotor according to an embodiment of the present disclosure may include the following steps.

At S901, a phased array detection crack depth of the blade groove of the in-service nuclear turbine rotor is acquired.

At S902, a stress corrosion crack propagation life, a low cycle fatigue crack propagation life and a high cycle fatigue crack propagation life of the blade groove of the rotor are acquired based on the phased array detection crack depth.

At S903, a crack propagation calendar life of the blade groove of the rotor is acquired based on the stress corrosion crack propagation life, the low cycle fatigue crack propagation life and the high cycle fatigue crack propagation life.

Explanation of S901-S903 may refer to the above embodiments, which will not be repeated here.

At S904, a safety factor is acquired based on the crack propagation calendar life and a planned overhaul interval of the in-service nuclear turbine.

At S905, it is determined whether the safety factor satisfies a monitoring acceptance condition.

In an implementation, acquiring the safety factor based on the crack propagation calendar life and the planned overhaul interval of the in-service nuclear turbine includes determining a ratio of the crack propagation calendar life to the planned overhaul interval or a difference value between the crack propagation calendar life and the planned overhaul interval as the safety factor.

In an implementation, the safety factor is positively correlated with the crack propagation calendar life, and is negatively correlated with the planned overhaul interval.

It is noted that the monitoring acceptance condition is not limited, and for example, the safety factor being greater than a second preset threshold may be determined as the monitoring acceptance condition. The second preset threshold is not limited, and for example, may be 2.

For example, taking the fifth-stage inverted T-type blade groove of the No. 1 low-pressure rotor of the in-service nuclear turbine A, the fifth-stage inverted T-type blade groove of the No. 2 low-pressure rotor of the in-service nuclear turbine B and the fifth-stage inverted T-type blade groove of the No. 3 low-pressure rotor of the in-service nuclear turbine C in the above embodiment for example, a planned overhaul interval τₘ of each of the in-service nuclear turbine A, the in-service nuclear turbine B and the in-service nuclear turbine C is as illustrated in Table 12, τₘ=10 years.

The crack propagation category of the fifth-stage inverted T-type blade groove of the No. 1 low-pressure rotor of the in-service nuclear turbine A is the first crack propagation category, and a crack propagation calendar life τ_{CL1} under the first crack propagation category of the fifth-stage inverted T-type blade groove of the No. 1 low-pressure rotor of the in-service nuclear turbine A is 71.39 years, in which case, a calculation process of a safety factor S_{R} is as follow:

$${S}_{R} = \frac{{τ}_{CL 1}}{{τ}_{m}} = \frac{71.39}{10} = 7.14$$

It can be seen that the safety factor of the fifth-stage inverted T-type blade groove of the No. 1 low-pressure rotor of the in-service nuclear turbine A is that S_{R}=7.14>2, it is determined that the safety factor S_{R} satisfies the monitoring acceptance condition.

The crack propagation category of the fifth-stage inverted T-type blade groove of the No. 2 low-pressure rotor of the in-service nuclear turbine B is the first crack propagation category, and a crack propagation calendar life τ_{CL1} under the first crack propagation category of the fifth-stage inverted T-type blade groove of the No. 2 low-pressure rotor of the in-service nuclear turbine B is 31.29 years, in which case, a calculation process of the safety factor S_{R} is as follow:

$${S}_{R} = \frac{{τ}_{CL 1}}{{τ}_{m}} = \frac{31.29}{10} = 3.13$$

It can be seen that the safety factor of the fifth-stage inverted T-type blade groove of the No. 2 low-pressure rotor of the in-service nuclear turbine B is that S_{R}=3.13>2, it is determined that the safety factor S_{R} satisfies the monitoring acceptance condition.

The crack propagation category of the fifth-stage inverted T-type blade groove of the No. 3 low-pressure rotor of the in-service nuclear turbine C is the second crack propagation category, and a crack propagation calendar life τ_{CL2} under the second crack propagation category of the fifth-stage inverted T-type blade groove of the No. 3 low-pressure rotor of the in-service nuclear turbine C is 12.93 years, in which case, a calculation process of the safety factor S_{R} is as follow:

$${S}_{R} = \frac{{τ}_{CL 2}}{{τ}_{m}} = \frac{12.93}{10} = 1.29$$

It can be seen that the safety factor of the fifth-stage inverted T-type blade groove of the No. 3 low-pressure rotor of the in-service nuclear turbine C is that S_{R}=1.29>2, it is determined that the safety factor S_{R} does not satisfy the monitoring acceptance condition.

At S906, abnormal data of the blade groove of the rotor during a usage phase are acquired in response to the safety factor not satisfying the monitoring acceptance condition.

At S907, the abnormal data of blade groove during the usage phase are optimized and improved, and it is returned to execute a process of acquiring the safety factor until the acquired safety factor satisfies the monitoring acceptance condition.

It is noted that, the abnormal data of the blade groove of the rotor during the usage phase are not limited in the disclosure, and for example, may include usage technology parameters of the blade groove of the rotor, stress calculation basic data of the blade groove of the rotor during the usage phase, material test basic data of the in-service nuclear turbine rotor during the usage phase, etc.

In some examples, optimizing and improving the abnormal data of the blade groove of the rotor in the usage phase includes turning or grinding the crack in the blade groove of the rotor; turning to increase a fillet radius of a location where the blade groove of the rotor is located on the premise of not influencing a structural strength of the blade groove of the rotor; performing local repair welding; eliminating a welding residual stress by a local heat treatment processing technology; finishing and polishing a repair welding part; enhancing a machining precision, and eliminating a machining stress concentration; performing a phased array non-destructive monitoring again to determine a depth of a crack in the blade groove; and performing shot peening on the blade groove to improve a fatigue performance.

Taking the fifth-stage inverted T-type blade groove of the No. 3 low-pressure rotor of the in-service nuclear turbine C in the above embodiment for example, in response to the safety factor S_{R} not satisfying the monitoring acceptance condition, the abnormal data of the fifth-stage inverted T-type blade groove of the No. 3 low-pressure rotor of the in-service nuclear turbine C during the usage phase may be optimized and improved, and no crack may be found during a phased array non-destructive monitoring on the optimized and improved fifth-stage inverted T-type blade groove of the No. 3 low-pressure rotor of the in-service nuclear turbine C, and the depth of the crack is set as aᵢ=2 mm=0.002 m.

The safety monitoring is performed on the crack again under a combined action of stress corrosion cracking, high cycle fatigue damage and low cycle fatigue damage, and a crack propagation calendar life of the fifth-stage inverted T-type blade groove of the No. 3 low-pressure rotor of the in-service nuclear turbine C is recalculated. When the recalculated crack propagation calendar life is a crack propagation calendar life τ_{CL1} under the first crack propagation category, that is, 71.39 years, and τₘ=10 years, a calculation process of the safety factor S_{R} is as follows:

$${S}_{R} = \frac{{τ}_{CL 1}}{{τ}_{m}} = \frac{71.39}{10} = 7.14$$

It can be seen that the safety factor of the fifth-stage inverted T-type blade groove of the No. 3 low-pressure rotor of the in-service nuclear turbine C is that S_{R}=7.14>2, it is determined that the safety factor satisfies the monitoring acceptance condition, and performing the safety monitoring on the crack in the fifth-stage inverted T-type blade groove of the No. 3 low-pressure rotor of the in-service nuclear turbine C ends.

In summary, based on the method for safety monitoring of the crack in the blade groove of the in-service nuclear turbine rotor in embodiments of the present disclosure, the safety factor is acquired based on the crack propagation calendar life and the planned overhaul interval of the in-service nuclear turbine. It is determined whether the safety factor satisfies the monitoring acceptance condition. The abnormal data of the blade groove of the rotor during the usage phase are acquired in response to the safety factor not satisfying the monitoring acceptance condition. The abnormal data of the blade groove of the rotor during the usage phase are optimized and improved, and it is returned to execute the process of acquiring the safety factor until the acquired safety factor satisfies the monitoring acceptance condition, which helps improve safety of the blade groove of the rotor during the usage phase, and is suitable for monitoring the blade groove of the in-service nuclear turbine rotor.

In order to implement the above embodiment, an apparatus for monitoring safety of a crack in a blade groove of an in-service nuclear turbine rotor is further provided in the disclosure.

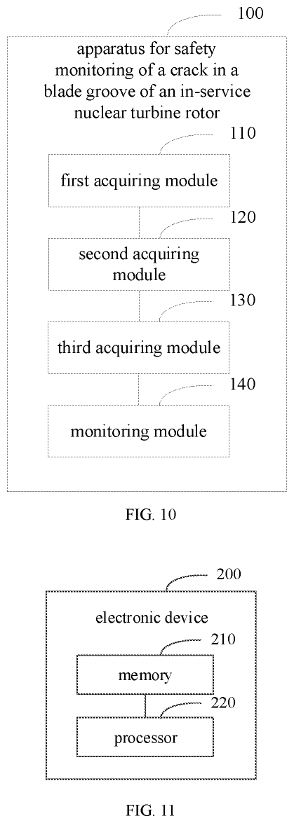

FIG. 10 is a diagram illustrating a structure of an apparatus for safety monitoring of a crack in a blade groove of an in-service nuclear turbine rotor according to an embodiment of the present disclosure.

As illustrated in FIG. 10, the apparatus 100 for safety monitoring of a crack in a blade groove of an in-service nuclear turbine rotor according to the embodiment of the present disclosure includes a first acquiring module 110, a second acquiring module 120, a third acquiring module 130 and a monitoring module 140.

The first acquiring module 110 is configured to acquire a phased array detection crack depth of the blade groove of the in-service nuclear turbine rotor.

The second acquiring module 120 is configured to acquire a stress corrosion crack propagation life, a low cycle fatigue crack propagation life and a high cycle fatigue crack propagation life of the blade groove of the rotor based on the phased array detection crack depth.

The third acquiring module 130 is configured to acquire a crack propagation calendar life of the blade groove of the rotor based on the stress corrosion crack propagation life, the low cycle fatigue crack propagation life and the high cycle fatigue crack propagation life.

The monitoring module 140 is configured to perform safety monitoring on the crack in the blade groove of the rotor based on the crack propagation calendar life.

In an embodiment of the present disclosure, the first acquiring module 110 is further configured to: acquire the phased array detection crack depth by performing a phased array detection on the blade groove of the rotor by a phased array ultrasonic flaw detector and a phased array probe; and in response to no crack being found during the phased array detection on the blade groove of the rotor, set the phased array detection crack depth as a preset value.

In an embodiment of the present disclosure, the second acquiring module 120 is further configured to: acquire a crack propagation size set of the blade groove of the rotor; acquire a crack propagation category of the blade groove of the rotor based on the phased array detection crack depth and the crack propagation size set; and acquire a stress corrosion crack propagation life, a low cycle fatigue crack propagation life, and a high cycle fatigue crack propagation life under the crack propagation category of the blade groove of the rotor. Different crack propagation categories correspond to different stress corrosion crack propagation lives, different low cycle fatigue crack propagation lives, and different high cycle fatigue crack propagation lives.

In an embodiment of the present disclosure, the second acquiring module 120 is further configured to: acquire stress calculation basic data of the blade groove of the rotor; acquire material test basic data of the in-service nuclear turbine rotor; and determine the crack propagation size set based on the stress calculation basic data and the material test basic data of the rotor.

In an embodiment of the present disclosure, the second acquiring module 120 is further configured to: determine a stress corrosion crack propagation size threshold value of the blade groove of the rotor based on a crack shape parameter of the blade groove of the rotor, a stress corrosion fracture toughness of a material of the rotor and a maximum stress at a crack location in the blade groove of the rotor under a load operation steady-state condition of the in-service nuclear turbine;
determine a high cycle fatigue crack propagation size threshold value of the blade groove of the rotor based on the crack shape parameter of the blade groove of the rotor, a test value of a high cycle fatigue crack propagation threshold value of the material of the rotor and a range of a high cycle fatigue stress at the crack location in the blade groove of the rotor under the load operation steady-state condition of the in-service nuclear turbine;
determine a high cycle fatigue critical crack size of the blade groove of the rotor based on the crack shape parameter of the blade groove of the rotor, a fracture toughness of the material of the rotor, and the maximum stress at the crack location in the blade groove of the rotor under the load operation steady-state condition of the in-service nuclear turbine;
determine a low cycle fatigue critical crack size of the blade groove of the rotor under a normal shutdown transient condition of the in-service nuclear turbine based on the crack shape parameter of the blade groove of the rotor, the fracture toughness of the material of the rotor, and a maximum stress at the crack location in the blade groove of the rotor under the normal shutdown transient condition of the in-service nuclear turbine;
determine a low cycle fatigue critical crack size of the blade groove of the rotor under a 120% overspeed test transient condition of the in-service nuclear turbine based on the crack shape parameter of the blade groove of the rotor, the fracture toughness of the material of the rotor, and a maximum stress at the crack location in the blade groove of the rotor in the 120% overspeed test transient condition of the in-service nuclear turbine; and
determine a low cycle fatigue critical crack size of the blade groove of the rotor under a 120% overspeed test transient condition of the in-service nuclear turbine based on the crack shape parameter of the blade groove of the rotor, the fracture toughness of the material of the rotor, and a maximum stress at the crack location in the blade groove of the rotor in the 120% overspeed test transient condition of the in-service nuclear turbine; and
determine that the crack propagation category is a first crack propagation category in response to the phased array detection crack depth being less than the stress corrosion crack propagation size threshold value, and the stress corrosion crack propagation size threshold value being less than the high cycle fatigue crack propagation size threshold value; or
determine that the crack propagation category is a second crack propagation category in response to the stress corrosion crack propagation size threshold value being less than the phased array detection crack depth, and the phased array detection crack depth being less than the high cycle fatigue crack propagation size threshold value; or
determine that the crack propagation category is a second crack propagation category in response to the stress corrosion crack propagation size threshold value being less than the phased array detection crack depth, and the phased array detection crack depth being less than the high cycle fatigue crack propagation size threshold value; or
determine that the crack propagation category is a fourth crack propagation category in response to the high cycle fatigue crack propagation size threshold value being less than the phased array detection crack depth, and the phased array detection crack depth being less than the stress corrosion crack propagation size threshold value.

In an embodiment of the present disclosure, when the crack propagation category is a first crack propagation category, and the first crack propagation category includes three phases, in which a crack size of the blade groove of the rotor in a first phase is extended from the phased array detection crack depth to the stress corrosion crack propagation size threshold value, a crack size of the blade groove of the rotor in a second phase is extended from the stress corrosion crack propagation size threshold value to the high cycle fatigue crack propagation size threshold value, and a crack size of the blade groove of the rotor in a third phase is extended from the high cycle fatigue crack propagation size threshold value to a low cycle fatigue critical crack size.

In an embodiment of the present disclosure, when the crack propagation category is a second crack propagation category, and the second crack propagation category includes two phases, in which a crack size of the blade groove of the rotor in a first phase is extended from the phased array detection crack depth to the high cycle fatigue crack propagation size threshold value, and a crack size of the blade groove of the rotor in a second phase is extended from the high cycle fatigue crack propagation size threshold value to the low cycle fatigue critical crack size.

In an embodiment of the present disclosure, when the crack propagation category is a third crack propagation category, and the third crack propagation category includes three phases, in which a crack size of the blade groove of the rotor in a first phase is extended from the phased array detection crack depth to the high cycle fatigue crack propagation size threshold value, a crack size of the blade groove of the rotor in a second phase is extended from the high cycle fatigue crack propagation size threshold value to the stress corrosion crack propagation size threshold value, and a crack size of the blade groove of the rotor in a third phase is extended from the stress corrosion crack propagation size threshold value to the low cycle fatigue critical crack size.

In an embodiment of the present disclosure, when the crack propagation category is a fourth crack propagation category, and the fourth crack propagation category includes two phases, in which a crack size of the blade groove of the rotor in a first phase is extended from the phased array detection crack depth to the stress corrosion crack propagation size threshold value, and a crack size of the blade groove of the rotor in a second phase is extended from the stress corrosion crack propagation size threshold value to the low cycle fatigue critical crack size.

In an embodiment of the present disclosure, the second acquiring module 120 is further configured to:
acquire a stress corrosion crack propagation life under any one of the first crack propagation category, the third crack propagation category or the fourth crack propagation category based on the stress corrosion crack propagation size threshold value, a test value of an annual average stress corrosion crack propagation rate of the material of the rotor, and the low cycle fatigue critical crack size of the blade groove of the rotor under the normal shutdown transient condition of the in-service nuclear turbine; and
acquire a stress corrosion crack propagation life under the second crack propagation category based on the phased array detection crack depth, the test value of the annual average stress corrosion crack propagation rate of the material of the rotor, and the low cycle fatigue critical crack size of the blade groove of the rotor under the normal shutdown transient condition of the in-service nuclear turbine.

In an embodiment of the present disclosure, the second acquiring module 120 is further configured to:
acquire a high cycle fatigue crack propagation life under any one of the first crack propagation category, the second crack propagation category or the third crack propagation category based on the high cycle fatigue crack propagation size threshold value, the high cycle fatigue critical crack size, the crack shape parameter of the blade groove of the rotor, a high cycle fatigue crack propagation test constant of the material of the rotor, and a range of a high cycle fatigue stress at the blade groove of the rotor under the load operation steady-state condition of the in-service nuclear turbine; and
acquire a high cycle fatigue crack propagation life under the fourth crack propagation category based on the phased array detection crack depth, the high cycle fatigue critical crack size, the crack shape parameter of the blade groove of the rotor, the high cycle fatigue crack propagation test constant of the material of the rotor, and the range of the high cycle fatigue stress at the blade groove of the rotor under the load operation steady-state condition of the in-service nuclear turbine.

In an embodiment of the present disclosure, the second acquiring module 120 is further configured to:
acquire a low cycle fatigue crack propagation life in a first phase of the first crack propagation category under the normal shutdown transient condition of the in-service nuclear turbine based on the phased array detection crack depth, the stress corrosion crack propagation size threshold value, the crack shape parameter of the blade groove of the rotor, a low cycle fatigue crack propagation test constant of the material of the rotor, and the maximum stress at the crack location in the blade groove of the rotor under the normal shutdown transient condition of the in-service nuclear turbine;
acquire a low cycle fatigue crack propagation life in a second phase of the first crack propagation category under the normal shutdown transient condition of the in-service nuclear turbine based on the stress corrosion crack propagation size threshold value, the high cycle fatigue crack propagation size threshold value, the crack shape parameter of the blade groove of the rotor, the low cycle fatigue crack propagation test constant of the material of the rotor, and the maximum stress at the crack location in the blade groove of the rotor under the normal shutdown transient condition of the in-service nuclear turbine; and
acquire a low cycle fatigue crack propagation life in a third phase of the first crack propagation category under the normal shutdown transient condition of the in-service nuclear turbine based on the high cycle fatigue crack propagation size threshold value, the low cycle fatigue critical crack size of the blade groove of the rotor under the normal shutdown transient condition of the in-service nuclear turbine, the crack shape parameter of the blade groove of the rotor, the low cycle fatigue crack propagation test constant of the material of the rotor, and the maximum stress at the crack location in the blade groove of the rotor under the normal shutdown transient condition of the in-service nuclear turbine.

In an embodiment of the present disclosure, the second acquiring module 120 is further configured to: acquire a low cycle fatigue crack propagation life in a first phase of the second crack propagation category under the normal shutdown transient condition of the in-service nuclear turbine based on the phased array detection crack depth, the high cycle fatigue crack propagation size threshold value, the crack shape parameter of the blade groove of the rotor, a low cycle fatigue crack propagation test constant of the material of the rotor, and the maximum stress at the crack location in the blade groove of the rotor under the normal shutdown transient condition of the in-service nuclear turbine; and
acquire a low cycle fatigue crack propagation life in a second phase of the second crack propagation category under the normal shutdown transient condition of the in-service nuclear turbine based on the high cycle fatigue crack propagation size threshold value, the low cycle fatigue critical crack size of the blade groove of the rotor under the normal shutdown transient condition of the in-service nuclear turbine, the crack shape parameter of the blade groove of the rotor, the low cycle fatigue crack propagation test constant of the material of the rotor, and the maximum stress at the crack location in the blade groove of the rotor under the normal shutdown transient condition of the in-service nuclear turbine.

In an embodiment of the present disclosure, the second acquiring module 120 is further configured to:
acquire a low cycle fatigue crack propagation life in a first phase of the third propagation category under the normal shutdown transient condition of the in-service nuclear turbine based on the phased array detection crack depth, the high cycle fatigue crack propagation size threshold value, the crack shape parameter of the blade groove of the rotor, a low cycle fatigue crack propagation test constant of the material of the rotor, and the maximum stress at the crack location in the blade groove of the rotor under the normal shutdown transient condition of the in-service nuclear turbine;
acquire a low cycle fatigue crack propagation life in a second phase of the third propagation category under the normal shutdown transient condition of the in-service nuclear turbine based on the high cycle fatigue crack propagation size threshold value, the stress corrosion crack propagation size threshold value, the crack shape parameter of the blade groove of the rotor, the low cycle fatigue crack propagation test constant of the material of the rotor, and the maximum stress at the crack location in the blade groove of the rotor under the normal shutdown transient condition of the in-service nuclear turbine; and
acquire a low cycle fatigue crack propagation life in a third phase of the third propagation category under the normal shutdown transient condition of the in-service nuclear turbine based on the stress corrosion crack propagation size threshold value, the low cycle fatigue critical crack size of the blade groove of the rotor under the normal shutdown transient condition of the in-service nuclear turbine, the crack shape parameter of the blade groove of the rotor, the low cycle fatigue crack propagation test constant of the material of the rotor, and the maximum stress at the crack location in the blade groove of the rotor under the normal shutdown transient condition of the in-service nuclear turbine.

In an embodiment of the present disclosure, the second acquiring module 120 is further configured to:
acquire a low cycle fatigue crack propagation life in a first phase of the fourth propagation category under the normal shutdown transient condition of the in-service nuclear turbine based on the phased array detection crack depth, the stress corrosion crack propagation size threshold value, the crack shape parameter of the blade groove of the rotor, a low cycle fatigue crack propagation test constant of the material of the rotor, and the maximum stress at the crack location in the blade groove of the rotor under the normal shutdown transient condition of the in-service nuclear turbine; and
acquire a low cycle fatigue crack propagation life in a second phase of the fourth propagation category under the normal shutdown transient condition of the in-service nuclear turbine based on the stress corrosion crack propagation size threshold value, the low cycle fatigue critical crack size of the blade groove of the rotor under the normal shutdown transient condition of the in-service nuclear turbine, the crack shape parameter of the blade groove of the rotor, the low cycle fatigue crack propagation test constant of the material of the rotor, and the maximum stress at the crack location in the blade groove of the rotor under the normal shutdown transient condition of the in-service nuclear turbine.

In an embodiment of the present disclosure, the second acquiring module 120 is further configured to:
acquire a low cycle fatigue crack propagation life in a first phase of the first crack propagation category under the 120% overspeed test transient condition of the in-service nuclear turbine based on the phased array detection crack depth, the stress corrosion crack propagation size threshold value, the crack shape parameter of the blade groove of the rotor, a low cycle fatigue crack propagation test constant of the material of the rotor, and the maximum stress at the crack location in the blade groove of the rotor under the 120% overspeed test transient condition of the in-service nuclear turbine;
acquire a low cycle fatigue crack propagation life in a second phase of the first crack propagation category under the 120% overspeed test transient condition of the in-service nuclear turbine based on the stress corrosion crack propagation size threshold value, the high cycle fatigue crack propagation size threshold value, the crack shape parameter of the blade groove of the rotor, the low cycle fatigue crack propagation test constant of the material of the rotor, and the maximum stress at the crack location in the blade groove of the rotor under the 120% overspeed test transient condition of the in-service nuclear turbine; and
acquire a low cycle fatigue crack propagation life in a third phase of the first crack propagation category under the 120% overspeed test transient condition of the in-service nuclear turbine based on the high cycle fatigue crack propagation size threshold value, the low cycle fatigue critical crack size of the blade groove of the rotor under the 120% overspeed test transient condition of the in-service nuclear turbine, the crack shape parameter of the blade groove of the rotor, the low cycle fatigue crack propagation test constant of the material of the rotor, and the maximum stress at the crack location in the blade groove of the rotor under the 120% overspeed test transient condition of the in-service nuclear turbine.

In an embodiment of the present disclosure, the second acquiring module 120 is further configured to:
acquire a low cycle fatigue crack propagation life in a first phase of the second crack propagation category under the 120% overspeed test transient condition of the in-service nuclear turbine based on the phased array detection crack depth, the high cycle fatigue crack propagation size threshold value, the crack shape parameter of the blade groove of the rotor, a low cycle fatigue crack propagation test constant of the material of the rotor, and the maximum stress at the crack location in the blade groove of the rotor under the 120% overspeed test transient condition of the in-service nuclear turbine; and
acquire a low cycle fatigue crack propagation life in a second phase of the second crack propagation category under the 120% overspeed test transient condition of the in-service nuclear turbine based on the high cycle fatigue crack propagation size threshold value, the low cycle fatigue critical crack size of the blade groove of the rotor under the 120% overspeed test transient condition of the in-service nuclear turbine, the crack shape parameter of the blade groove of the rotor, the low cycle fatigue crack propagation test constant of the material of the rotor, and the maximum stress at the crack location in the blade groove of the rotor under the 120% overspeed test transient condition of the in-service nuclear turbine.

In an embodiment of the present disclosure, the second acquiring module 120 is further configured to:
acquire a low cycle fatigue crack propagation life in a first phase of the third crack propagation category under the 120% overspeed test transient condition of the in-service nuclear turbine based on the phased array detection crack depth, the high cycle fatigue crack propagation size threshold value, the crack shape parameter of the blade groove of the rotor, a low cycle fatigue crack propagation test constant of the material of the rotor, and the maximum stress at the crack location in the blade groove of the rotor under the 120% overspeed test transient condition of the in-service nuclear turbine;
acquire a low cycle fatigue crack propagation life in a second phase of the third crack propagation category under the 120% overspeed test transient condition of the in-service nuclear turbine based on the high cycle fatigue crack propagation size threshold value, the stress corrosion crack propagation size threshold value, the crack shape parameter of the blade groove of the rotor, the low cycle fatigue crack propagation test constant of the material of the rotor, and the maximum stress at the crack location in the blade groove of the rotor under the 120% overspeed test transient condition of the in-service nuclear turbine; and
acquire a low cycle fatigue crack propagation life in a third phase of the third crack propagation category under the 120% overspeed test transient condition of the in-service nuclear turbine based on the high cycle fatigue crack propagation size threshold value, the low cycle fatigue critical crack size of the blade groove of the rotor under the 120% overspeed test transient condition of the in-service nuclear turbine, the crack shape parameter of the blade groove of the rotor, the low cycle fatigue crack propagation test constant of the material of the rotor, and the maximum stress at the crack location in the blade groove of the rotor under the 120% overspeed test transient condition of the in-service nuclear turbine.

In an embodiment of the present disclosure, the second acquiring module 120 is further configured to:
acquire a low cycle fatigue crack propagation life in a first phase of the fourth crack propagation category under the 120% overspeed test transient condition of the in-service nuclear turbine based on the phased array detection crack depth, the stress corrosion crack propagation size threshold value, the crack shape parameter of the blade groove of the rotor, a low cycle fatigue crack propagation test constant of the material of the rotor, and the maximum stress at the crack location in the blade groove of the rotor under the 120% overspeed test transient condition of the in-service nuclear turbine; and
acquire a low cycle fatigue crack propagation life in a second phase of the fourth crack propagation category under the 120% overspeed test transient condition of the in-service nuclear turbine based on the high cycle fatigue crack propagation size threshold value, the low cycle fatigue critical crack size of the blade groove of the rotor under the 120% overspeed test transient condition of the in-service nuclear turbine, the crack shape parameter of the blade groove of the rotor, the low cycle fatigue crack propagation test constant of the material of the rotor, and the maximum stress at the crack location in the blade groove of the rotor under the 120% overspeed test transient condition of the in-service nuclear turbine.

In an embodiment of the present disclosure, the second acquiring module 120 is further configured to:
acquire a low cycle fatigue crack propagation life in a first phase of the first crack propagation category under the 120% overspeed test transient condition of the in-service nuclear turbine based on the phased array detection crack depth, the stress corrosion crack propagation size threshold value, the crack shape parameter of the blade groove of the rotor, a low cycle fatigue crack propagation test constant of the material of the rotor, and the maximum stress at the crack location in the blade groove of the rotor under the 120% overspeed test transient condition of the in-service nuclear turbine;
acquire a low cycle fatigue crack propagation life in a second phase of the first crack propagation category under the 120% overspeed test transient condition of the in-service nuclear turbine based on the stress corrosion crack propagation size threshold value, the high cycle fatigue crack propagation size threshold value, the crack shape parameter of the blade groove of the rotor, the low cycle fatigue crack propagation test constant of the material of the rotor, and the maximum stress at the crack location in the blade groove of the rotor under the 120% overspeed test transient condition of the in-service nuclear turbine; and
acquire a low cycle fatigue crack propagation life in a third phase of the first crack propagation category under the 120% overspeed test transient condition of the in-service nuclear turbine based on the high cycle fatigue crack propagation size threshold value, the low cycle fatigue critical crack size of the blade groove of the rotor under the 120% overspeed test transient condition of the in-service nuclear turbine, the crack shape parameter of the blade groove of the rotor, the low cycle fatigue crack propagation test constant of the material of the rotor, and the maximum stress at the crack location in the blade groove of the rotor under the 120% overspeed test transient condition of the in-service nuclear turbine.

In an embodiment of the present disclosure, the second acquiring module 120 is further configured to:
acquire a low cycle fatigue crack propagation life in a first phase of the second crack propagation category under the 120% overspeed test transient condition of the in-service nuclear turbine based on the phased array detection crack depth, the high cycle fatigue crack propagation size threshold value, the crack shape parameter of the blade groove of the rotor, a low cycle fatigue crack propagation test constant of the material of the rotor, and the maximum stress at the crack location in the blade groove of the rotor under the 120% overspeed test transient condition of the in-service nuclear turbine; and
acquire a low cycle fatigue crack propagation life in a second phase of the second crack propagation category under the 120% overspeed test transient condition of the in-service nuclear turbine based on the high cycle fatigue crack propagation size threshold value, the low cycle fatigue critical crack size of the blade groove of the rotor under the 120% overspeed test transient condition of the in-service nuclear turbine, the crack shape parameter of the blade groove of the rotor, the low cycle fatigue crack propagation test constant of the material of the rotor, and the maximum stress at the crack location in the blade groove of the rotor under the 120% overspeed test transient condition of the in-service nuclear turbine.

In an embodiment of the present disclosure, the second acquiring module 120 is further configured to:
acquire a low cycle fatigue crack propagation life in a first phase of the third crack propagation category under the 120% overspeed test transient condition of the in-service nuclear turbine based on the phased array detection crack depth, the high cycle fatigue crack propagation size threshold value, the crack shape parameter of the blade groove of the rotor, a low cycle fatigue crack propagation test constant of the material of the rotor, and the maximum stress at the crack location in the blade groove of the rotor under the 120% overspeed test transient condition of the in-service nuclear turbine;
acquire a low cycle fatigue crack propagation life in a second phase of the third crack propagation category under the 120% overspeed test transient condition of the in-service nuclear turbine based on the high cycle fatigue crack propagation size threshold value, the stress corrosion crack propagation size threshold value, the crack shape parameter of the blade groove of the rotor, the low cycle fatigue crack propagation test constant of the material of the rotor, and the maximum stress at the crack location in the blade groove of the rotor under the 120% overspeed test transient condition of the in-service nuclear turbine; and
acquire a low cycle fatigue crack propagation life in a third phase of the third crack propagation category under the 120% overspeed test transient condition of the in-service nuclear turbine based on the high cycle fatigue crack propagation size threshold value, the low cycle fatigue critical crack size of the blade groove of the rotor under the 120% overspeed test transient condition of the in-service nuclear turbine, the crack shape parameter of the blade groove of the rotor, the low cycle fatigue crack propagation test constant of the material of the rotor, and the maximum stress at the crack location in the blade groove of the rotor under the 120% overspeed test transient condition of the in-service nuclear turbine.

In an embodiment of the present disclosure, the second acquiring module 120 is further configured to:
acquire a low cycle fatigue crack propagation life in a first phase of the fourth crack propagation category under the 120% overspeed test transient condition of the in-service nuclear turbine based on the phased array detection crack depth, the stress corrosion crack propagation size threshold value, the crack shape parameter of the blade groove of the rotor, a low cycle fatigue crack propagation test constant of the material of the rotor, and the maximum stress at the crack location in the blade groove of the rotor under the 120% overspeed test transient condition of the in-service nuclear turbine; and
acquire a low cycle fatigue crack propagation life in a second phase of the fourth crack propagation category under the 120% overspeed test transient condition of the in-service nuclear turbine based on the high cycle fatigue crack propagation size threshold value, the low cycle fatigue critical crack size of the blade groove of the rotor under the 120% overspeed test transient condition of the in-service nuclear turbine, the crack shape parameter of the blade groove of the rotor, the low cycle fatigue crack propagation test constant of the material of the rotor, and the maximum stress at the crack location in the blade groove of the rotor under the 120% overspeed test transient condition of the in-service nuclear turbine.

In an embodiment of the present disclosure, the third acquiring module 130 is further configured to: acquire a crack propagation calendar life under the crack propagation category based on a stress corrosion crack propagation life, low cycle fatigue crack propagation lives in a plurality of phases and a high cycle fatigue crack propagation life under the crack propagation category.

In an embodiment of the present disclosure, the third acquiring module 130 is further configured to:
acquire a calendar life in a first phase of the first crack propagation category based on a low cycle fatigue crack propagation life in the first phase of the first crack propagation category under the normal shutdown transient condition of the in-service nuclear turbine, a low cycle fatigue crack propagation life in the first phase of the first crack propagation category under the 120% overspeed test transient condition of the in-service nuclear turbine, a low cycle fatigue crack propagation life in the first phase of the first crack propagation category under the 120% overspeed test transient condition of the in-service nuclear turbine, an annual average number of normal shutdowns, an annual average number of 120% overspeed tests and an annual average number of 120% overspeed operations of the in-service nuclear turbine;
acquire a calendar life in a second phase of the first crack propagation category based on a stress corrosion crack propagation life under the first crack propagation category, a low cycle fatigue crack propagation life in the second phase of the first crack propagation category under the normal shutdown transient condition of the in-service nuclear turbine, a low cycle fatigue crack propagation life in the second phase of the first crack propagation category under the 120% overspeed test transient condition of the in-service nuclear turbine, a low cycle fatigue crack propagation life in the second phase of the first crack propagation category under the 120% overspeed test transient condition of the in-service nuclear turbine, the annual average number of the normal shutdowns, the annual average number of the 120% overspeed tests and the annual average number of the 120% overspeed operations of the in-service nuclear turbine;
acquire a calendar life in a third phase of the first crack propagation category based on the stress corrosion crack propagation life under the first crack propagation category, a high cycle fatigue crack propagation life under the first crack propagation category, a low cycle fatigue crack propagation life in the third phase of the first crack propagation category under the normal shutdown transient condition of the in-service nuclear turbine, a low cycle fatigue crack propagation life in the third phase of the first crack propagation category under the 120% overspeed test transient condition of the in-service nuclear turbine, a low cycle fatigue crack propagation life in the third phase of the first crack propagation category under the 120% overspeed test transient condition of the in-service nuclear turbine, the annual average number of the normal shutdowns, the annual average number of the 120% overspeed tests and the annual average number of the 120% overspeed operations of the in-service nuclear turbine and an annual average number of high cycle fatigues of the blade groove of the rotor; and
acquire a crack propagation calendar life under the first crack propagation category based on the calendar life in the first phase of the first crack propagation category, the calendar life in the second phase of the first crack propagation category and the calendar life in the third phase of the first crack propagation category.

In an embodiment of the present disclosure, the third acquiring module 130 is further configured to:
acquire a calendar life in a first phase of the second crack propagation category based on a stress corrosion crack propagation life under the second crack propagation category, a low cycle fatigue crack propagation life in the first phase of the second crack propagation category under the normal shutdown transient condition of the in-service nuclear turbine, a low cycle fatigue crack propagation life in the first phase of the second crack propagation category under the 120% overspeed test transient condition of the in-service nuclear turbine, a low cycle fatigue crack propagation life in the first phase of the second crack propagation category under the 120% overspeed test transient condition of the in-service nuclear turbine, an annual average number of normal shutdowns, an annual average number of 120% overspeed tests and an annual average number of 120% overspeed operations of the in-service nuclear turbine;
acquire a calendar life in a second phase of the second crack propagation category based on a stress corrosion crack propagation life under the second crack propagation category, a high cycle fatigue crack propagation life under the second crack propagation category, a low cycle fatigue crack propagation life in the second phase of the second crack propagation category under the normal shutdown transient condition of the in-service nuclear turbine, a low cycle fatigue crack propagation life in the second phase of the second crack propagation category under the 120% overspeed test transient condition of the in-service nuclear turbine, a low cycle fatigue crack propagation life in the second phase of the second crack propagation category under the 120% overspeed test transient condition of the in-service nuclear turbine, the annual average number of the normal shutdowns, the annual average number of the 120% overspeed tests and the annual average number of the 120% overspeed operations of the in-service nuclear turbine, and an annual average number of high cycle fatigues of the blade groove of the rotor; and
acquire a crack propagation calendar life under the second crack propagation category based on the calendar life in the first phase of the second crack propagation category, and the calendar life in the second phase of the second crack propagation category.

In an embodiment of the present disclosure, the third acquiring module 130 is further configured to:
acquire a calendar life in a first phase of the third crack propagation category based on a low cycle fatigue crack propagation life in the first phase of the third crack propagation category under the normal shutdown transient condition of the in-service nuclear turbine, a low cycle fatigue crack propagation life in the first phase of the third crack propagation category under the 120% overspeed test transient condition of the in-service nuclear turbine, a low cycle fatigue crack propagation life in the first phase of the third crack propagation category under the 120% overspeed test transient condition of the in-service nuclear turbine, an annual average number of normal shutdowns, an annual average number of 120% overspeed tests and an annual average number of 120% overspeed operations of the in-service nuclear turbine;
acquire a calendar life in a second phase of the third crack propagation category based on a high cycle fatigue crack propagation life under the third second crack propagation category, a low cycle fatigue crack propagation life in the second phase of the third propagation category under the normal shutdown transient condition of the in-service nuclear turbine, a low cycle fatigue crack propagation life in the second phase of the third propagation category under the 120% overspeed test transient condition of the in-service nuclear turbine, a low cycle fatigue crack propagation life in the second phase of the third propagation category under the 120% overspeed test transient condition of the in-service nuclear turbine, the annual average number of the normal shutdowns, the annual average number of the 120% overspeed tests and the annual average number of the 120% overspeed operations of the in-service nuclear turbine and an annual average number of high cycle fatigues of the blade groove of the rotor;
acquire a calendar life in a third phase of the third crack propagation category based on the stress corrosion crack propagation life under the third crack propagation category, a high cycle fatigue crack propagation life under the third crack propagation category, a low cycle fatigue crack propagation life in the third phase of the third crack propagation category under the normal shutdown transient condition of the in-service nuclear turbine, a low cycle fatigue crack propagation life in the third phase of the third crack propagation category under the 120% overspeed test transient condition of the in-service nuclear turbine, a low cycle fatigue crack propagation life in the third phase of the third crack propagation category under the 120% overspeed test transient condition of the in-service nuclear turbine, the annual average number of the normal shutdowns, the annual average number of the 120% overspeed tests and the annual average number of the 120% overspeed operations of the in-service nuclear turbine and an annual average number of high cycle fatigues of the blade groove of the rotor; and
acquire a crack propagation calendar life under the third crack propagation category based on the calendar life in the first phase of the third crack propagation category, the calendar life in the second phase of the third crack propagation category and the calendar life in the third phase of the third crack propagation category.

In an embodiment of the present disclosure, the third acquiring module 130 is further configured to:
acquire a calendar life in a first phase of the fourth crack propagation category based on a high cycle fatigue crack propagation life under the fourth crack propagation category, a low cycle fatigue crack propagation life in the first phase of the fourth propagation category under the normal shutdown transient condition of the in-service nuclear turbine, a low cycle fatigue crack propagation life in the first phase of the fourth propagation category under the 120% overspeed test transient condition of the in-service nuclear turbine, a low cycle fatigue crack propagation life in the first phase of the fourth propagation category under the 120% overspeed test transient condition of the in-service nuclear turbine, an annual average number of normal shutdowns, an annual average number of 120% overspeed tests and an annual average number of 120% overspeed operations of the in-service nuclear turbine and an annual average number of high cycle fatigues of the blade groove of the rotor;
acquire a calendar life in a second phase of the fourth crack propagation category based on a stress corrosion crack propagation life under the fourth crack propagation category, a high cycle fatigue crack propagation life under the fourth crack propagation category, a low cycle fatigue crack propagation life in the second phase of the fourth crack propagation category under the normal shutdown transient condition of the in-service nuclear turbine, a low cycle fatigue crack propagation life in the second phase of the fourth crack propagation category under the 120% overspeed test transient condition of the in-service nuclear turbine, a low cycle fatigue crack propagation life in the second phase of the fourth crack propagation category under the 120% overspeed test transient condition of the in-service nuclear turbine, the annual average number of the normal shutdowns, the annual average number of the 120% overspeed tests and the annual average number of the 120% overspeed operations of the in-service nuclear turbine, and an annual average number of high cycle fatigues of the blade groove of the rotor; and
acquire a crack propagation calendar life under the fourth crack propagation category based on the calendar life in the first phase of the fourth crack propagation category, and the calendar life in the second phase of the fourth crack propagation category.

In an embodiment of the present disclosure, the monitoring module 140 is further configured to: acquire a safety factor based on the crack propagation calendar life and a planned overhaul interval of the in-service nuclear turbine; and perform safety monitoring on the crack in the blade groove of the rotor by determining whether the safety factor satisfies a monitoring acceptance condition.

In an embodiment of the present disclosure, the monitoring module 140 is further configured to: acquire abnormal data of the blade groove of the rotor during a usage phase in response to the safety factor not satisfying the monitoring acceptance condition; and optimize and improve the abnormal data of the blade groove of the rotor during the usage phase, and return to execute a process of acquiring the safety factor until the acquired safety factor satisfies the monitoring acceptance condition.

It needs to be noted that, for details not disclosed in the apparatus for safety monitoring of a crack in a blade groove of an in-service nuclear turbine rotor in embodiments of the present disclosure, please refer to details not disclosed in the method for safety monitoring of a crack in a blade groove of an in-service nuclear turbine rotor in embodiments of the present disclosure, which will not be repeated here.

In summary, in the apparatus for safety monitoring of the crack in the blade groove of the in-service nuclear turbine rotor in embodiments of the present disclosure, the phased array detection crack depth of the blade groove of the in-service nuclear turbine rotor is acquired. The stress corrosion crack propagation life, the low cycle fatigue crack propagation life and the high cycle fatigue crack propagation life of the blade groove of the rotor are acquired based on the phased array detection crack depth. The crack propagation calendar life of the blade groove of the rotor is acquired based on the stress corrosion crack propagation life, the low cycle fatigue crack propagation life and the high cycle fatigue crack propagation life. The safety monitoring is performed on the crack in the blade groove of the rotor based on the crack propagation calendar life. Therefore, the safety monitoring may be performed on the crack in the blade groove of the rotor in consideration of influences of the stress corrosion, the low cycle fatigue and the high cycle fatigue on the life of the blade groove of the rotor, to ensure a long life safe operation of the rotor of the in-service nuclear turbine.

In order to achieve the above embodiments, as illustrated in FIG. 11, an electronic device 300 is provided, and includes a memory 210, a processor 220 and a computer program stored on the memory 210 and executable by the processor 220. The processor 220 implements a method for safety monitoring of a crack in a blade groove of an in-service nuclear turbine rotor when executing the program.

In an embodiment of the present disclosure, the electronic device 200 further includes: a wireless communication component. The wireless communication component is connected to the in-service nuclear turbine, and data transmission is performed between the electronic device and the in-service nuclear turbine through the wireless communication component.

In an embodiment of the present disclosure, the memory 210 is configured to store a crack propagation calendar life of the blade groove of the in-service nuclear turbine rotor; the processor 220 is configured to acquire a crack safety monitoring instruction, and acquire a crack propagation calendar life of a target blade groove of the in-service nuclear turbine rotor to be monitored from the memory 210 based on the crack safety monitoring instruction, and perform safety monitoring on a crack in the target blade groove of the rotor based on the crack propagation calendar life of the target blade groove of the rotor.

In an embodiment of the present disclosure, the electronic device 200 further includes: a remote client. The remote client is connected to the processor 220; and the remote client is configured to send the crack security monitoring instruction to the processor 220, and receive a monitoring result fed back by the processor 220.

In an embodiment of the present disclosure, the remote client is further configured to acquire control information of a user indicating controlling the remote client, and generate the crack security monitoring instruction based on the control information.

In an embodiment of the present disclosure, the processor 220 is further configured to determine the blade groove of the in-service nuclear turbine rotor associated with the remote client as the target blade groove of the rotor.

In the electronic device in embodiments of the present disclosure, the computer program stored on the memory is executed by the processor. The phased array detection crack depth of the blade groove of the in-service nuclear turbine rotor is acquired. The stress corrosion crack propagation life, the low cycle fatigue crack propagation life and the high cycle fatigue crack propagation life of the blade groove of the rotor are acquired based on the phased array detection crack depth. The crack propagation calendar life of the blade groove of the rotor is acquired based on the stress corrosion crack propagation life, the low cycle fatigue crack propagation life and the high cycle fatigue crack propagation life. The safety monitoring is performed on the crack in the blade groove of the rotor based on the crack propagation calendar life. Therefore, the safety monitoring may be performed on the crack in the blade groove of the rotor in consideration of influences of the stress corrosion, the low cycle fatigue and the high cycle fatigue on the life of the blade groove of the rotor, to ensure a long life safe operation of the rotor of the in-service nuclear turbine.

In order to implement the above embodiment, a computer-readable storage medium with a computer program stored thereon is provided in embodiments of the present disclosure. The computer program is caused to implement a method for safety monitoring of a crack in a blade groove of the in-service nuclear turbine rotor as described above when executed by a processor.

The computer-readable storage medium in embodiments of the present disclosure stores the computer program and the computer program is executed by the processor The phased array detection crack depth of the blade groove of the in-service nuclear turbine rotor is acquired. The stress corrosion crack propagation life, the low cycle fatigue crack propagation life and the high cycle fatigue crack propagation life of the blade groove of the rotor are acquired based on the phased array detection crack depth. The crack propagation calendar life of the blade groove of the rotor is acquired based on the stress corrosion crack propagation life, the low cycle fatigue crack propagation life and the high cycle fatigue crack propagation life. The safety monitoring is performed on the crack in the blade groove of the rotor based on the crack propagation calendar life. Therefore, the safety monitoring may be performed on the crack in the blade groove of the rotor in consideration of influences of the stress corrosion, the low cycle fatigue and the high cycle fatigue on the life of the blade groove of the rotor, to ensure a long life safe operation of the rotor of the in-service nuclear turbine.

In order to achieve the above embodiments, a monitoring platform suitable for an in-service nuclear turbine is provided, and includes the apparatus for safety monitoring of a crack in a blade groove of an in-service nuclear turbine rotor as described in FIG. 11; or the electronic device as described above; or the computer-readable storage medium as described above.

In the monitoring platform suitable for the in-service nuclear turbine in embodiments of the present disclosure, the phased array detection crack depth of the blade groove of the in-service nuclear turbine rotor is acquired. The stress corrosion crack propagation life, the low cycle fatigue crack propagation life and the high cycle fatigue crack propagation life of the blade groove of the rotor are acquired based on the phased array detection crack depth. The crack propagation calendar life of the blade groove of the rotor is acquired based on the stress corrosion crack propagation life, the low cycle fatigue crack propagation life and the high cycle fatigue crack propagation life. The safety monitoring is performed on the crack in the blade groove of the rotor based on the crack propagation calendar life. Therefore, the safety monitoring may be performed on the crack in the blade groove of the rotor in consideration of influences of the stress corrosion, the low cycle fatigue and the high cycle fatigue on the life of the blade groove of the rotor, to ensure a long life safe operation of the rotor of the in-service nuclear turbine.

In the description of the present disclosure, it should be understood that an orientation or position relationship indicated by terms “center”, “longitudinal”, “transverse”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential” and the like is merely an orientation or position relationship shown in the accompanying drawings, rather than indicating or implying that the referred apparatus or element must have a specific orientation to construct and operate in a specific orientation, and therefore, cannot be understood as a limitation to the present disclosure.

In addition, terms “first” and “second” used in the present disclosure are only for description purpose, and may not be understood as indicating or implying a relative importance or implying a number of technical features indicated by implication. Therefore, features limiting “first” and “second” may explicitly or implicitly include one or more of the features. In the description of the present disclosure, “a plurality of” means two or more than two, unless otherwise specified.

In the present disclosure, terms such as “mounted”, “linked”, “connected”, “fixed” and the like should be construed broadly unless expressly specified and defined otherwise, and for example, may be a fixed connection, a detachable connection, or a whole; or may be a mechanical connection or an electrical connection; or may be a direct connection or an indirect connection via an intermediate medium, or may be a communication relationship between two elements or an interaction relationship between two elements. For those skilled in the art, specific meanings of the above terms in the present disclosure may be understood based on specific situations.

In the present disclosure, unless expressly specified and defined otherwise, the first feature “on” or “under” the second feature may be that the first feature is in direct contact with the second feature, or the first feature is in indirect contact with the second feature via an intermediate medium. Moreover, the first feature “above”, “over”, and “upper” the second feature may be the first feature is directly above or obliquely above the second feature, or merely indicates that the first feature horizontal height is higher than the second feature. The first feature “below”, “under” and “lower” the second feature may be that the first feature is directly below or obliquely below the second feature, or merely indicates that the first feature level height is less than the second feature.

In descriptions of the specification, descriptions with reference to terms “one embodiment”, “some embodiments”, “examples”, “specific examples” or “some examples” etc. mean specific features, structures, materials or characteristics described in conjunction with the embodiment or example are included in at least one embodiment or example of the present disclosure. In this specification, the schematic representations of the above terms do not have to be the same embodiment or example. Moreover, specific features, structures, materials or characteristics described may be combined in any one or more embodiments or examples in a suitable manner. In addition, those skilled in the art may combine different embodiments or examples and characteristics of different embodiments or examples described in this specification without contradicting each other.

It should be understood that, notwithstanding the embodiments of the present disclosure are shown and described above, the above embodiments are exemplary in nature and shall not be construed as a limitation of the present disclosure. Those skilled in the art may change, modify, substitute and vary the above embodiments within the scope of the present disclosure.

1. A method for safety monitoring of a crack in a blade groove of an nuclear turbine rotor, comprising:
acquiring a phased array detection crack depth of the blade groove of the nuclear turbine rotor;
acquiring a stress corrosion crack propagation life, low cycle fatigue and high cycle fatigue crack propagation lives based on the crack depth, wherein a stress corrosion crack propagation size threshold value is determined based on a crack shape parameter of the blade groove of the rotor, a stress corrosion fracture toughness of a material of the rotor and a maximum stress at a crack location in the blade groove of the rotor under a load operation steady-state condition; a low cycle fatigue critical crack size of the blade groove of the rotor under a normal shutdown transient condition is determined based on the crack shape parameter of the blade groove of the rotor, the fracture toughness of the material of the rotor, and a maximum stress at the crack location in the blade groove of the rotor under the normal shutdown transient condition; a stress corrosion crack propagation lives under different crack propagation categories are acquired based on the stress corrosion crack propagation size threshold value, the phased array detection crack depth, a test value of an annual average stress corrosion crack propagation rate of the material of the rotor, and the low cycle fatigue critical crack size;
acquiring a crack propagation calendar life of the blade groove of the rotor based on the stress corrosion crack propagation life, the low cycle fatigue and high cycle fatigue crack propagation life; and
performing safety monitoring on the crack in the blade groove of the rotor.

2. The method according to claim 1, wherein acquiring the phased array detection crack depth of the blade groove of the nuclear turbine rotor comprises:
acquiring the phased array detection crack depth by performing a phased array detection on the blade groove of the rotor by a phased array ultrasonic flaw detector and a phased array probe; and
in response to no crack being found during the phased array detection on the blade groove of the rotor, setting the phased array detection crack depth as a preset value.

3. The method according to claim 1, wherein acquiring the stress corrosion crack propagation life, the low cycle fatigue and high cycle fatigue crack propagation lives based on the crack depth comprises:
acquiring a crack propagation size set of the blade groove of the rotor;
acquiring a crack propagation category of the blade groove of the rotor based on the phased array detection crack depth and the crack propagation size set; and
acquiring a stress corrosion crack propagation life, a low cycle fatigue crack propagation life, and a high cycle fatigue crack propagation life under the crack propagation category of the blade groove of the rotor, wherein different crack propagation categories correspond to different stress corrosion crack propagation lives, different low cycle fatigue crack propagation lives, and different high cycle fatigue crack propagation lives.

4. The method according to claim 3, wherein acquiring the crack propagation size set of the blade groove of the rotor comprises:
acquiring stress calculation basic data of the blade groove of the rotor;
acquiring material test basic data of the nuclear turbine rotor; and
determining the crack propagation size set based on the stress calculation basic data and the material test basic data of the rotor.

5. The method according to claim 4, wherein determining the crack propagation size set based on the stress calculation basic data and the material test basic data of the rotor comprises:
determining a high cycle fatigue crack propagation size threshold value of the blade groove of the rotor based on the crack shape parameter of the blade groove of the rotor, a test value of a high cycle fatigue crack propagation threshold value of the material of the rotor and a range of a high cycle fatigue stress at the crack location in the blade groove of the rotor under the load operation steady-state condition of the nuclear turbine;
determining a high cycle fatigue critical crack size of the blade groove of the rotor based on the crack shape parameter of the blade groove of the rotor, a fracture toughness of the material of the rotor, and the maximum stress at the crack location in the blade groove of the rotor under the load operation steady-state condition of the nuclear turbine;
determining a low cycle fatigue critical crack size of the blade groove of the rotor under a 110% overspeed test transient condition of the nuclear turbine based on the crack shape parameter of the blade groove of the rotor, the fracture toughness of the material of the rotor, and a maximum stress at the crack location in the blade groove of the rotor in the 110% overspeed test transient condition of the nuclear turbine; and
determining a low cycle fatigue critical crack size of the blade groove of the rotor under a 120% overspeed operation transient condition of the nuclear turbine based on the crack shape parameter of the blade groove of the rotor, the fracture toughness of the material of the rotor, and a maximum stress at the crack location in the blade groove of the rotor under the 120% overspeed operation transient condition of the nuclear turbine.

6. The method according to claim 4, wherein acquiring the crack propagation category of the blade groove of the rotor based on the phased array detection crack depth and the crack propagation size set comprises:
determining the crack propagation category as a first crack propagation category in response to the phased array detection crack depth being less than the stress corrosion crack propagation size threshold value, and the stress corrosion crack propagation size threshold value being less than the high cycle fatigue crack propagation size threshold value; or
determining the crack propagation category as a second crack propagation category in response to the stress corrosion crack propagation size threshold value being less than the phased array detection crack depth, and the phased array detection crack depth being less than the high cycle fatigue crack propagation size threshold value; or
determining the crack propagation category as a third crack propagation category in response to the stress corrosion crack propagation size threshold value being less than the phased array detection crack depth, and the phased array detection crack depth being less than the high cycle fatigue crack propagation size threshold value; or
determining the crack propagation category as a fourth crack propagation category in response to the high cycle fatigue crack propagation size threshold value being less than the phased array detection crack depth, and the phased array detection crack depth being less than the stress corrosion crack propagation size threshold value.

7. The method according to claim 6, wherein acquiring the stress corrosion crack propagation life under the crack propagation category of the blade groove of the rotor comprises at least one of:
acquiring a stress corrosion crack propagation life under any one of the first crack propagation category, the third crack propagation category or the fourth crack propagation category based on the stress corrosion crack propagation size threshold value, a test value of an annual average stress corrosion crack propagation rate of the material of the rotor, and the low cycle fatigue critical crack size of the blade groove of the rotor under the normal shutdown transient condition of the nuclear turbine; or
acquiring a stress corrosion crack propagation life under the second crack propagation category based on the phased array detection crack depth, the test value of the annual average stress corrosion crack propagation rate of the material of the rotor, and the low cycle fatigue critical crack size of the blade groove of the rotor under the normal shutdown transient condition of the nuclear turbine.

8. The method according to claim 6, wherein acquiring the high cycle fatigue crack propagation life under the crack propagation category of the blade groove of the rotor comprises at least one of:
acquiring a high cycle fatigue crack propagation life under any one of the first crack propagation category, the second crack propagation category or the third crack propagation category based on the high cycle fatigue crack propagation size threshold value, the high cycle fatigue critical crack size, the crack shape parameter of the blade groove of the rotor, a high cycle fatigue crack propagation test constant of the material of the rotor, and a range of a high cycle fatigue stress at the blade groove of the rotor under the load operation steady-state condition of the nuclear turbine; or
acquiring a high cycle fatigue crack propagation life under the fourth crack propagation category based on the phased array detection crack depth, the high cycle fatigue critical crack size, the crack shape parameter of the blade groove of the rotor, the high cycle fatigue crack propagation test constant of the material of the rotor, and the range of the high cycle fatigue stress at the blade groove of the rotor under the load operation steady-state condition of the nuclear turbine.

9. The method according to claim 6, wherein acquiring the low cycle fatigue crack propagation life under the crack propagation category of the blade groove of the rotor comprises:
acquiring a low cycle fatigue crack propagation life in a first phase of the first crack propagation category under the normal shutdown transient condition of the nuclear turbine based on the phased array detection crack depth, the stress corrosion crack propagation size threshold value, the crack shape parameter of the blade groove of the rotor, a low cycle fatigue crack propagation test constant of the material of the rotor, and the maximum stress at the crack location in the blade groove of the rotor under the normal shutdown transient condition of the nuclear turbine;
acquiring a low cycle fatigue crack propagation life in a second phase of the first crack propagation category under the normal shutdown transient condition of the nuclear turbine based on the stress corrosion crack propagation size threshold value, the high cycle fatigue crack propagation size threshold value, the crack shape parameter of the blade groove of the rotor, the low cycle fatigue crack propagation test constant of the material of the rotor, and the maximum stress at the crack location in the blade groove of the rotor under the normal shutdown transient condition of the nuclear turbine; and
acquiring a low cycle fatigue crack propagation life in a third phase of the first crack propagation category under the normal shutdown transient condition of the nuclear turbine based on the high cycle fatigue crack propagation size threshold value, the low cycle fatigue critical crack size of the blade groove of the rotor under the normal shutdown transient condition of the nuclear turbine, the crack shape parameter of the blade groove of the rotor, the low cycle fatigue crack propagation test constant of the material of the rotor, and the maximum stress at the crack location in the blade groove of the rotor under the normal shutdown transient condition of the nuclear turbine.

10. The method according to claim 6, wherein acquiring the low cycle fatigue crack propagation life under the crack propagation category of the blade groove of the rotor comprises:
acquiring a low cycle fatigue crack propagation life in a first phase of the second crack propagation category under the normal shutdown transient condition of the nuclear turbine based on the phased array detection crack depth, the high cycle fatigue crack propagation size threshold value, the crack shape parameter of the blade groove of the rotor, a low cycle fatigue crack propagation test constant of the material of the rotor, and the maximum stress at the crack location in the blade groove of the rotor under the normal shutdown transient condition of the nuclear turbine; and
acquiring a low cycle fatigue crack propagation life in a second phase of the second crack propagation category under the normal shutdown transient condition of the nuclear turbine based on the high cycle fatigue crack propagation size threshold value, the low cycle fatigue critical crack size of the blade groove of the rotor under the normal shutdown transient condition of the nuclear turbine, the crack shape parameter of the blade groove of the rotor, the low cycle fatigue crack propagation test constant of the material of the rotor, and the maximum stress at the crack location in the blade groove of the rotor under the normal shutdown transient condition of the nuclear turbine.

11. The method according to claim 6, wherein acquiring the low cycle fatigue crack propagation life under the crack propagation category of the blade groove of the rotor comprises:
acquiring a low cycle fatigue crack propagation life in a first phase of the third propagation category under the normal shutdown transient condition of the nuclear turbine based on the phased array detection crack depth, the high cycle fatigue crack propagation size threshold value, the crack shape parameter of the blade groove of the rotor, a low cycle fatigue crack propagation test constant of the material of the rotor, and the maximum stress at the crack location in the blade groove of the rotor under the normal shutdown transient condition of the nuclear turbine;
acquiring a low cycle fatigue crack propagation life in a second phase of the third propagation category under the normal shutdown transient condition of the nuclear turbine based on the high cycle fatigue crack propagation size threshold value, the stress corrosion crack propagation size threshold value, the crack shape parameter of the blade groove of the rotor, the low cycle fatigue crack propagation test constant of the material of the rotor, and the maximum stress at the crack location in the blade groove of the rotor under the normal shutdown transient condition of the nuclear turbine; and
acquiring a low cycle fatigue crack propagation life in a third phase of the third propagation category under the normal shutdown transient condition of the nuclear turbine based on the stress corrosion crack propagation size threshold value, the low cycle fatigue critical crack size of the blade groove of the rotor under the normal shutdown transient condition of the nuclear turbine, the crack shape parameter of the blade groove of the rotor, the low cycle fatigue crack propagation test constant of the material of the rotor, and the maximum stress at the crack location in the blade groove of the rotor under the normal shutdown transient condition of the nuclear turbine.

12. The method according to claim 6, wherein acquiring the low cycle fatigue crack propagation life under the crack propagation category of the blade groove of the rotor comprises:
acquiring a low cycle fatigue crack propagation life in a first phase of the fourth propagation category under the normal shutdown transient condition of the nuclear turbine based on the phased array detection crack depth, the stress corrosion crack propagation size threshold value, the crack shape parameter of the blade groove of the rotor, a low cycle fatigue crack propagation test constant of the material of the rotor, and the maximum stress at the crack location in the blade groove of the rotor under the normal shutdown transient condition of the nuclear turbine; and
acquiring a low cycle fatigue crack propagation life in a second phase of the fourth propagation category under the normal shutdown transient condition of the nuclear turbine based on the stress corrosion crack propagation size threshold value, the low cycle fatigue critical crack size of the blade groove of the rotor under the normal shutdown transient condition of the nuclear turbine, the crack shape parameter of the blade groove of the rotor, the low cycle fatigue crack propagation test constant of the material of the rotor, and the maximum stress at the crack location in the blade groove of the rotor under the normal shutdown transient condition of the nuclear turbine.

13. The method according to claim 6, wherein acquiring the crack propagation calendar life of the blade groove of the rotor based on the stress corrosion crack propagation life, the low cycle fatigue crack propagation life and the high cycle fatigue crack propagation life comprises:
acquiring a crack propagation calendar life under the crack propagation category based on a stress corrosion crack propagation life, low cycle fatigue crack propagation lives in a plurality of phases and a high cycle fatigue crack propagation life under the crack propagation category.

14. The method according to claim 13, wherein acquiring the crack propagation calendar life under the crack propagation category based on the stress corrosion crack propagation life, the low cycle fatigue crack propagation lives in the plurality of phases and the high cycle fatigue crack propagation life under the crack propagation category comprises:
acquiring a calendar life in a first phase of the first crack propagation category based on a low cycle fatigue crack propagation life in the first phase of the first crack propagation category under the normal shutdown transient condition of the nuclear turbine, a low cycle fatigue crack propagation life in the first phase of the first crack propagation category under the 110% overspeed test transient condition of the nuclear turbine, a low cycle fatigue crack propagation life in the first phase of the first crack propagation category under the 120% overspeed operation transient condition of the nuclear turbine, an annual average number of normal shutdowns, an annual average number of 110% overspeed tests and an annual average number of 120% overspeed operations of the nuclear turbine;
acquiring a calendar life in a second phase of the first crack propagation category based on a stress corrosion crack propagation life under the first crack propagation category, a low cycle fatigue crack propagation life in the second phase of the first crack propagation category under the normal shutdown transient condition of the nuclear turbine, a low cycle fatigue crack propagation life in the second phase of the first crack propagation category under the 110% overspeed test transient condition of the nuclear turbine, a low cycle fatigue crack propagation life in the second phase of the first crack propagation category under the 120% overspeed operation transient condition of the nuclear turbine, the annual average number of the normal shutdowns, the annual average number of the 110% overspeed tests and the annual average number of the 120% overspeed operations of the nuclear turbine;
acquiring a calendar life in a third phase of the first crack propagation category based on the stress corrosion crack propagation life under the first crack propagation category, a high cycle fatigue crack propagation life under the first crack propagation category, a low cycle fatigue crack propagation life in the third phase of the first crack propagation category under the normal shutdown transient condition of the nuclear turbine, a low cycle fatigue crack propagation life in the third phase of the first crack propagation category under the 110% overspeed test transient condition of the nuclear turbine, a low cycle fatigue crack propagation life in the third phase of the first crack propagation category under the 120% overspeed operation transient condition of the nuclear turbine, the annual average number of the normal shutdowns, the annual average number of the 110% overspeed tests and the annual average number of the 120% overspeed operations of the nuclear turbine and an annual average number of high cycle fatigues of the blade groove of the rotor; and
acquiring a crack propagation calendar life under the first crack propagation category based on the calendar life in the first phase of the first crack propagation category, the calendar life in the second phase of the first crack propagation category and the calendar life in the third phase of the first crack propagation category.

15. The method according to claim 13, wherein acquiring the crack propagation calendar life under the crack propagation category based on the stress corrosion crack propagation life, the low cycle fatigue crack propagation lives in the plurality of phases and the high cycle fatigue crack propagation life under the crack propagation category comprises:
acquiring a calendar life in a first phase of the second crack propagation category based on a stress corrosion crack propagation life under the second crack propagation category, a low cycle fatigue crack propagation life in the first phase of the second crack propagation category under the normal shutdown transient condition of the nuclear turbine, a low cycle fatigue crack propagation life in the first phase of the second crack propagation category under the 110% overspeed test transient condition of the nuclear turbine, a low cycle fatigue crack propagation life in the first phase of the second crack propagation category under the 120% overspeed operation transient condition of the nuclear turbine, an annual average number of normal shutdowns, an annual average number of 110% overspeed tests and an annual average number of 120% overspeed operations of the nuclear turbine;
acquiring a calendar life in a second phase of the second crack propagation category based on a stress corrosion crack propagation life under the second crack propagation category, a high cycle fatigue crack propagation life under the second crack propagation category, a low cycle fatigue crack propagation life in the second phase of the second crack propagation category under the normal shutdown transient condition of the nuclear turbine, a low cycle fatigue crack propagation life in the second phase of the second crack propagation category under the 110% overspeed test transient condition of the nuclear turbine, a low cycle fatigue crack propagation life in the second phase of the second crack propagation category under the 120% overspeed operation transient condition of the nuclear turbine, the annual average number of the normal shutdowns, the annual average number of the 110% overspeed tests and the annual average number of the 120% overspeed operations of the nuclear turbine, and an annual average number of high cycle fatigues of the blade groove of the rotor; and
acquiring a crack propagation calendar life under the second crack propagation category based on the calendar life in the first phase of the second crack propagation category, and the calendar life in the second phase of the second crack propagation category.

16. The method according to claim 13, wherein acquiring the crack propagation calendar life under the crack propagation category based on the stress corrosion crack propagation life, the low cycle fatigue crack propagation lives the plurality of phases and the high cycle fatigue crack propagation life under the crack propagation category comprises:
acquiring a calendar life in a first phase of the third crack propagation category based on a low cycle fatigue crack propagation life in the first phase of the third propagation category under the normal shutdown transient condition of the nuclear turbine, a low cycle fatigue crack propagation life in the first phase of the third propagation category under the 110% overspeed test transient condition of the nuclear turbine, a low cycle fatigue crack propagation life in the first phase of the third propagation category under the 120% overspeed operation transient condition of the nuclear turbine, an annual average number of normal shutdowns, an annual average number of 110% overspeed tests and an annual average number of 120% overspeed operations of the nuclear turbine;
acquiring a calendar life in a second phase of the third crack propagation category based on a high cycle fatigue crack propagation life under the third second crack propagation category, a low cycle fatigue crack propagation life in the second phase of the third propagation category under the normal shutdown transient condition of the nuclear turbine, a low cycle fatigue crack propagation life in the second phase of the third propagation category under the 110% overspeed test transient condition of the nuclear turbine, a low cycle fatigue crack propagation life in the second phase of the third propagation category under the 120% overspeed operation transient condition of the nuclear turbine, the annual average number of the normal shutdowns, the annual average number of the 110% overspeed tests and the annual average number of the 120% overspeed operations of the nuclear turbine and an annual average number of high cycle fatigues of the blade groove of the rotor;
acquiring a calendar life in a third phase of the third crack propagation category based on a stress corrosion crack propagation life under the third crack propagation category, the high cycle fatigue crack propagation life under the third crack propagation category, a low cycle fatigue crack propagation life in the third phase of the third crack propagation category under the normal shutdown transient condition of the nuclear turbine, a low cycle fatigue crack propagation life in the third phase of the third crack propagation category under the 110% overspeed test transient condition of the nuclear turbine, a low cycle fatigue crack propagation life in the third phase of the third crack propagation category under the 120% overspeed operation transient condition of the nuclear turbine, the annual average number of the normal shutdowns, the annual average number of the 110% overspeed tests and the annual average number of the 120% overspeed operations of the nuclear turbine and an annual average number of high cycle fatigues of the blade groove of the rotor; and
acquiring a crack propagation calendar life under the third crack propagation category based on the calendar life in the first phase of the third crack propagation category, the calendar life in the second phase of the third crack propagation category and the calendar life in the third phase of the third crack propagation category.

17. The method according to claim 13, wherein acquiring the crack propagation calendar life under the crack propagation category based on the stress corrosion crack propagation life, the low cycle fatigue crack propagation lives the plurality of phases and the high cycle fatigue crack propagation life under the crack propagation category comprises:
acquiring a calendar life in a first phase of the fourth crack propagation category based on a high cycle fatigue crack propagation life under the fourth crack propagation category, a low cycle fatigue crack propagation life in the first phase of the fourth propagation category under the normal shutdown transient condition of the nuclear turbine, a low cycle fatigue crack propagation life in the first phase of the fourth propagation category under the 110% overspeed test transient condition of the nuclear turbine, a low cycle fatigue crack propagation life in the first phase of the fourth propagation category under the 120% overspeed operation transient condition of the nuclear turbine, an annual average number of normal shutdowns, an annual average number of 110% overspeed tests and an annual average number of 120% overspeed operations of the nuclear turbine and an annual average number of high cycle fatigues of the blade groove of the rotor;
acquiring a calendar life in a second phase of the fourth crack propagation category based on a stress corrosion crack propagation life under the fourth crack propagation category, the high cycle fatigue crack propagation life under the fourth crack propagation category, a low cycle fatigue crack propagation life in the second phase of the fourth crack propagation category under the normal shutdown transient condition of the nuclear turbine, a low cycle fatigue crack propagation life in the second phase of the fourth crack propagation category under the 110% overspeed test transient condition of the nuclear turbine, a low cycle fatigue crack propagation life in the second phase of the fourth crack propagation category under the 120% overspeed operation transient condition of the nuclear turbine, the annual average number of the normal shutdowns, the annual average number of the 110% overspeed tests and the annual average number of the 120% overspeed operations of the nuclear turbine and an annual average number of high cycle fatigues of the blade groove of the rotor; and
acquiring a crack propagation calendar life under the fourth crack propagation category based on the calendar life in the first phase of the fourth crack propagation category, and the calendar life in the second phase of the fourth crack propagation category.

18. The method according to claim 1, wherein performing the safety monitoring on the crack in the blade groove of the rotor based on the crack propagation calendar life comprises:
in response to the nuclear turbine being in a usage phase, acquiring a safety factor based on the crack propagation calendar life and a planned overhaul interval of the nuclear turbine; and
performing the safety monitoring on the crack in the blade groove of the rotor by determining whether the safety factor satisfies a second monitoring acceptance condition.

19. The method according to claim 18, further comprising:
acquiring abnormal data of the blade groove of the rotor during the usage phase in response to the safety factor not satisfying the second monitoring acceptance condition; and
optimizing and improving the abnormal data of the blade groove of the rotor during the usage phase, and returning to execute a process of acquiring the safety factor until the acquired safety factor satisfies the second monitoring acceptance condition.

20. An electronic device, comprising:
a memory; and
a processor; and
a computer program, stored on the memory and executable by the processor; wherein, when executing the computer program, the processor is configured to implement: acquiring a phased array detection crack depth of the blade groove of the nuclear turbine rotor;
acquiring a stress corrosion crack propagation life, low cycle fatigue and high cycle fatigue crack propagation lives based on the crack depth, wherein a stress corrosion crack propagation size threshold value is determined based on a crack shape parameter of the blade groove of the rotor, a stress corrosion fracture toughness of a material of the rotor and a maximum stress at a crack location in the blade groove of the rotor under a load operation steady-state condition; a low cycle fatigue critical crack size of the blade groove of the rotor under a normal shutdown transient condition is determined based on the crack shape parameter of the blade groove of the rotor, the fracture toughness of the material of the rotor, and a maximum stress at the crack location in the blade groove of the rotor under the normal shutdown transient condition; a stress corrosion crack propagation lives under different crack propagation categories are acquired based on the stress corrosion crack propagation size threshold value, the phased array detection crack depth, a test value of an annual average stress corrosion crack propagation rate of the material of the rotor, and the low cycle fatigue critical crack size;
acquiring a crack propagation calendar life of the blade groove of the rotor based on the stress corrosion crack propagation life, the low cycle fatigue and high cycle fatigue crack propagation life, and
performing safety monitoring on the crack in the blade groove of the rotor.
